(19) United States
(12) Patent Application Publication
(10) Pub. No.: US 2026/0058487 A1
(43) Pub. Date: Feb. 26, 2026

(54) POWER STORAGE SYSTEM

(71) Applicant: SEMICONDUCTOR ENERGY LABORATORY CO., LTD., Atsugi-shi, Kanagawa-ken (JP)

(72) Inventors: Taisuke NAKAO, Atsugi, Kanagawa (JP); Mayumi MIKAMI, Atsugi, Kanagawa (JP); Ryota TAJIMA, Isehara, Kanagawa (JP); Takeshi OSADA, Isehara, Kanagawa (JP)

(21) Appl. No.: 19/104,943

(22) PCT Filed: Aug. 28, 2023
(86) PCT No.: PCT/IB2023/058465

§ 371 Date: Feb. 19, 2025

(30) Foreign Application Priority Data
Sep. 2, 2022 (JP) 2022-139877

(51) Int. Cl. H02J 7/00; H01M 4/02; H01M 4/131; H01M 4/133; H01M 4/134; H01M 4/136; H01M 4/38; H01M 4/505; H01M 4/525; H01M 4/58; H01M 4/587; H01M 10/48

(52) U.S. Cl. CPC H02J 7/007182; H01M 4/131; H01M 4/133; H01M 4/134; H01M 4/136; H01M 4/386; H01M 4/505; H01M 4/525; H01M 4/5825; H01M 4/587; H01M 10/48; H02J 7/0048; H01M 2004/021; H01M 2004/027; H01M 2004/028

(57) ABSTRACT

A novel power storage system is provided. The power storage system includes a secondary battery, a current measuring circuit, a voltage measuring circuit, and a control circuit. The secondary battery includes a negative electrode. The negative electrode contains graphite and silicon. The current measuring circuit and the voltage measuring circuit are electrically connected to the control circuit. The control circuit has a function of starting charge of the secondary battery. The control circuit has a function of performing a first arithmetic operation of calculating a voltage differential value of the amount of electricity of charge current of the secondary battery with the use of a current value detected by the current measuring circuit and a voltage value detected by the voltage measuring circuit, and has a function of performing a second arithmetic operation of detecting an extremum of the voltage differential value. The control circuit has a function of stopping the charge after a predetermined time elapses since the extremum is detected through the second arithmetic operation.

### TECHNICAL FIELD

One embodiment of the present invention relates to a power storage system, an operation method of the power storage system, a secondary battery, and an operation method of the secondary battery. One embodiment of the present invention relates to a charge method of a secondary battery. One embodiment of the present invention relates to a semiconductor device and an operation method of the semiconductor device. One embodiment of the present invention relates to a battery control circuit, a battery protection circuit, a power storage device, an electronic device, and operation methods thereof.

Note that one embodiment of the present invention is not limited to the above technical field. The technical field of one embodiment of the invention disclosed in this specification and the like relates to an object, a method, a driving method, or a manufacturing method. One embodiment of the present invention relates to a process, a machine, manufacture, or a composition of matter. Thus, specific examples of the technical field of one embodiment of the present invention disclosed in this specification and the like include a semiconductor device, a display device, a light-emitting device, a power storage device, an optical device, an imaging device, a lighting device, an arithmetic device, a control device, a memory device, an input device, an output device, an input/output device, a signal processing device, an electronic computer, an electronic device, driving methods thereof, and manufacturing methods thereof.

### BACKGROUND ART

In recent years, for example, a variety of power storage devices (also referred to as batteries or secondary batteries) such as lithium-ion batteries, lithium-ion capacitors, air batteries, and all-solid-state batteries have been actively developed. In particular, demand for lithium-ion batteries with high output and high capacity has rapidly grown with the development of the semiconductor industry. The lithium-ion batteries are essential as rechargeable energy supply sources for today's information society.

Lithium-ion batteries have been utilized in a wide range of areas from small electronic devices to automobiles. As the application range of batteries expands, there are more and more applications utilizing a multi-cell battery stack where a plurality of battery cells are connected in series.

Furthermore, lithium-ion batteries have been required to have increased capacity per weight and improved charge and discharge cycle performance, and positive electrodes, negative electrodes, and electrolyte solutions are under active research and development. For example, Patent Document 1 to Patent Document 3 each disclose improvement of a positive electrode active material contained in a positive electrode of a lithium-ion battery. For another example, Patent Document 4 discloses a structure example in which the capacity is increased and the charge and discharge cycle performance is improved by using a mixture of graphite and silicon as a negative electrode active material contained in a negative electrode of a lithium-ion battery.

A power storage device is provided with a circuit for detecting an abnormality in charge and discharge, such as overdischarge, overcharge, overcurrent, or a short circuit. In such a circuit, for example, data of voltage, current, and the like is obtained, and stop of charge and discharge or control of cell balancing or the like is performed on the basis of the obtained data. Thus, a battery can be protected and controlled.

Patent Document 5 discloses a protection IC that functions as a battery protection circuit. Specifically, Patent Document 5 discloses a protection IC that detects an abnormality in charge and discharge by comparing, using a plurality of comparators provided inside, a reference voltage and a voltage of a terminal to which a battery is connected.

Patent Document 6 discloses a protection semiconductor device for protecting an assembled battery in which secondary battery cells are connected in series.

A variety of circuits for detecting an abnormality in charge and discharge of a secondary battery and protecting and controlling the battery, as described above, and a variety of integrated circuits (ICs) including the circuits are also semiconductor devices formed using transistors.

A silicon-based semiconductor is widely known as a semiconductor material applicable to a transistor, and an oxide semiconductor has been attracting attention as another material. It is known that a transistor using an oxide semiconductor has an extremely low off-state current in a non-conduction state. Patent Document 7 and Patent Document 8 disclose a central processing unit (CPU) that can have low power consumption and a memory device that can retain stored contents for a long time, for example, by utilizing a feature of a low off-state current of a transistor using an oxide semiconductor.

For example, secondary batteries and the like for mobile electronic devices are highly demanded to have high discharge capacity per weight and excellent cycle performance. In order to meet such demands, positive electrode active materials in positive electrodes of secondary batteries have been actively improved. In addition, a crystal structure of a positive electrode active material has also been studied (Non-Patent Document 1 to Non-Patent Document 3).

An XRD (X-ray diffraction) pattern is one of methods used for analysis of a crystal structure of a positive electrode active material. For example, with the use of ICSD (Inorganic Crystal Structure Database) described in Non-Patent Document 4, XRD data can be analyzed. For Rietveld analysis, the analysis program RIETAN-FP (Non-Patent Document 5) can be used, for example.

### REFERENCES

### Patent Documents

[Patent Document 1] Japanese Published Patent Application No. 2019-179758
[Patent Document 2] International Publication WO2020/026078 Pamphlet
[Patent Document 3] Japanese Published Patent Application No. 2020-140954
[Patent Document 4] International Publication WO2022/130099 Pamphlet
[Patent Document 5] Specification of United States Patent Application Publication No. 2011-267726
[Patent Document 6] Japanese Published Patent Application No. 2010-220389
[Patent Document 7] Japanese Published Patent Application No. 2012-257187
[Patent Document 8] Japanese Published Patent Application No. 2011-151383

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348
[Non-Patent Document 2] T. Motohashi et al., “Electronic phase diagram of the layered cobalt oxide system LiₓCoO₂ (0.0≤x≤1.0)”, Physical Review B, 80 (16); 165114
[Non-Patent Document 3] Zhaohui Chen et al., “Staging Phase Transitions in LiₓCoO₂”, Journal of The Electrochemical Society, 2002, 149 (12), A1604-A1609
[Non-Patent Document 4] A. Belsky, et al., “New developments in the Inorganic Crystal Structure Database (ICSD): accessibility in support of materials research and design”, Acta Cryst., (2002), B58, 364-369
[Non-Patent Document 5] F. Izumi and K. Momma, Solid State Phenom., (2007) 130, 15-20

### SUMMARY OF THE INVENTION

### Problems to be Solved by the Invention

Patent Document 4 discloses that the charge and discharge capacity is increased and excellent charge and discharge cycle performance is achieved when the ratio of positive electrode capacity to negative electrode capacity of a lithium-ion battery using a negative electrode containing graphite and silicon is preferably higher than or equal to 50% and lower than 100%, further preferably higher than or equal to 70% and lower than 90%. That is, it is preferable that the upper limit of the usage range be set to greater than or equal to 50% and less than 100% or greater than or equal to 70% and less than 90% of the maximum capacity, instead of using the maximum rechargeable and dischargeable capacity of the negative electrode containing graphite and silicon. Patent Document 4 discloses a lithium-ion battery fabricated such that the ratio of positive electrode capacity to negative electrode capacity falls within the above range.

However, in the case where a composite oxide having a layered rock-salt crystal structure belonging to the space group R-3m, such as lithium cobalt oxide, is used as a positive electrode active material, the positive electrode capacity changes with charge voltage. For example, when the charge voltage becomes higher, the amount of lithium extracted from the positive electrode active material increases and the positive electrode capacity increases.

It is known that repeated charge and discharge of a lithium-ion battery cause deterioration such as a capacity decrease. In that case, the amount of deterioration of a positive electrode is not the same as the amount of deterioration of a negative electrode in some cases. That is, the capacity ratio between the positive electrode and the negative electrode in the lithium-ion battery that has deteriorated may be different from the capacity ratio in the lithium-ion battery at the time of being fabricated.

In view of this, an object of one embodiment of the present invention is to provide a charge method in which the upper limit of the usage range of a lithium-ion battery using a negative electrode containing graphite and silicon can be set to greater than or equal to 50% and less than 100% or greater than or equal to 70% and less than 90% of the maximum capacity of the negative electrode.

Another object of one embodiment of the present invention is to provide a power storage system with a high energy density. Another object of one embodiment of the present invention is to provide a power storage system with a high degree of safety. Another object of one embodiment of the present invention is to provide a charge method of a power storage system with a high energy density. Another object of one embodiment of the present invention is to provide a charge method of a power storage system with a high degree of safety. Another object of one embodiment of the present invention is to provide a secondary battery with a high energy density. Another object of one embodiment of the present invention is to provide a secondary battery with a high degree of safety. Another object of one embodiment of the present invention is to provide a novel charge method of a secondary battery. Another object of one embodiment of the present invention is to provide a power storage system using a highly reliable positive electrode active material. Another object of one embodiment of the present invention is to provide a highly reliable positive electrode active material. Another object of one embodiment of the present invention is to provide an excellent power storage system by utilizing a positive electrode active material of one embodiment of the present invention for the power storage system of one embodiment of the present invention. Another object of one embodiment of the present invention is to estimate a state of a secondary battery. Another object of one embodiment of the present invention is to estimate a charge depth of a secondary battery. Another object of one embodiment of the present invention is to estimate a full rechargeable capacity of a secondary battery and a deterioration state of the secondary battery. Another object of one embodiment of the present invention is to estimate a dischargeable capacity of a secondary battery.

Another object of one embodiment of the present invention is to provide a novel charging unit, a novel charge control circuit, a novel battery control circuit, a novel battery protection circuit, a novel power storage device, a novel semiconductor device, a novel vehicle, a novel electronic device, or the like. Another object of one embodiment of the present invention is to provide a charging unit, a charge control circuit, a battery control circuit, a battery protection circuit, a power storage device, a semiconductor device, a vehicle, an electronic device, or the like with low power consumption. Another object of one embodiment of the present invention is to provide a charging unit, a charge control circuit, a battery control circuit, a battery protection circuit, a power storage device, a semiconductor device, a vehicle, an electronic device, or the like with a high degree of integration.

Note that the objects of one embodiment of the present invention are not limited to the objects listed above. The objects listed above do not preclude the existence of other objects. Note that the other objects are objects that are not described in this section and will be described below. The objects that are not described in this section will be derived from the description of the specification, the drawings, and the like and can be extracted as appropriate from the description by those skilled in the art. Note that one embodiment of the present invention is to achieve at least one of the objects listed above and the other objects.

### Means for Solving the Problems

A charging unit of one embodiment of the present invention has a function of detecting a change in a structure of a negative electrode active material of one embodiment of the present invention in a charge process by measuring charge voltage and charge current of a secondary battery and analyzing the measured charge voltage and the measured charge current. Alternatively, the charging unit of one embodiment of the present invention has a function of detecting a change in a crystal structure of a positive electrode active material of one embodiment of the present invention in a charge process by measuring charge voltage and charge current of a secondary battery and analyzing the measured charge voltage and the measured charge current.

One embodiment of the present invention is a power storage system including a secondary battery, a current measuring circuit, a voltage measuring circuit, and a control circuit. The secondary battery includes a negative electrode. The negative electrode contains graphite and silicon. The current measuring circuit and the voltage measuring circuit are electrically connected to the control circuit. The control circuit has a function of starting charge of the secondary battery. The control circuit has a function of performing a first arithmetic operation of calculating a voltage differential value of the amount of electricity of charge current of the secondary battery with use of a current value detected by the current measuring circuit and a voltage value detected by the voltage measuring circuit, and has a function of performing a second arithmetic operation of detecting an extremum of the voltage differential value. The control circuit has a function of stopping the charge after a predetermined time elapses since the extremum is detected through the second arithmetic operation.

One embodiment of the present invention is a power storage system including a secondary battery, a current measuring circuit, a voltage measuring circuit, and a control circuit. The secondary battery includes a positive electrode and a negative electrode. The negative electrode contains graphite and silicon. The current measuring circuit and the voltage measuring circuit are electrically connected to the control circuit. The current measuring circuit has a function of measuring current flowing through the secondary battery. The voltage measuring circuit has a function of measuring voltage of the secondary battery. The control circuit has a first function of starting charge of the secondary battery, a second function of calculating the amount of electricity Q(t) using current I(t) at a time t, a third function of detecting a time tp at which a first curve has a first local maximum by analyzing the first curve with a horizontal axis representing voltage V(t) and a vertical axis representing a voltage differential of the amount of electricity Q(t) [dQ(t)/dV(t)], and a fourth function of stopping the charge at a time t2 at which a predetermined time elapses from the time tp in the case where voltage V(tp) at the time tp is higher than or equal to first voltage. The first voltage depends on a kind of a positive electrode active material in the positive electrode.

In the case where lithium iron phosphate is contained as the positive electrode active material in the above power storage system, the first voltage can be higher than or equal to 3.40 V and lower than or equal to 3.50 V.

Alternatively, in the case where lithium nickel-cobalt-manganese oxide is contained as the positive electrode active material in the above power storage system, the first voltage can be higher than or equal to 3.90 V and lower than or equal to 4.50 V.

Alternatively, in the case where lithium cobalt oxide is contained as the positive electrode active material in the above power storage system, the first voltage can be higher than or equal to 4.20 V and lower than or equal to 4.50 V.

In any one of the above power storage systems, a ratio Wg/Ws between the weight Wg of graphite and the weight Ws of silicon is preferably greater than or equal to 4 and less than or equal to 10.

In the above power storage system, a capacity charged in the negative electrode is preferably greater than or equal to 70% and 90% of a rechargeable and dischargeable capacity of the negative electrode.

### Effect of the Invention

In view of the above, according to one embodiment of the present invention, a charge method can be provided in which the upper limit of the usage range of a lithium-ion battery using a negative electrode containing graphite and silicon can be set to greater than or equal to 50% and less than 100% or greater than or equal to 70% and less than 90% of the maximum capacity of the negative electrode.

According to one embodiment of the present invention, a power storage system with a high energy density can be provided. According to another embodiment of the present invention, a power storage system with a high degree of safety can be provided. According to another embodiment of the present invention, a secondary battery with a high energy density can be provided. According to another embodiment of the present invention, a secondary battery with a high degree of safety can be provided. According to another embodiment of the present invention, a novel charge method of a secondary battery can be provided. According to another embodiment of the present invention, a power storage system using a highly reliable positive electrode active material can be provided. According to another embodiment of the present invention, a highly reliable positive electrode active material can be provided. According to another embodiment of the present invention, an excellent power storage system can be provided by utilizing a positive electrode active material of one embodiment of the present invention for the power storage system of one embodiment of the present invention. According to another embodiment of the present invention, a state of a secondary battery can be estimated. According to another embodiment of the present invention, a charge depth of a secondary battery can be estimated. According to another embodiment of the present invention, a full rechargeable capacity of a secondary battery can be estimated, and a deterioration state of the secondary battery can be estimated. According to another embodiment of the present invention, a dischargeable capacity of a secondary battery can be estimated.

According to another embodiment of the present invention, a novel charging unit, a novel charge control circuit, a novel battery control circuit, a novel battery protection circuit, a novel power storage device, a novel semiconductor device, a novel vehicle, a novel electronic device, or the like can be provided. According to another embodiment of the present invention, a charging unit, a charge control circuit, a battery control circuit, a battery protection circuit, a power storage device, a semiconductor device, a vehicle, an electronic device, or the like with low power consumption can be provided. According to another embodiment of the present invention, a charging unit, a charge control circuit, a battery control circuit, a battery protection circuit, a power storage device, a semiconductor device, a vehicle, an electronic device, or the like with a high degree of integration can be provided.

Note that the effects of one embodiment of the present invention are not limited to the effects listed above. The effects listed above do not preclude the existence of other effects. The other effects are effects that are not described in this section and will be described below. The effects that are not described in this section are derived from the description of the specification, the drawings, and the like and can be extracted as appropriate from the description by those skilled in the art. Note that one embodiment of the present invention has at least one of the effects listed above and the other effects. Accordingly, one embodiment of the present invention does not have the effects listed above in some cases.

### BRIEF DESCRIPTION OF THE DRAWINGS

FIG. 1A and FIG. 1B are block diagrams each illustrating an example of a power storage system.

FIG. 2A and FIG. 2B are block diagrams each illustrating an example of a power storage system.

FIG. 3A and FIG. 3B are block diagrams each illustrating an example of a power storage system.

FIG. 4A and FIG. 4B are block diagrams illustrating examples of a power storage system.

FIG. 5A is a diagram illustrating a cross-sectional structure inside a secondary battery, FIG. 5B is a graph showing a capacity ratio between a positive electrode and a negative electrode, and FIG. 5C is a graph showing capacity limitation on electrodes each containing graphite and silicon.

FIG. 6A is a graph showing a discharge curve of a half cell using an electrode containing graphite and silicon, and FIG. 6B is a graph showing a dQ/dV-SOC curve.

FIG. 7A is a graph showing a potential change of a positive electrode and a potential change of a negative electrode in charge of a secondary battery, FIG. 7B is a graph showing charge voltage of the secondary battery, and FIG. 7C is a graph showing a dQ/dV-SOC curve of the secondary battery.

FIG. 8 is a flowchart showing a method for charging a secondary battery.

FIG. 9 is a flowchart showing a method for charging a secondary battery.

FIG. 10 is a flowchart showing a method for charging a secondary battery.

FIG. 11 is a block diagram illustrating a structure example of a power storage system.

FIG. 12 is a flowchart showing an operation example of a power storage system.

FIG. 13 is a block diagram illustrating a structure example of a power storage system.

FIG. 14 is a schematic view showing an operation example of a power storage system.

FIG. 15 is a flowchart showing an operation example of a power storage system.

FIG. 16A to FIG. 16C are block diagrams illustrating examples of a power storage system.

FIG. 17A and FIG. 17B are cross-sectional views of a positive electrode active material, and FIG. 17C to FIG. 17F are cross-sectional views of part of the positive electrode active material.

FIG. 18 is a diagram illustrating crystal structures of a positive electrode active material.

FIG. 19 is a diagram illustrating crystal structures of a conventional positive electrode active material.

FIG. 20 is a diagram showing XRD patterns calculated from crystal structures.

FIG. 21 is a diagram showing XRD patterns calculated from crystal structures.

FIG. 22A and FIG. 22B are diagrams showing XRD patterns calculated from crystal structures.

FIG. 23A to FIG. 23H are diagrams illustrating examples of electronic devices.

FIG. 24A to FIG. 24D are diagrams illustrating examples of electronic devices.

FIG. 25A to FIG. 25C are diagrams illustrating examples of electronic devices.

FIG. 26A to FIG. 26C are diagrams illustrating examples of vehicles.

### MODE FOR CARRYING OUT THE INVENTION

In this specification and the like, a semiconductor device refers to a device that utilizes semiconductor characteristics, and means a circuit including a semiconductor element (e.g., a transistor or a diode) or a device including the circuit, for example. The semiconductor device also means all devices that can function by utilizing semiconductor characteristics. For example, an integrated circuit including a semiconductor element, a chip provided with an integrated circuit, an electronic component including a packaged chip, and an electronic device provided with an electronic component are examples of a semiconductor device. For example, a display device, a light-emitting device, a power storage device, an optical device, an imaging device, a lighting device, an arithmetic device, a control device, a memory device, an input device, an output device, an input/output device, a signal processing device, an electronic computer, an electronic device, and the like themselves might be semiconductor devices, or might include semiconductor devices.

Embodiments will be described below with reference to the drawings. Note that the embodiments can be implemented in many different modes. Thus, it will be readily understood by those skilled in the art that the modes and details can be changed in various ways without departing from the spirit and scope thereof. Therefore, the present invention should not be interpreted as being limited to the description in the embodiments.

In this specification and the like, one embodiment of the present invention can be constituted by appropriately combining a structure described in an embodiment with any of the structures described in the other embodiments. In addition, in the case where a plurality of structures are described in one embodiment, the structures can be combined with each other as appropriate to constitute one embodiment of the present invention.

As for the drawings illustrating the embodiments, in the structures of the invention, the same reference numerals are used in common for the same portions or portions having similar functions in different drawings, and repeated description thereof is omitted in some cases. Furthermore, for example, the same hatching pattern is used for the portions having similar functions throughout the drawings, and the portions are not especially denoted by reference numerals in some cases. Moreover, some components are omitted in a perspective view or a top view (also referred to as a “plan view”), for example, for easy understanding of the drawings in some cases. For example, some hidden lines might also be omitted in the drawings. For example, a hatching pattern or the like might be omitted in the drawings.

In the drawings, the size, the layer thickness, or the region is sometimes exaggerated for clarity. Thus, the drawings are not limited to the drawings with the illustrated size, aspect ratio, and the like, for example. Note that the drawings schematically illustrate ideal examples, and embodiments of the present invention are not limited to shapes, values, and the like illustrated in the drawings, for example. In the actual manufacturing process, for example, a layer, a resist mask, or the like might be unintentionally reduced in size by treatment such as etching, which might not be reflected in the drawings for easy understanding. For example, in the actual circuit operation, a fluctuation in voltage, current, or the like might be caused by noise, difference in timing, or the like, which might not be reflected in the drawings for easy understanding.

In this specification, the drawings, and the like, components of the present invention are classified on the basis of the functions, and shown as elements independent of one another in some cases. However, such components are sometimes hard to classify functionally, and there are a case where one component is associated with a plurality of functions and a case where a plurality of components are associated with one function. Accordingly, the component is not limited to that described in this specification, the drawings, and the like and can be explained with another term as appropriate depending on the situation.

In this specification, the drawings, and the like, when a plurality of components are denoted by the same reference numerals, and in particular need to be distinguished from each other, an identification sign such as “A”, “b”, “_1”, “[n]”, or “[m, n]” is sometimes added to the reference numerals, for example.

Note that in this specification and the like, a “conduction state” or an “on state” of a transistor refers to a state where a source and a drain of the transistor can be regarded as being electrically short-circuited or a state where current can be made to flow between the source and the drain. For example, the “conduction state” or the “on state” refers to a state where voltage between a gate and a source is higher than threshold voltage in an n-channel transistor, a state where voltage between a gate and a source is lower than threshold voltage in a p-channel transistor, or the like in some cases. A “non-conduction state”, a “cutoff state”, or an “off state” of a transistor refers to a state where a source and a drain of the transistor can be regarded as being electrically disconnected. For example, the “non-conduction state”, the “cutoff state”, or the “off state” refers to a state where voltage between a gate and a source is lower than threshold voltage in an n-channel transistor, a state where voltage between a gate and a source is higher than threshold voltage in a p-channel transistor, or the like in some cases.

In this specification and the like, “on-state current” of a transistor refers to current flowing between a source and a drain of the transistor in an on state (also referred to as drain current) unless otherwise specified. In this specification and the like, “off-state current” of a transistor refers to drain current of the transistor in an off state unless otherwise specified. Note that in this specification and the like, when a transistor is in an off state, drain current and current flowing between a gate and a source or a drain (also referred to as gate leakage current) are sometimes referred to as leakage current.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure. In this specification and the like, the space group R-3m is represented by a composite hexagonal lattice, unless otherwise specified. In some cases, not only (hkl) but also (hkil) is used as the Miller index. Here, i is −(h+k).

In this specification and the like, a particle is not limited to referring to only a spherical shape (a circular cross-sectional shape). The cross-sectional shape of each of particles may be an ellipse, a rectangle, a trapezoid, a triangle, a quadrilateral with rounded corners, an asymmetrical shape, or the like, for example. Note that each of the particles may have an irregular shape.

In this specification and the like, uniformity refers to a phenomenon in which, in a solid made of a plurality of elements (e.g., A1, A2, and A3), a certain element (e.g., A1) is distributed with similar features in specific regions. Note that the concentrations of the element in the specific regions are substantially the same. For example, the difference in concentration of the element between the specific regions is less than or equal to 10%. Examples of the specific regions include a surface portion, a surface, a projection, a depression, and a bulk.

In this specification and the like, segregation refers to a phenomenon in which, in a solid made of a plurality of elements (e.g., A1, A2, and A3), a certain element (e.g., A2) is spatially non-uniformly distributed.

A secondary battery of one embodiment of the present invention in this specification and the like includes a positive electrode and a negative electrode, for example. A positive electrode active material is a material included in the positive electrode. The positive electrode active material is a substance that performs a reaction contributing to charge and discharge of the secondary battery, for example. Note that the positive electrode active material may partly contain a substance that does not contribute to the charge and discharge of the secondary battery.

In this specification and the like, a positive electrode active material refers to a compound which contains a transition metal and oxygen and into and from which lithium can be inserted and extracted. The positive electrode active material does not include, for example, a carbonate, a hydroxy group, and the like which are adsorbed after formation of the positive electrode active material. Furthermore, the positive electrode active material does not include an electrolyte, an organic solvent, a binder, a conductive material, and a compound originating from any of these that are attached to the positive electrode active material after the formation.

In this specification and the like, a positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite. The positive electrode active material refers to a group of particles of lithium cobalt oxide, for example.

A theoretical capacity of a positive electrode active material refers to the amount of electricity obtained when all lithium that can be inserted and extracted and is contained in the positive electrode active material is extracted. For example, the theoretical capacity of lithium cobalt oxide (LiCoO₂) is 274 mAh/g, the theoretical capacity of lithium nickel oxide (LiNiO₂) is 275 mAh/g, and the theoretical capacity of lithium manganese oxide (LiMn₂O₄) is 148 mAh/g.

A charge depth is a value showing the degree of charge, i.e., the amount of lithium extracted from a positive electrode, relative to the theoretical capacity of a positive electrode active material. For example, in the case of a positive electrode active material having a layered rock-salt crystal structure such as lithium cobalt oxide (LiCoO₂) or lithium nickel-cobalt-manganese oxide (LiNiₓCo_{y}Mn_{z}O₂ (x+y+z=1)), a charge depth of 0 indicates a state where no lithium has been extracted from the positive electrode active material; a charge depth of 0.5 indicates a state where lithium corresponding to 137 mAh/g has been extracted from a positive electrode; and a charge depth of 0.8 indicates a state where lithium corresponding to 219.2 mAh/g has been extracted from the positive electrode, relative to a theoretical capacity of 274 mAh/g.

The remaining amount of lithium in a positive electrode active material relative to the theoretical capacity is represented by x in a compositional formula, e.g., LiₓCoO₂ or LiₓMO₂. Here, M means a transition metal that is oxidized or reduced due to insertion and extraction of lithium. In this specification and the like, LiₓCoO₂ can be replaced with LiₓMO₂ as appropriate. In the case of a positive electrode active material in a secondary battery, x can be (theoretical capacity−charge capacity (the amount of electricity charged))/theoretical capacity. For example, in the case where a secondary battery using LiCoO₂ as a positive electrode active material is charged to 219.2 mAh/g, the positive electrode active material can be represented by Li_{0.2}CoO₂ or x=0.2. Small x in LiₓCoO₂ means, for example, 0.1<x≤0.24.

In the case where lithium cobalt oxide almost satisfies the stoichiometric proportion, lithium cobalt oxide is LiCoO₂ and the occupancy rate of lithium in the lithium sites is x=1. In a secondary battery after its discharge ends, it can be said that contained lithium cobalt oxide is LiCoO₂ and x=1. Here, “discharge ends” means that voltage becomes lower than or equal to 2.5 V (lithium counter electrode) at a current of 100 mA/g, for example. In a lithium-ion battery, the voltage rapidly decreases when the occupancy rate of lithium in the lithium sites becomes x=1 and no more lithium can enter the lithium sites. At this time, it can be said that discharge ends. In general, in a lithium-ion battery using LiCoO₂, the discharge voltage rapidly decreases until the discharge voltage reaches 2.5 V; thus, discharge ends under the above-described conditions. When a positive electrode after discharge ends is analyzed by, for example, an XRD pattern or the like, a general crystal structure of LiCoO₂ can be observed.

The charge capacity (the amount of electricity charged) and discharge capacity used for calculation of x in LiₓCoO₂ are preferably measured under the conditions of no short circuits and no or small influence of decomposition of an electrolyte. For example, data of a secondary battery in which a sudden capacity change that seems to result from a short circuit occurs should not be used for calculation of x.

The space group of a crystal structure is identified by, for example, an XRD pattern, an electron diffraction pattern, a neutron diffraction pattern, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned above voids between anions packed in a first layer, and anions in a third layer are placed at the positions that are positioned right above voids between the anions in the second layer and are not positioned right above the anions in the first layer. Accordingly, anions do not necessarily form a cubic lattice structure. In addition, actual crystals always have a defect; thus, analysis results are not necessarily consistent with the theory. For example, in an electron diffraction pattern or a FFT (Fast Fourier Transform) pattern of a TEM (Transmission Electron Microscope) image or the like, a spot may appear in a position different from a theoretical position. For example, anions may be regarded as forming a cubic close-packed structure when a difference in orientation from a theoretical position is less than or equal to 5° or less than or equal to 2.5°.

The potential of a positive electrode generally increases with increasing charge voltage of a secondary battery. The positive electrode active material of one embodiment of the present invention has a stable crystal structure even at a high charge voltage. The stable crystal structure of the positive electrode active material in a charged state can inhibit a decrease in a full rechargeable capacity due to repeated charge and discharge.

A short circuit of a secondary battery might cause not only a malfunction in at least one of charge operation and discharge operation of the secondary battery but also heat generation and ignition. In order to obtain a safe secondary battery, a short circuit is preferably inhibited even at a high charge voltage. With the positive electrode active material of one embodiment of the present invention, a short circuit is inhibited even at a high charge voltage. Thus, a secondary battery with both a high discharge capacity and a high degree of safety can be obtained.

The description is made on the assumption that materials (such as a positive electrode active material, a negative electrode active material, and an electrolyte) of a secondary battery have not deteriorated unless otherwise specified. For example, the case where a full rechargeable capacity is higher than or equal to 97% of the rated capacity of a secondary battery can be regarded as a non-deteriorated state. The rated capacity conforms to JIS C 8711:2019. Note that in this specification and the like, in some cases, materials included in a secondary battery that have not deteriorated are referred to as initial products or materials in an initial state, and materials that have deteriorated (have a full rechargeable capacity lower than 97% of the rated capacity of the secondary battery) are referred to as products in use, materials in a used state, products that are already used, or materials in an already-used state.

### Embodiment 1

In this embodiment, a charging unit of one embodiment of the present invention and a power storage system that includes the charging unit of one embodiment of the present invention will be described.

### Example 1 of Power Storage System

### [Block Diagram]

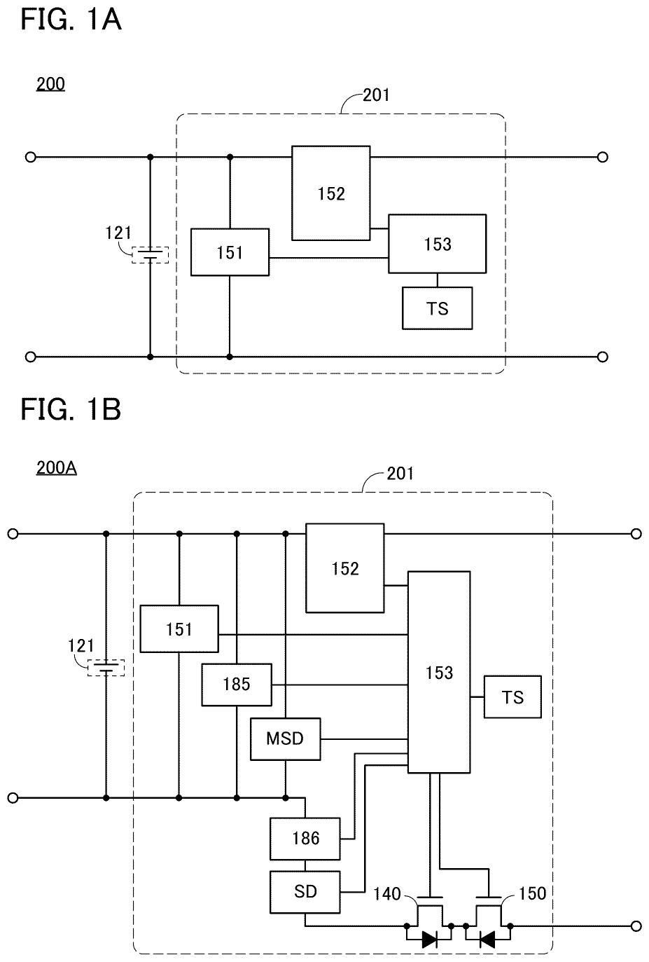

FIG. 1A is a block diagram illustrating an example of a power storage system 200. The power storage system 200 includes a charging unit 201 and a secondary battery 121. The charging unit 201 is electrically connected to a positive electrode and a negative electrode of the secondary battery 121.

The charging unit 201 includes a control circuit 153, a current measuring circuit 152, and a voltage measuring circuit 151. The control circuit 153 and the current measuring circuit 152 are electrically connected to each other. The control circuit 153 and the voltage measuring circuit 151 are electrically connected to each other. The charging unit 201 preferably includes a temperature sensor TS. The temperature sensor TS can measure the ambient temperature of the secondary battery. The temperature sensor TS is set to be in contact with an exterior body or a housing of the secondary battery, for example. Charge control using the temperature sensor TS will be described later.

The current measuring circuit 152 has a function of measuring current of the secondary battery 121 (current flowing through the secondary battery 121). In particular, the current measuring circuit 152 preferably has a function of measuring charge current of the secondary battery 121 (current flowing at the time of charging the secondary battery 121). The current measuring circuit 152 can supply the measured current value to the control circuit 153.

The voltage measuring circuit 151 has a function of measuring voltage of the secondary battery 121 (a potential difference generated between the positive electrode and the negative electrode of the secondary battery 121). In particular, the voltage measuring circuit 151 preferably has a function of measuring charge voltage of the secondary battery 121 (a potential difference generated between the positive electrode and the negative electrode at the time of charging the secondary battery 121). The voltage measuring circuit 151 can supply the measured voltage value to the control circuit 153.

The control circuit 153 has a function of controlling the start and stop of charge of the secondary battery 121. The control circuit 153 also has a function of controlling the charge conditions of the secondary battery 121. Specifically, the control circuit 153 has a function of controlling charge current of the secondary battery 121, for example.

As the control circuit 153, a CPU, an MCU (Micro Controller Unit), or the like can be used, for example.

The control circuit 153 has a function of calculating a change over time or a time differential of the voltage of the secondary battery 121 supplied from the voltage measuring circuit 151. Calculating a change over time or a time differential of voltage refers to, for example, obtaining a plurality of data sets of voltage values and time and performing an arithmetic operation using the obtained plurality of data sets. Note that the control circuit 153 preferably includes an analog-digital converter circuit. In the case where the obtained voltage value of the secondary battery 121 is an analog value, the control circuit 153 can convert the analog value into a digital value with the use of the analog-digital converter circuit. In the case where an MCU is used as the control circuit 153, the control circuit 153 can include the voltage measuring circuit 151 and an analog-digital converter circuit unit. The analog-digital converter circuit may be prepared separately from the control circuit 153.

The control circuit 153 has a function of calculating a time integral of current of the secondary battery 121 supplied from the current measuring circuit 152, i.e., a function of calculating the amount of electricity of the secondary battery 121. Calculating a time integral of current, i.e., calculating the amount of electricity, refers to, for example, obtaining a plurality of data sets of current values and time and performing an arithmetic operation using the obtained plurality of data sets. The control circuit 153 has a function of calculating a voltage differential of the amount of electricity (dQ/dV) of the secondary battery 121. Calculating a voltage differential of the amount of electricity refers to, for example, obtaining a plurality of data sets of voltage values, current values, and time and performing an arithmetic operation using the obtained plurality of data sets.

The control circuit 153 includes a memory circuit. The memory circuit has a function of a register or a cache memory in a CPU or an MCU, for example. The memory circuit has a function of storing, for example, various programs used in the power storage system 200, various kinds of data necessary for the operation of the power storage system 200, and the like.

FIG. 1B is a block diagram illustrating a power storage system 200A that is an example of the power storage system 200. The charging unit 201 included in the power storage system 200A illustrated in FIG. 1B includes, in addition to the components of the power storage system 200 illustrated in FIG. 1A, a detection circuit 185, a detection circuit 186, a short-circuit detection circuit SD, a micro short-circuit detection circuit MSD, a transistor 140, and a transistor 150. The detection circuit 185, the detection circuit 186, the short-circuit detection circuit SD, the micro short-circuit detection circuit MSD, the transistor 140, and the transistor 150 will be described in detail later.

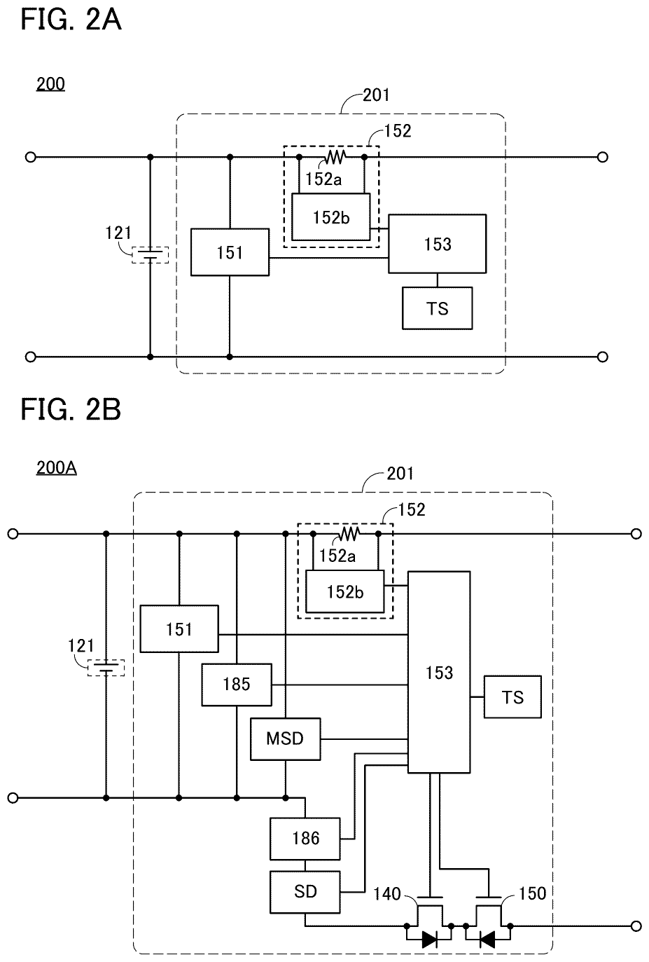

FIG. 2A and FIG. 2B are block diagrams illustrating a specific structure example of the current measuring circuit 152 in the charging unit 201 included in the power storage system 200 illustrated in FIG. 1A and the power storage system 200A illustrated in FIG. 1B. As illustrated in FIG. 2A and FIG. 2B, the current measuring circuit 152 includes a resistor 152a and a circuit 152b.

The resistor 152a has a function of a shunt resistor. The circuit 152b has a function of measuring voltages at both ends of the resistor 152a.

Note that the current measuring circuit 152 is not limited to having a resistance detection structure using a shunt resistor (the resistor 152a) as illustrated in FIG. 2A and FIG. 2B. The current measuring circuit 152 may have a magnetic field detection structure using a coil, a Hall element, a magnetoresistive element, a magnetic impedance element, a flux gate, or the like, for example.

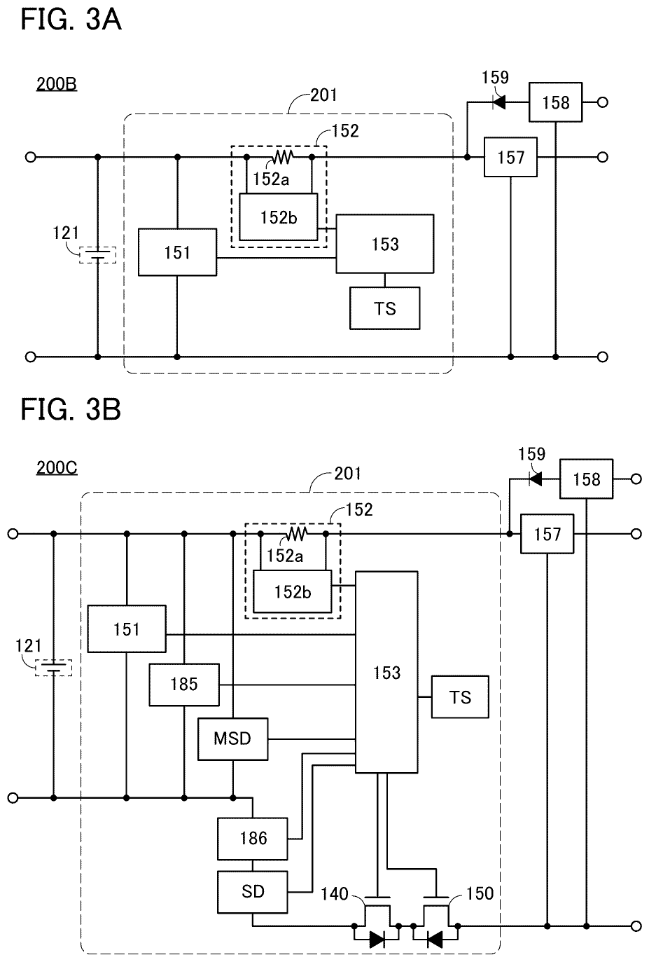

FIG. 3A and FIG. 3B are block diagrams illustrating a power storage system 200B and a power storage system 200C that are other examples of the power storage system 200. The power storage system 200B and the power storage system 200C illustrated in FIG. 3A and FIG. 3B each include, in addition to the components illustrated in FIG. 2A and FIG. 2B, a DC-DC converter 157, a circuit 158, and a diode 159.

As illustrated in FIG. 3A and FIG. 3B, the power storage system 200B and the power storage system 200C may each include the DC-DC converter 157. The DC-DC converter 157 includes a voltage converter circuit (not illustrated) and a control circuit (not illustrated). The DC-DC converter 157 has a function of converting the voltage of the secondary battery 121 and outputting the converted voltage.

As illustrated in FIG. 3A and FIG. 3B, the power storage system 200B and the power storage system 200C may each include the circuit 158. The circuit 158 preferably has a function of an AC adapter. That is, the circuit 158 has a function of converting AC power into DC power, for example. The circuit 158 has a function of converting voltage, for example. The circuit 158 has a function of supplying power that has been converted into DC to the secondary battery 121. The circuit 158 may have a function of controlling a current value and a voltage value that are to be supplied when supplying power to the secondary battery 121. Alternatively, the circuit 158 may have a function of controlling a current value and a voltage value that are to be supplied to the secondary battery 121, on the basis of a signal supplied from the control circuit 153.

In each of the power storage system 200B and the power storage system 200C illustrated in FIG. 3A and FIG. 3B, the diode 159 may be provided between the circuit 158 and the charging unit 201. The diode 159 has a function of inhibiting reverse current from the charging unit 201 to the circuit 158.

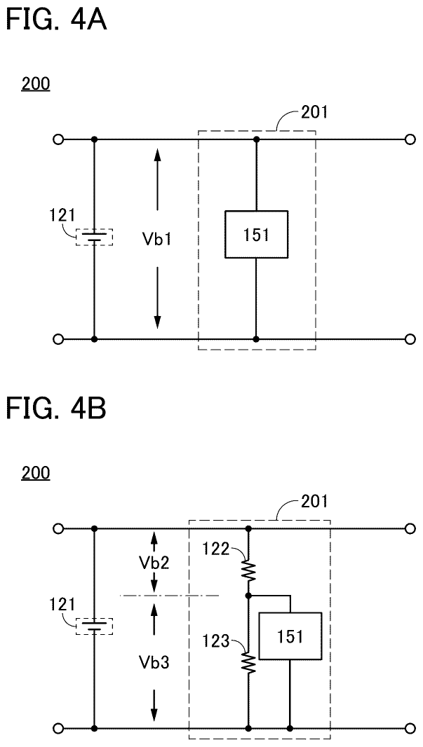

FIG. 4A and FIG. 4B are block diagrams illustrating the measurement of the voltage of the secondary battery 121 by the voltage measuring circuit 151 in the power storage system 200, for example. The voltage measuring circuit 151 measures voltage Vb1 between the positive electrode and the negative electrode of the secondary battery 121 as illustrated in FIG. 4A in some cases, and measures voltage obtained by dividing the voltage Vb1 by resistors as illustrated in FIG. 4B in other cases.

In FIG. 4B, the voltage Vb1 is divided into voltage Vb2 and voltage Vb3 by a resistor 122 and a resistor 123. The voltage measuring circuit 151 measures the voltage Vb3 obtained by the resistor voltage division.

In the case of measuring the voltage Vb3 obtained by dividing the voltage Vb1 between the positive electrode and the negative electrode of the secondary battery 121 by the resistors as illustrated in FIG. 4B, the voltage measuring circuit 151 or the control circuit 153 may estimate the voltage Vb1 between the positive electrode and the negative electrode of the secondary battery 121 from the voltage Vb3 obtained by the resistor voltage division.

The charging unit 201 preferably has a function of a coulomb counter. For example, the charging unit 201 has a function of calculating a charge capacity (the amount of electricity charged) and a discharge capacity of the secondary battery 121 by calculating the amount of accumulated electricity of the secondary battery 121 with the use of the current measuring circuit 152 and the control circuit 153. The charging unit 201 may have a function of analyzing the charge depth (SOC: State of Charge) with the use of the calculated charge capacity (amount of electricity charged) and discharge capacity.

### [Secondary Battery]

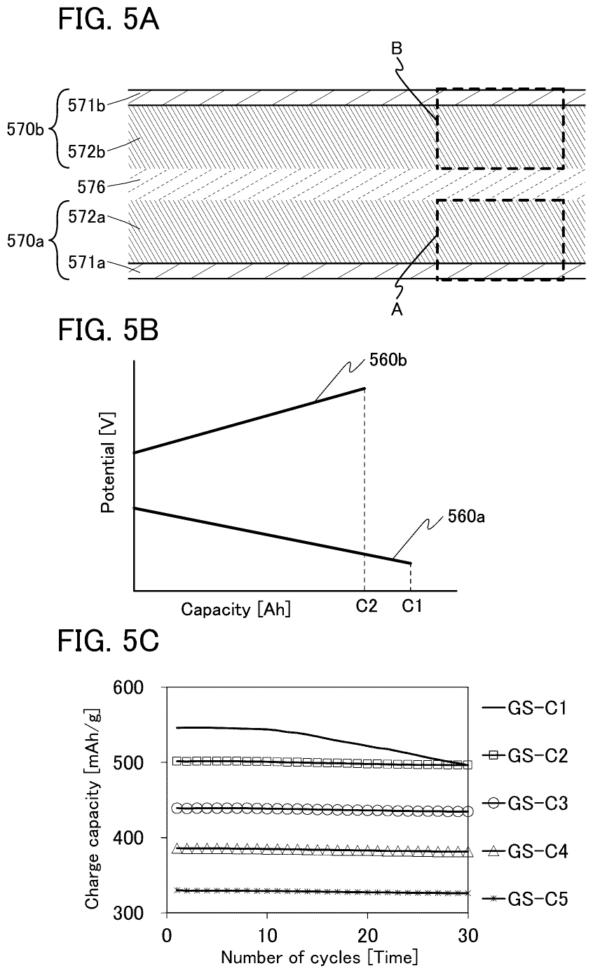

FIG. 5A is a schematic cross-sectional view of a negative electrode 570a, a positive electrode 570b, and a separator 576 included inside the secondary battery 121. The negative electrode 570a includes a negative electrode current collector 571a and a negative electrode active material layer 572a, and the positive electrode 570b includes a positive electrode current collector 571b and a positive electrode active material layer 572b. FIG. 5B is a graph showing the capacity ratio between the negative electrode 570a and the positive electrode 570b in regions surrounded by a dashed line A and a dashed line B in FIG. 5A. The secondary battery may include the separator between the negative electrode 570a and the positive electrode 570b.

The details of a secondary battery that can be used as the secondary battery 121 will be described later.

### [Capacity Ratio Between Negative Electrode and Positive Electrode]

A negative electrode characteristic curve 560a and a positive electrode characteristic curve 560b shown in FIG. 5B are characteristic curves showing the relationship between the capacities and the potentials of the negative electrode active material layer 572a and the positive electrode active material layer 572b included in the negative electrode 570a and the positive electrode 570b that have the same areas and face each other in the regions surrounded by the dashed line A and the dashed line B in FIG. 5A.

As for the negative electrode characteristic curve 560a in FIG. 5B, a capacity C1 is a total rechargeable and dischargeable capacity of the negative electrode 570a. The rechargeable and dischargeable capacity of the negative electrode 570a refers to, for example, a charge capacity of the case where a half cell including the negative electrode 570a and a lithium metal is fabricated, constant voltage discharge (lower current density limit of 0.02 C) is performed after constant current discharge (0.2 C, lower voltage limit of 0.01 V), and then constant current charge (0.2 C, upper voltage limit of 1 V) is performed. As for the positive electrode characteristic curve 560b in FIG. 5B, a capacity C2 is the capacity of the positive electrode of the secondary battery in a fully charged state.

In the secondary battery 121 of one embodiment of the present invention, the negative electrode active material layer 572a contains graphite and silicon as a negative electrode active material. FIG. 5C shows the results of charge and discharge cycle tests on half cells each of which is fabricated using an electrode containing graphite and silicon at a weight ratio of 9:1, and the results reveal that charge and discharge capacity limitation can inhibit deterioration due to the charge and discharge cycles. Table 1 shows the conditions in FIG. 5C, the maximum charge capacities in charge and discharge, and the capacity retention rates at the 30th cycle.

TABLE 1

| | Capacity | Maximum charge | Charge |
|---|---|---|---|
| | limitation | capacity | capacity [%] |
| | condition | [mAh/g] | at 30th cycle |
| GS-C1 | Not limited | 546.1 | 90.91 |
| GS-C2 | 90% | 501.5 | 98.96 |
| GS-C3 | 80% | 439.2 | 99.00 |
| GS-C4 | 70% | 385.8 | 98.86 |
| GS-C5 | 60% | 330.1 | 98.75 |

As shown in FIG. 5C and Table 1, the capacity limitation is preferably imposed on the negative electrode containing graphite and silicon as the negative electrode active material. That is, by using the capacity that is preferably greater than or equal to 50% and less than 100%, further preferably greater than or equal to 70% and less than 90% of the rechargeable and dischargeable capacity of the negative electrode 570a in the secondary battery 121, the rechargeable and dischargeable capacity can be increased and deterioration of the charge and discharge capacity can be inhibited.

The capacity limitation described above can be conducted at the time of charging the secondary battery included in the power storage system of one embodiment of the present invention.

### [Charge]

Next, charge of a secondary battery using the charging unit of one embodiment of the present invention will be described.

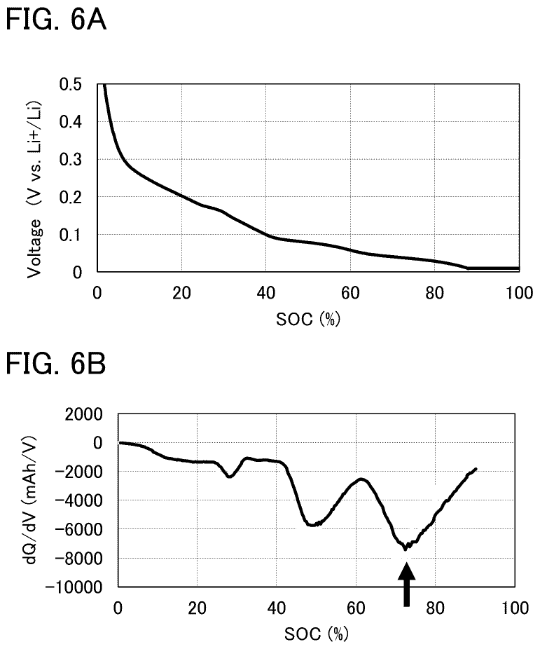

FIG. 6A is a graph showing a discharge curve of a half cell fabricated using an electrode containing graphite and silicon (corresponding to a negative electrode potential during charge in the case of a full cell using the electrode as a negative electrode). The vertical axis of the graph in FIG. 6A represents the voltage of the half cell, which corresponds to the negative electrode potential in the case of the full cell. The horizontal axis of the graph represents the SOC (State Of Charge, charge rate). In this specification, a half cell refers to a cell using a lithium metal for a negative electrode, and an electrode containing graphite and silicon functions as a positive electrode in a half cell. In this specification, a full cell refers to a cell using a material other than a lithium metal for a negative electrode; for example, an electrode containing lithium cobalt oxide, lithium nickel-cobalt-manganese oxide, or lithium iron phosphate can be used as a positive electrode and an electrode containing graphite and silicon can be used as a negative electrode.

FIG. 6B is a graph showing a dQ/dV-SOC curve, which is a graph obtained by plotting voltage differential values of the amount of electricity discharged on the discharge curve in FIG. 6A. As shown in FIG. 6B, the dQ/dV-SOC curve of the electrode containing graphite and silicon has some local minimum values (also referred to as downward peaks or downward convex peaks). These downward peaks probably correspond to structural changes of a lithium graphite compound. Among these downward peaks, the downward peak indicated by an arrow in the graph is preferably used for charge control using the charging unit of one embodiment of the present invention.

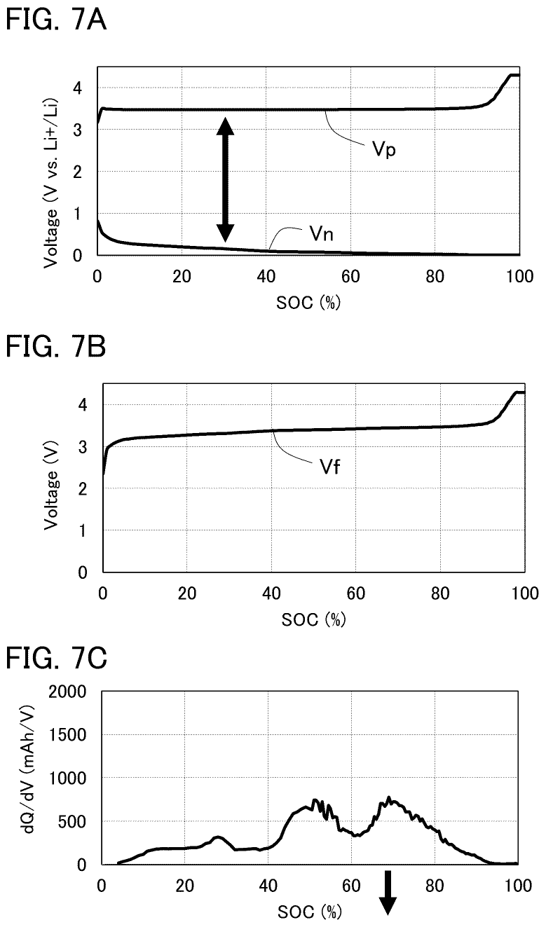

For example, when the charge is stopped after a certain period of time has elapsed since passing the downward peak is sensed in the charge, the capacity of the electrode containing graphite and silicon can be limited to the capacity that is greater than or equal to 70% and less than 90% of the rechargeable and dischargeable capacity. Note that the downward peaks shown in FIG. 6B correspond to upward peaks (also referred to as local maximum values or upward convex peaks) in the case of a full cell using the electrode containing graphite and silicon as a negative electrode. This is described with reference to FIG. 7.

FIG. 7A is a graph showing the relationship between an SOC and each of a positive electrode potential Vp and a negative electrode potential Vn in a full cell using an electrode containing graphite and silicon as a negative electrode and using a positive electrode containing lithium iron phosphate, for example. The voltage Vf of the full cell is a difference between the positive electrode potential Vp and the negative electrode potential Vn as indicated by a double-headed arrow in FIG. 7A. The relationship between the voltage Vf and the SOC (the charge curve) of the full cell is as shown in a graph of FIG. 7B.

FIG. 7C is a graph showing a dQ/dV-SOC curve calculated from the charge curve of the full cell. The downward peak indicated by the arrow in FIG. 6B corresponds to an upward peak indicated by an arrow in FIG. 7C. Described below is a method for charging the power storage system in which capacity limitation can be performed by stopping charge after a certain period of time has elapsed since the upward peak is sensed.

The secondary battery using the charging unit of one embodiment of the present invention is preferably capable of determining the upper limit voltage of charge on the basis of a waveform obtained in the charge. Here, the waveform can have a variety of shapes, for example, a curve, a straight line, and a combined shape of a curve and a straight line. The waveform is not limited to a periodic wave. Examples of the waveform obtained in the charge include a dQ/dV-V curve and a ΔV-t curve obtained from data of voltage, time, and current in the charge. That is, in the secondary battery using the charging unit of one embodiment of the present invention, an extremum attributed to a change in the structure of the negative electrode active material is preferably detected in the waveform obtained in the charge. When the charge depth of the negative electrode containing the negative electrode active material of one embodiment of the present invention is approximately 70% or in its vicinity, an extremum is observed in a voltage differential curve of the amount of electricity (dQ/dV curve) of the secondary battery, for example. The charging unit of one embodiment of the present invention has a function of detecting the extremum and controlling the charge.

In this specification, an extremum refers to the maximum value or the minimum value in a partial region of a curve such as a dQ/dV curve. The maximum value in the region is referred to as a local maximum value, and detection of a local maximum value may be rephrased as detection of a local maximum. The minimum value in the region is referred to as a local minimum value, and detection of a local minimum value may be rephrased as detection of a local minimum. In the case where three upward convex peaks exist in the entire region of a dQ/dV curve, for example, it can be said that three local maximum values are detected or three local maximums are detected.

The extremum attributed to the change in the structure of the negative electrode active material is detected, for example, in a voltage change curve over time of a secondary battery. Alternatively, the extremum is detected in a time differential curve of voltage (dV/dt curve) of the secondary battery.

Alternatively, the extremum attributed to the change in the structure of the negative electrode active material is detected in a dQ/dV curve, for example.

Constant-current constant-voltage (CCCV) charge is used in some cases to charge a secondary battery. In CCCV charge, constant current charge is performed up to the upper limit voltage of charge and then constant voltage charge is performed. When the constant voltage charge is performed at the upper limit voltage of the constant current charge in the CCCV charge, for example, the charge can be performed at the upper limit voltage over an adequate time and the charge capacity (the amount of electricity charged) is less likely to be influenced by a change of impedance or the like due to deterioration of the secondary battery, so that the charge capacity (the amount of electricity charged) can have fewer variations.

By setting the charge depth of the negative electrode containing graphite and silicon shallow, the lifetime of the secondary battery can be increased; however, when the charge depth is too shallow, the discharge capacity of the secondary battery becomes small. Accordingly, the charge depth is, for example, preferably greater than or equal to 50%, further preferably greater than or equal to 60%, still further preferably greater than or equal to 70%, yet still further preferably greater than or equal to 80%. The charge depth may be greater than 85%.

Here, the charge depth of the negative electrode containing graphite and silicon refers to a value normalized with the charge capacity (the amount of electricity charged) per weight of the negative electrode active material (graphite and silicon), and a state where all lithium that can be inserted into the negative electrode active material is inserted is regarded as a charge depth of 100%.

In the charging unit of one embodiment of the present invention, an extremum attributed to a change in the structure of the negative electrode active material can be detected in a dQ/dV curve or the like, and constant current charge can be performed. Constant current charge using the detection of the extremum is easy and good in controllability. Thus, with the use of the charging unit of one embodiment of the present invention, a secondary battery in which a variation in charge capacity (amount of electricity charged) is small and deterioration due to charge at a high voltage is inhibited can be achieved.

### Example 1 of Charge Method

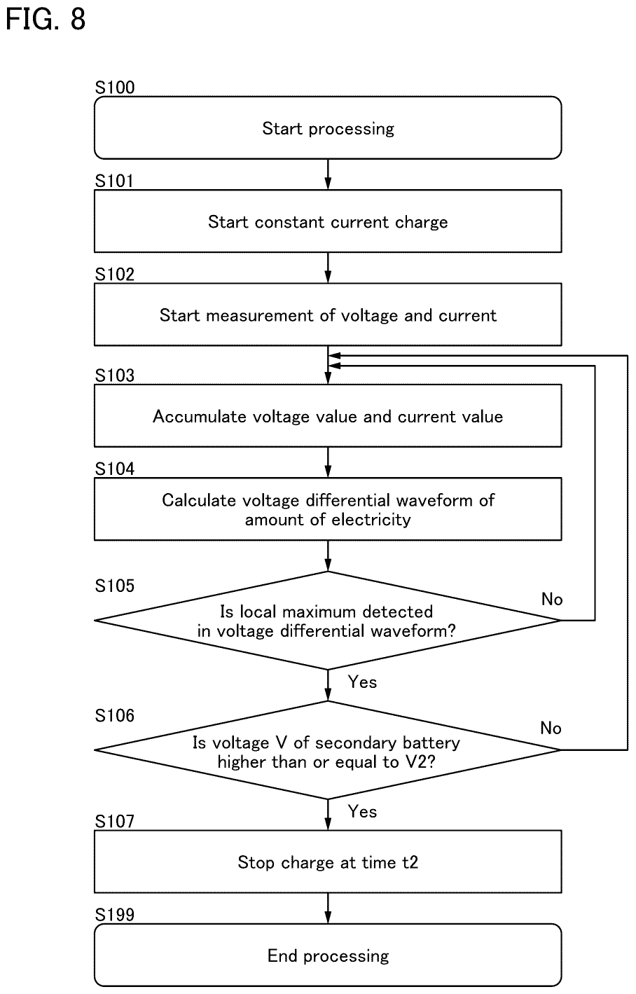

Next, an example of a charge method using the charging unit of one embodiment of the present invention will be described with reference to a flowchart shown in FIG. 8.

First, processing is started in Step S100.

Next, in Step S101, constant current charge of a secondary battery is started at a time t1. Note that the constant current charge is continuously performed until the charge is stopped in Step S107.

Next, in Step S102, the voltage measuring circuit 151 starts measurement of the voltage of the secondary battery. In addition, the current measuring circuit 152 starts measurement of the current of the secondary battery. The voltage measuring circuit 151 supplies the measured voltage value to the control circuit 153. The current measuring circuit 152 supplies the measured current value to the control circuit 153.

Next, in Step S103, the control circuit 153 accumulates, as a data set with time, the voltage values measured by the voltage measuring circuit 151 and the current values measured by the current measuring circuit 152 after Step S102. The memory circuit or the like included in the control circuit 153 can be used for data accumulation. As the time linked to the voltage values and the current values, an elapsed time from the start of the charge may be used, for example.

Next, in Step S104, the control circuit 153 calculates a voltage differential curve of the amount of electricity (a dQ/dV curve) of the secondary battery with the use of the data sets of time and the voltage values and current values accumulated at any time. Here, in Step S103, after the data sets of the voltage values, the current values, and time are accumulated for a predetermined time, the voltage differential curve of the amount of electricity of the secondary battery may be calculated. For example, the data sets may be accumulated in a period which is sufficient for detection of an extremum (a local maximum or a local minimum).

Next, in Step S105, the control circuit 153 analyzes a curve with a horizontal axis representing voltage V and a vertical axis representing a voltage differential of the amount of electricity Q, dQ/dV (hereinafter, a dQ/dV-V curve), and determines whether an extremum (also referred to as a peak) is detected. When an extremum, e.g., a local maximum (also referred to as an upward convex peak) here, is detected in the dQ/dV-V curve, the processing proceeds to Step S106. When the extremum is not detected, the processing returns to Step S103. Note that a plurality of extrema may be detected in the dQ/dV-V curve. In such a case, the highest extremum (the extremum at the highest voltage) of the plurality of extrema is detected. Alternatively, r (r is an integer greater than or equal to 2) higher extrema of the plurality of extrema are detected and any of the r extrema may be selected.

It is preferable that the control circuit 153 continuously accumulate the data sets of the voltage values, the current values, and time while the steps from Step S103 to Step S105 are being repeated. That is, when the steps from Step S103 to Step S105 are repeated n times, the dQ/dV-V curve can be calculated using all the pieces of data of n repetitions. Alternatively, data of the latest one or data of the latest several ones of the n repetitions may be used.

Next, in order to determine whether the detected extremum is a higher extremum (or a given extremum), determination whether the voltage V of the secondary battery is higher than or equal to a predetermined voltage is performed. Specifically, in Step S106, the control circuit 153 determines whether the voltage of the secondary battery is higher than or equal to a predetermined voltage. When the voltage V of the secondary battery is higher than or equal to voltage V2, the processing proceeds to Step S107. When the voltage V is lower than the voltage V2, the processing returns to Step S103.

Here, the voltage V2 can be a given value that depends on the relationship between a positive electrode active material and a negative electrode active material of the secondary battery. In the case where graphite and silicon are contained as the negative electrode active material and lithium iron phosphate is contained as the positive electrode active material, for example, the voltage V2 can be higher than or equal to 3.40 V and lower than or equal to 3.50 V. Alternatively, in the case where graphite and silicon are contained as the negative electrode active material and lithium nickel-cobalt-manganese oxide is contained as the positive electrode active material, the voltage V2 can be higher than or equal to 3.90 V and lower than or equal to 4.50 V. Alternatively, in the case where graphite and silicon are contained as the negative electrode active material and lithium cobalt oxide is contained as the positive electrode active material, the voltage V2 can be higher than or equal to 4.20 V and lower than or equal to 4.50 V, for example, can be 4.25 V.

Alternatively, in Step S106, the magnitude relationship between the voltage V and the voltage V2 may be determined on the basis of the charge depth of the secondary battery. For example, when the charge depth of the secondary battery is greater than or equal to S1%, the processing proceeds to Step S107, whereas when the charge depth is less than S1%, the processing returns to Step S103. Here, the value of S1 is greater than or equal to 70% and 90%, or greater than or equal to 75% and less than or equal to 85%.

The control circuit 153 can accumulate the data sets of the voltage values, the current values, and time continuously until the processing proceeds to Step S107 from the initial Step S103 of the repeated Steps S103.

Next, in Step S107, a time tp showing the extremum in the dQ/dV-V curve is detected by analysis, and the charge is stopped at a time t2 at which a predetermined time has elapsed from the time tp. Here, the predetermined time is, for example, the time required for stopping the charge by the control circuit 153. Alternatively, the time t2 may be set in the following manner: in the dQ/dV-V curve, a region having a desired voltage width with voltage giving the extremum as a center is determined and a time corresponding to the voltage at the top edge in the region is set as the time t2, for example. In the case where the extremum is not detected in Step S105, the charge may be stopped when the charge voltage reaches a predetermined charge voltage in Step S107.

As the conditions of stopping the charge in Step S107, the detection of the extremum is given here; alternatively, stopping the charge may be controlled on the basis of an elapsed time or the like from a detected inflection point, for example.

Smoothing of a curve to be analyzed may be performed. As a smoothing method, for example, a moving average may be used.

Here, the inflection point detected at the time tp is, for example, an inflection point attributed to a change in a structure of the negative electrode active material contained in the negative electrode of the secondary battery. Alternatively, the inflection point detected at the time tp is, for example, an inflection point attributed to a change in a crystal structure of the positive electrode active material contained in the positive electrode of the secondary battery.

By using a positive electrode active material described in Embodiment 3 as the positive electrode active material, for example, the collapse of the crystal structure of the positive electrode active material due to the repeated charge and discharge can be inhibited when the charge of the secondary battery is stopped at around the time tp.

Note that the mass of the positive electrode active material and the mass of the negative electrode active material are preferably adjusted such that the inflection point attributed to the change in the structure of the negative electrode active material contained in the negative electrode of the secondary battery and the inflection point attributed to the change in the crystal structure of the positive electrode active material contained in the positive electrode of the secondary battery are detected at the same time. In such a case, the inflection point attributed to the positive electrode and the inflection point attributed to the negative electrode overlap with each other; thus, the inflection point is more easily detected at the time tp.

A specific example of the inflection point that is attributed to the positive electrode and detected at the time tp can be an inflection point corresponding to a change of the crystal structure of the positive electrode active material from an O3 type crystal structure to an O3′ type crystal structure, with the use of the positive electrode active material described in Embodiment 3. The positive electrode active material here is, for example, lithium cobalt oxide. The charge voltage or the charge depth at the time t2 is preferably lower than the charge voltage or shallower than the charge depth at which the crystal structure of the positive electrode active material changes to an H1-3 type crystal structure. The O3 type crystal structure, the O3′ type crystal structure, and the H1-3 type crystal structure will be described in detail later. Note that the change from the O3 type crystal structure to the O3′ type crystal structure is expressed as a phase change in some cases.

In the power storage system of one embodiment of the present invention, the crystal structure of the positive electrode active material of the secondary battery can be controlled to be the O3′ type crystal structure at the time t2, for example. Accordingly, a change of the crystal structure of the positive electrode active material to an undesirable crystal structure due to the repeated charge and discharge of the secondary battery can be inhibited.

Note that in the case where, in the charge state corresponding to the time t2, the positive electrode is analyzed by an XRD pattern, the crystal structure to be determined is preferably expressed by the space group R-3m. Further preferably, the crystal structure to be determined is expressed by the space group R-3m and is indicated to be the O3′ type crystal structure.

For example, in the case where, in the charge state corresponding to the time t2, the positive electrode obtained by disassembling the secondary battery charged by the power storage system of one embodiment of the present invention is evaluated by the XRD pattern, a spectrum corresponding to the space group R-3m is observed. For measurement conditions, a measurement method, and the like, the following description can be referred to.

In the case where the positive electrode in the state before the charge of the secondary battery is also analyzed by the XRD pattern, the crystal structure to be determined is preferably expressed by the space group R-3m.

In the power storage system of one embodiment of the present invention, the crystal structure to be determined is expressed by the space group R-3m when the positive electrode is analyzed by the XRD pattern at the time t2 and before the charge, in which case a decrease in the discharge capacity of the secondary battery due to charge and discharge cycles can be small.

Here, the case is considered where the steps from Step S101 to Step S107 are repeated s times. Note that s is an integer greater than or equal to 2. In such a case, the time tp and the time t2 obtained on the basis of the extrema detected in Step S102 to Step S106 may be used in the next charge. Specifically, the time tp and the time t2 obtained in the (s−1)th charge may be used as the conditions of stopping the charge in Step S107 of the s-th charge.

Next, in Step S199, the processing ends.

Described above is the example in which the constant current charge is performed continuously in a period from the start of the charge in Step S101 to the stop of the charge in Step S107. In that case, the current value in the constant current charge is set to, for example, a constant current value in the period from the start of the charge in Step S101 to the stop of the charge in Step S107. Alternatively, the current value in the constant current charge may be changed stepwisely in the period from the start of the charge in Step S101 to the stop of the charge in Step S107. Specifically, for example, in the case where the steps from Step S103 to Step S105 are repeated n times, the current value may be changed after a certain number of times.

The charging unit of one embodiment of the present invention can analyze the charge characteristics of the secondary battery in Step S103 to Step S106 and change the charge conditions of the secondary battery in Step S107 in accordance with the analysis results. Specifically, the charge of the secondary battery can be stopped, for example. The charge characteristics analyzed in Step S103 to Step S106 vary in accordance with the ambient temperature in charge and discharge of the secondary battery, deterioration of the secondary battery due to charge and discharge cycles, and the like. The charging unit of one embodiment of the present invention can inhibit the deterioration of the secondary battery by changing the charge conditions of the secondary battery, e.g., the charge voltage or the like of the secondary battery, in accordance with the variation in the charge characteristics.

Alternatively, in Step S107, constant voltage charge may be performed after the time t2 at a voltage lower than or equal to the voltage of the secondary battery at the time t2. In the case where such constant voltage charge is performed, a current value that is greater than or equal to one-tenth and less than or equal to one-fifth of the charge current value in the constant current charge before the time t2 can be used as a termination current value of the constant voltage charge. Note that a termination current value of constant voltage charge means that charge is terminated when charge current in the constant voltage charge falls below the termination current value.

### Example 2 of Charge Method

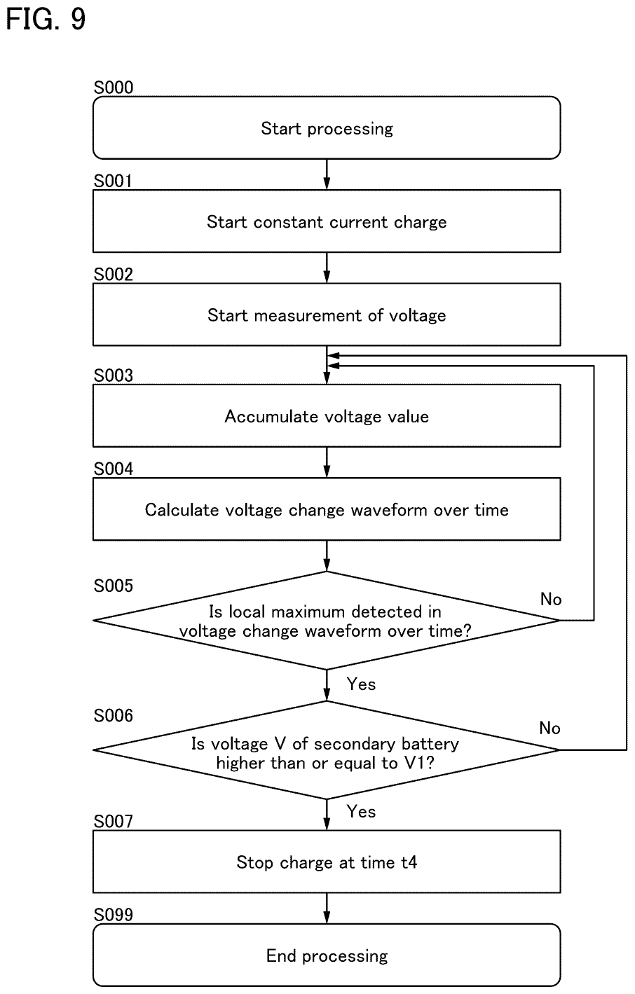

An example of a charge method using the charging unit of one embodiment of the present invention will be described with reference to a flowchart shown in FIG. 9. In the charge method shown in FIG. 9, a simpler arithmetic operation by the control circuit 153 in a smaller circuit scale than in the charge method shown in FIG. 8 can sometimes be performed.

Note that dQ/dV can be expressed by the following formula.

$$dQ / dV = ( dQ / dt ) \times ( dt / dV )$$

In constant current charge, dQ/dt is constant; thus, dQ/dV is proportional to dt/dV. Thus, by evaluating the dt/dV characteristics in the constant current charge, information similar to the dQ/dV characteristics can be obtained.

An example of evaluating the dt/dV characteristics in a region where constant current charge is performed will be described below. In acquisition of the dt/dV characteristics, the current value of a secondary battery is not needed to be acquired every time, and the acquisition of the dt/dV characteristics can be performed more easily than that of dQ/dV in some cases. In addition, only two parameters of voltage and time are to be acquired, and thus an arithmetic operation is simple and easy and the circuit scale can be reduced in some cases. Since the amount of data to be acquired can be reduced, the memory circuit scale can be reduced in some cases.

Furthermore, a dQ/dV change in the constant current charge is gentler than a dQ/dV change in constant voltage charge in some cases. Since the voltage of the secondary battery is constant in the constant voltage charge, the use of the estimated value of OCV (Open Circuit Voltage) enables dQ/dOCV to be used instead of dQ/dV. With the use of battery internal resistance R and charge current I, dOCV can approximate to R×dI.

In view of the above, even when the voltage resolution of a circuit that acquires the dt/dV characteristics in the constant current charge or the like is 12 bits or lower, for example, in the power storage system of one embodiment of the present invention, adequate evaluation can be performed. In particular, in the secondary battery using the positive electrode active material described in Embodiment 3, an extremum is observed stably in the dQ/dV curve in the constant current charge. Accordingly, charge can be controlled with high accuracy even in a simpler measurement system.

First, processing is started in Step S000.

Next, in Step S001, the constant current charge of the secondary battery is started at a time t3. Note that the constant current charge is continuously performed until the charge is stopped in Step S007.

Next, in Step S002, the voltage measuring circuit 151 starts measurement of the voltage of the secondary battery. The voltage measuring circuit 151 supplies the measured voltage value to the control circuit 153.

Next, in Step S003, the control circuit 153 accumulates, as a data set with time, the voltage values measured by the voltage measuring circuit 151 after Step S002. The memory circuit or the like included in the control circuit 153 can be used for data accumulation. As the time linked to the voltage values, an elapsed time from the start of the charge may be used, for example.

The obtained voltage values are converted from analog values into digital values in the control circuit 153. Alternatively, the control circuit 153 may use the obtained analog values in an arithmetic operation without converting them into digital values. Described here is an example in which an MCU is used as the control circuit 153 and an analog-digital converter circuit incorporated in the MCU is used to convert the voltage values.

Here, an MCU incorporating an analog-digital converter circuit having a 12-bit voltage resolution is used as an example.

When a change of a voltage value or an absolute value of a change of a voltage value becomes greater than or equal to a predetermined value, a data set containing the voltage value and time is acquired and accumulated. The predetermined value can be, for example, the minimum value of the voltage resolution of the analog-digital converter circuit or may be a value greater than or equal to the minimum value.

In the case where a change of a voltage value or an absolute value of a change of a voltage value is less than the predetermined value, a data set containing the voltage value and time is acquired and accumulated when a predetermined time has elapsed since the previous acquisition of the data set.

Next, in Step S004, the control circuit 153 calculates a voltage change over time of the secondary battery with the use of the data sets containing the voltage values and time accumulated at any time. The voltage change over time can be expressed as voltage [V(t)−V(t−Δt1)] using voltage V(t) at a time t and voltage V(t−Δt1) at a time (t−Δt1). The curve of a voltage change over time is referred to as a ΔV-t curve in some cases. It is acceptable to use a time differential of voltage (dV/dt) as the voltage change over time, for example. Note that the arithmetic operation of the change over time is performed after the time t satisfies t=Δt1. Here, in Step S003, the change over time may be calculated after the data sets containing the voltage values and time are accumulated for a predetermined time. For example, the data sets may be accumulated in a period which is sufficient for detection of an extremum.

Next, in Step S005, the control circuit 153 analyzes the curve of the voltage change over time of the secondary battery (e.g., the ΔV-t curve) and determines whether an extremum is detected. When an extremum, e.g., a local minimum (also referred to as a downward convex peak) here, is detected in the curve of the change over time, the processing proceeds to Step S006. When the extremum is not detected, the processing returns to Step S003. Note that a plurality of extrema may be detected in the ΔV-t curve. In such a case, the highest extremum of the plurality of extrema is detected. Alternatively, r (r is an integer greater than or equal to 2) higher extrema of the plurality of extrema are detected and any of the r extrema may be selected.

It is preferable that the control circuit 153 continuously accumulate the data sets containing the voltage values and time, while the steps from Step S003 to Step S005 are being repeated. That is, when the steps from Step S003 to Step S005 are repeated n times, the curve of the change over time can be calculated using all the pieces of data of n repetitions. Alternatively, data of the latest one or data of the latest several ones of the n repetitions may be used. Here, n is an integer greater than or equal to 1.

Next, in Step S006, the control circuit 153 determines whether the voltage of the secondary battery is higher than or equal to a predetermined voltage. When the voltage V of the secondary battery is higher than or equal to voltage V1, the processing proceeds to Step S007. When the voltage V is lower than the voltage V1, the processing returns to Step S003.

Here, the voltage V1 can be a given value that depends on the relationship between a positive electrode active material and a negative electrode active material of the secondary battery. In the case where graphite and silicon are contained as the negative electrode active material and lithium iron phosphate is contained as the positive electrode active material, for example, the voltage V1 can be higher than or equal to 3.40 V and lower than or equal to 3.50 V. Alternatively, in the case where graphite and silicon are contained as the negative electrode active material and lithium nickel-cobalt-manganese oxide is contained as the positive electrode active material, the voltage V1 can be higher than or equal to 3.90 V and lower than or equal to 4.50 V. Alternatively, in the case where graphite and silicon are contained as the negative electrode active material and lithium cobalt oxide is contained as the positive electrode active material, the voltage V1 can be higher than or equal to 4.20 V and lower than or equal to 4.50 V, for example, can be 4.25 V.

Here, when the voltage measuring circuit 151 measures voltages obtained by resistor division of the voltage between the positive electrode and the negative electrode of the secondary battery, an estimated value of the voltage between the positive electrode and the negative electrode of the secondary battery, which is estimated from the voltages obtained by the resistor division, is preferably used as the voltage V1.

Alternatively, in Step S006, the magnitude relationship between the voltage V and the voltage V1 may be determined on the basis of the charge depth of the secondary battery. For example, when the charge depth of the secondary battery is greater than or equal to S1%, the processing proceeds to Step S007, whereas when the charge depth is less than S1%, the processing returns to Step S003. Here, the value of S1 is greater than or equal to 70% and 90%, or greater than or equal to 75% and less than or equal to 85%.

The control circuit 153 can accumulate the data sets containing the voltage values and time continuously until the processing proceeds to Step S007 from the initial Step S003 of the repeated Steps S003.

Next, in Step S007, a time tq showing an extremum in the ΔV-t curve is detected by analysis, and charge is stopped at a time t4 at which a predetermined time has elapsed from the time tq. Alternatively, the time t4 may be set in the following manner: in the ΔV-t curve, a region having a desired time width with the time showing the extremum as a center is determined and a time corresponding to the time at the top edge in the region is set as the time t4, for example. Here, the predetermined time is, for example, the time required for stopping the charge by the control circuit 153. In the case where the extremum is not detected in Step S005, the charge may be stopped when the charge voltage reaches a predetermined charge voltage in Step S007.

As the conditions of stopping the charge in Step S007, the detection of the extremum is given here; alternatively, stopping the charge may be controlled on the basis of an elapsed time or the like from a detected inflection point, for example.

Here, the case is considered where the steps from Step S001 to Step S007 are repeated w times. Note that w is an integer greater than or equal to 2. In such a case, the time tq and the time t4 obtained on the basis of the extrema detected in Step S002 to Step S006 may be used in the next charge cycle. Specifically, the time tq and the time t4 obtained in the (w−1)th charge may be used as the conditions of stopping the charge in Step S007 of the w-th charge.

In Step S099, the processing ends.

Described above is the example in which the constant current charge is performed continuously in a period from the start of the charge in Step S001 to the stop of the charge in Step S007. In that case, the current value in the constant current charge is set to, for example, a constant current value in the period from the start of the charge in Step S001 to the stop of the charge in Step S007. Alternatively, the current value in the constant current charge may be changed stepwisely in the period from the start of the charge in Step S001 to the stop of the charge in Step S007. Specifically, for example, in the case where the steps from Step S003 to Step S005 are repeated n times, the current value may be changed after a certain number of times.

### Example 3 of Charge Method

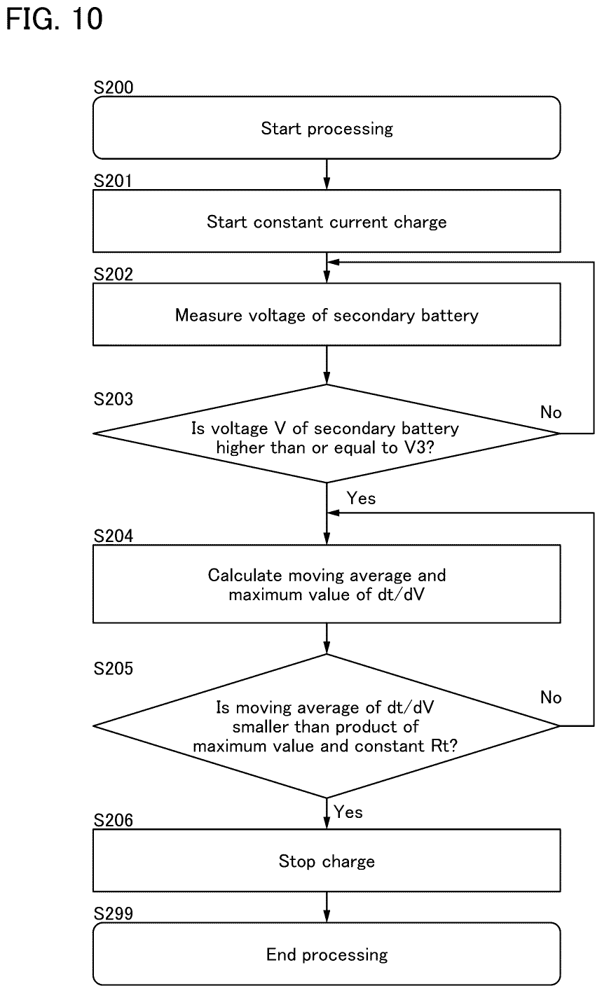

An example of a charge method using the charging unit of one embodiment of the present invention will be described with reference to a flowchart shown in FIG. 10.

First, processing is started in Step S200.

Next, in Step S201, constant current charge of a secondary battery is started. Note that the constant current charge is continuously performed until the charge is stopped in Step S206.

Next, in Step S202, the voltage measuring circuit 151 starts measurement of the voltage of the secondary battery. The measured voltage V is supplied from the voltage measuring circuit 151 to the control circuit 153.

Next, in Step S203, the control circuit 153 compares the measured voltage V and a predetermined voltage V3. When the voltage V is higher than or equal to the voltage V3, the processing proceeds to Step S204, whereas when the voltage V is lower than the voltage V3, the processing returns to Step S202.

Here, the voltage V3 can be a given value that depends on the relationship between a positive electrode active material and a negative electrode active material of the secondary battery. In the case where graphite and silicon are contained as the negative electrode active material and lithium iron phosphate is contained as the positive electrode active material, for example, the voltage V3 can be higher than or equal to 3.40 V and lower than or equal to 3.50 V. Alternatively, in the case where graphite and silicon are contained as the negative electrode active material and lithium nickel-cobalt-manganese oxide is contained as the positive electrode active material, the voltage V3 can be higher than or equal to 3.90 V and lower than or equal to 4.50 V. Alternatively, in the case where graphite and silicon are contained as the negative electrode active material and lithium cobalt oxide is contained as the positive electrode active material, the voltage V3 can be higher than or equal to 4.20 V and lower than or equal to 4.50 V, for example, can be 4.25 V.

In Step S204, the control circuit 153 evaluates dQ/dV. Since charge current is constant, a value of dt/dV is measured. The values of dt/dV can be accumulated at any time in a charge process. With the use of the accumulated data sets containing the voltages V and the time t, the moving average of dt/dV, [dt/dV]mean, and the maximum value of dt/dV, [dt/dV]max, are calculated.

Note that as a value corresponding to dt/dV, for example, a time required for voltage to change by a predetermined value may be calculated. The predetermined value may be, for example, greater than or equal to 0.5 mV and less than or equal to 10 mV.

Next, in Step S205, the moving average [dt/dV]mean is compared with a value obtained by multiplying the maximum value [dt/dV]max by a constant Rt. When the moving average [dt/dV]mean is less than the value obtained by multiplying the maximum value [dt/dV]max by the constant Rt, the processing proceeds to Step S206. When the moving average [dt/dV]mean is greater than or equal to the value obtained by multiplying the maximum value [dt/dV]max by the constant Rt, the processing returns to Step S204.

The time at which the moving average [dt/dV]mean is less than the value obtained by multiplying the maximum value [dt/dV]max by the constant Rt corresponds to, for example, a time at which dt/dV decreases from the local maximum value of the voltage V3 and its vicinity to (Rt×100)% of the local maximum value in the dt/dV curve. Note that the constant Rt is greater than 0 and less than or equal to 1.

In Step S206, the charge of the secondary battery is stopped.

Next, in Step S299, the processing ends.

The example of the constant current charge is shown in the flowchart of FIG. 10. However, in the case where the charge current is not constant, for example, the average value in the measurement time of the amount of electricity Q and the time in the vicinity thereof may be compared with a value obtained by multiplying the maximum value of the amount of electricity Q by a constant, instead of the comparison between the moving average of dt/dV, [dt/dV]mean, and the value obtained by multiplying the maximum value of the voltage, [dt/dV]max, by the constant Rt.

### Example 1 of Voltage Measuring Circuit

A voltage measuring circuit 151A is described as an example of the voltage measuring circuit 151 included in the charging unit 201.

### Structure Example

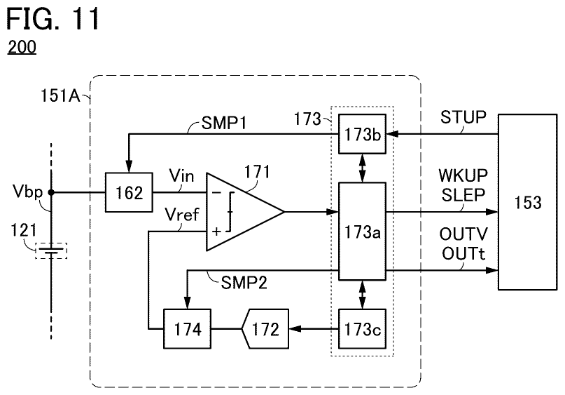

FIG. 11 is a block diagram illustrating a structure example of the voltage measuring circuit 151A.

As illustrated in FIG. 11, the voltage measuring circuit 151A includes a sample-and-hold circuit (S/H) 162, an S/H 174, a digital-analog converter circuit (DAC) 172, a comparator 171, and a control portion 173. The control portion 173 includes a signal processing circuit 173a, a timing circuit 173b, and a register 173c. FIG. 11 illustrates the secondary battery 121 and the control circuit 153 that are electrically connected to the voltage measuring circuit 151A in the power storage system 200 or the like.

In the following description of the voltage measuring circuit 151A, voltage refers to voltage with reference to the potential of the negative electrode of the secondary battery 121 unless otherwise specified.

The voltage measuring circuit 151A has a function of a successive approximation analog-digital converter circuit (ADC). The voltage measuring circuit 151A has a function of calculating the time required for the input voltage to change by a predetermined voltage value (e.g., 1 mV) (also referred to as a difference time or a time difference) and outputting the time. Thus, the voltage measuring circuit 151A may be referred to as a subtractor, a time measuring circuit, or the like, for example.

The S/H 162 has a function of obtaining (sampling) and holding voltage Vbp of the positive electrode of the secondary battery 121 in response to a signal SMP1. The S/H 162 also has a function of supplying a held voltage Vin to an inverting input terminal of the comparator 171.

The S/H 174 has a function of obtaining and holding voltage output from the DAC 172 in response to a signal SMP2. The S/H 174 also has a function of supplying a held voltage Vref to a non-inverting input terminal of the comparator 171.

The DAC 172 has a function of outputting an analog voltage on the basis of digital voltage data stored in the register 173c.

The comparator 171 has a function of comparing the levels of the voltage Vin and the voltage Vref and outputting voltage corresponding to digital data “1” (H level) or voltage corresponding to digital data “0” (L level) on the basis of the comparison result.

The signal processing circuit 173a has a function of performing various kinds of processing in accordance with the output of the comparator 171, a signal from the timing circuit 173b, and the like, for example. As for various kinds of processing, the signal processing circuit 173a has a function of updating the voltage data stored in the register 173c, for example. The signal processing circuit 173a has a function of outputting, to the control circuit 153, the voltage data (data OUTV) stored in the register 173c and time data (data OUTt) from the timing circuit 173b, for example. The signal processing circuit 173a has a function of outputting the signal SMP2 for controlling the operation of the S/H 174, for example. The signal processing circuit 173a has a function of outputting a signal WKUP and a signal SLEP for transmitting the operation state of the voltage measuring circuit 151A to the control circuit 153, for example.

The timing circuit 173b has a function of performing various kinds of processing in accordance with a signal from the signal processing circuit 173a, a signal STUP supplied from the control circuit 153, and the like, for example. As for various kinds of processing, the timing circuit 173b has a function of outputting the signal SMP1 for controlling the operation of the S/H 162, for example. The timing circuit 173b has a function of measuring time, for example. For the measurement of time in the timing circuit 173b, a counter (not illustrated), an oscillator (not illustrated), and the like can be used, for example. The count value of the counter can be time data, for example.

The register 173c has a function of storing voltage data.

The circuits included in the voltage measuring circuit 151A (e.g., the S/H 162, the S/H 174, the DAC 172, the comparator 171, the signal processing circuit 173a, the timing circuit 173b, and the register 173c) each include a transistor containing silicon in its channel formation region (a Si transistor) or a circuit including a Si transistor. That is, the voltage measuring circuit 151A can be regarded as a semiconductor device. Some or all of the circuits may include a transistor containing an oxide semiconductor in its channel formation region (an OS transistor) or a circuit including an OS transistor.

An OS transistor has a feature of an extremely low off-state current (current flowing between a source and a drain when the transistor is in an off state) because the band gap of an oxide semiconductor where a channel is formed is greater than or equal to 2 eV. The off-state current value per micrometer of channel width of an OS transistor at room temperature can be less than or equal to 1 aA (1×10⁻¹⁸ A), less than or equal to 1 zA (1×10⁻²¹ A), or less than or equal to 1 yA (1×10⁻²⁴ A). Note that the off-state current value per micrometer of channel width of a Si transistor at room temperature is greater than or equal to 1 fA (1×10⁻¹⁵ A) and less than or equal to 1 pA (1×10⁻¹² A). In other words, the off-state current of an OS transistor is lower than that of a Si transistor by approximately ten orders of magnitude.

The off-state current of an OS transistor hardly increases even in a high-temperature environment. Specifically, the off-state current hardly increases even at an environmental temperature higher than or equal to room temperature and lower than or equal to 200° C. Furthermore, the on-state current of an OS transistor is unlikely to decrease even in a high-temperature environment. Meanwhile, the on-state current of a Si transistor decreases in a high-temperature environment. That is, an OS transistor has a higher on-state current than a Si transistor in a high-temperature environment. In an OS transistor, the ratio between on-state current and off-state current is large even at an environmental temperature higher than or equal to 125° C. and lower than or equal to 150° C.; thus, an excellent switching operation can be performed. Accordingly, a semiconductor device including an OS transistor can operate stably and have high reliability even in a high-temperature environment.

A semiconductor layer of an OS transistor preferably contains at least one of indium and zinc. A semiconductor layer of an OS transistor preferably contains indium, M (M is one or more kinds selected from gallium, aluminum, yttrium, tin, silicon, boron, copper, vanadium, beryllium, titanium, iron, nickel, germanium, zirconium, molybdenum, lanthanum, cerium, neodymium, hafnium, tantalum, tungsten, magnesium, and cobalt), and zinc, for example. In particular, M is preferably one or more kinds selected from gallium, aluminum, yttrium, and tin.

It is particularly preferable to use an oxide containing indium (In), gallium (Ga), and zinc (Zn) (also referred to as “IGZO”) for a semiconductor layer. Alternatively, an oxide containing indium (In), aluminum (Al), and zinc (Zn) (also referred to as “IAZO”) may be used for a semiconductor layer. Further alternatively, an oxide containing indium (In), aluminum (Al), gallium (Ga), and zinc (Zn) (also referred to as “IAGZO”) may be used for a semiconductor layer.

When a semiconductor layer is In-M-Zn oxide, the atomic proportion of In is preferably higher than or equal to the atomic proportion of M in the In-M-Zn oxide. Examples of the atomic ratio of the metal elements in such In-M-Zn oxide include In:M:Zn=1:1:1 or a composition in the neighborhood thereof, In:M:Zn=1:1:1.2 or a composition in the neighborhood thereof, In:M:Zn=2:1:3 or a composition in the neighborhood thereof, In:M:Zn=3:1:2 or a composition in the neighborhood thereof, In:M:Zn=4:2:3 or a composition in the neighborhood thereof, In:M:Zn=4:2:4.1 or a composition in the neighborhood thereof, In:M:Zn=5:1:3 or a composition in the neighborhood thereof, In:M:Zn=5:1:6 or a composition in the neighborhood thereof, In:M:Zn=5:1:7 or a composition in the neighborhood thereof, In:M:Zn=5:1:8 or a composition in the neighborhood thereof, In:M:Zn=6:1:6 or a composition in the neighborhood thereof, and In:M:Zn=5:2:5 or a composition in the neighborhood thereof. The atomic proportion of In may be lower than the atomic proportion of M in the In-M-Zn oxide. Examples of the atomic ratio of the metal elements in such In-M-Zn oxide include In:M:Zn=1:3:2 or a composition in the neighborhood thereof and In:M:Zn=1:3:4 or a composition in the neighborhood thereof. Note that a composition in the neighborhood includes the range of ±30% of an intended atomic ratio.

In a memory circuit (or a memory device) using an OS transistor and a capacitor, for example, electric charge accumulated in the capacitor can be held for a long time owing to an extremely low off-state current of the OS transistor. Thus, when a potential level corresponding to the amount of electric charge held in the capacitor is made to correspond to digital data “1” or “0”, the data can be retained in the memory circuit for a long time. Accordingly, a nonvolatile memory can be formed, for example.

In some or all of the circuits included in the voltage measuring circuit 151A, an OS transistor or a memory circuit using an OS transistor can be provided. For example, with the use of an OS transistor as a transistor included in the S/H 174, the voltage Vref held in the S/H 174 can be maintained for a long time even when power supply to the DAC 172 is stopped. For example, when a memory circuit using an OS transistor is provided in the register 173c, the voltage data stored in the register 173c can be retained for a long time even when power supply to the register 173c is stopped.

The voltage measuring circuit 151A can be in a sleep mode until the input voltage changes by a predetermined voltage value, i.e., while a change in the input voltage is smaller than the predetermined voltage value. In the sleep mode, for example, power supply to the DAC 172 and the register 173c can be stopped. Part of the operation of the signal processing circuit 173a may be stopped by, for example, power gating, clock gating, or the like. When the voltage measuring circuit 151A is transferred to the sleep mode, the signal processing circuit 173a can output the signal SLEP.

The voltage measuring circuit 151A can maintain the voltage Vref held in the S/H 174 and retain the voltage data stored in the register 173c even in the sleep mode. Thus, also in the sleep mode, the voltage Vbp can be obtained by the S/H 162 and the voltage Vin and the voltage Vref can be compared by the comparator 171.

In the case where the input voltage changes by a predetermined voltage value in the sleep mode, the output of the comparator 171 changes and accordingly the voltage measuring circuit 151A can wake up from the sleep mode. When the voltage measuring circuit 151A wakes up, power supply to the DAC 172 and the register 173c can be restarted, for example. In addition, the operation of the signal processing circuit 173a can be restarted. At the time of the wake-up, the signal processing circuit 173a can output the signal WKUP.

Note that, for example, an OS transistor or a memory circuit using an OS transistor may be provided in part of the control circuit 153. For another example, in the control circuit 153, part of the operation may be stopped by power gating, clock gating, or the like when the signal SLEP is supplied, and the operation may be restarted when the signal WKUP is supplied.

### Operation Example

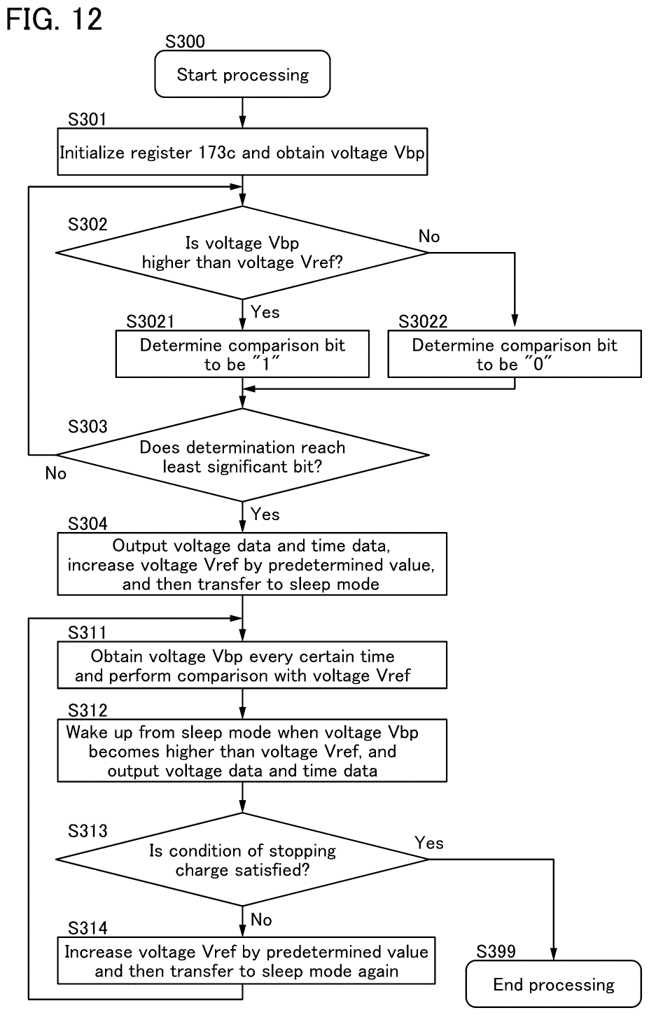

FIG. 12 is a flowchart showing an operation example of the voltage measuring circuit 151A.

First, in Step S300, the signal STUP is supplied from the control circuit 153, whereby processing is started. Note that the secondary battery 121 is assumed to be charged with a constant current.

Next, in Step S301 to Step S303, an analog input voltage is converted into digital voltage data to be stored in the register 173c. In Step S301 to Step S303, “1” or “0” is determined while successive approximation is performed bit by bit from the most significant bit to the least significant bit.

In Step S301, the register 173c is initialized. That is, only the most significant bit of the register 173c is set to “1”, and the others are all set to “0”. For example, in the case where the register 173c has 16-bit data, the data of the register 173c becomes “1000000000000000”. The data of the register 173c is converted into an analog voltage by the DAC 172, and the voltage is held as the voltage Vref in the S/H 174. In addition, the voltage Vbp of the positive electrode of the secondary battery 121 is obtained by the S/H 162 and held as the voltage Vin. After Step S301, the processing proceeds to Step S302.

In Step S302, whether the voltage Vbp (the voltage Vin obtained and held by the S/H 162 in Step S301) is higher than the voltage Vref is determined. That is, in the case where the voltage Vin is higher than the voltage Vref, the comparison bit is determined to be “1” in Step S3021. Alternatively, in the case where the voltage Vin is lower than or equal to the voltage Vref, the comparison bit is determined to be “0” in Step S3022. After Step S3021 or Step S3022, the processing proceeds to Step S303.

In Step S303, whether the determination reaches the least significant bit of the data of the register 173c is judged. In the case where the determination does not reach the least significant bit, the bit immediately below the lowest bit that has been currently determined of the register 173c is set to “1” and the processing returns to Step S302. Alternatively, in the case where the determination reaches the least significant bit, the processing proceeds to Step S304. In the case where the register 173c has 16-bit data, for example, the determination can reach the least significant bit by repeating Step S302 to Step S303 16 times.

Next, in Step S304, the voltage data of the register 173c and the time data of the timing circuit 173b (the count value of the counter) are output and the voltage measuring circuit 151A is transferred to the sleep mode. At this time, the signal SLEP is output. Here, before the voltage measuring circuit 151A is transferred to the sleep mode, the data of the register 173c is updated to data that is higher by a predetermined data value (e.g., a data value corresponding to 1 mV). Accordingly, the voltage output from the DAC 172 is increased by a predetermined voltage value (e.g., 1 mV), and the voltage is held in the S/H 174. That is, the voltage Vref held in the S/H 174 is increased by a predetermined voltage value, and then the voltage measuring circuit 151A is transferred to the sleep mode. After Step S304, the processing proceeds to Step S311.

Next, in Step S311 to Step S314, the time required for the input voltage to change by a predetermined voltage value is calculated and the time is output.

In Step S311, the voltage Vbp is obtained by the S/H 162 every certain time (e.g., 100 ms) and held as the voltage Vin. In addition, the comparator 171 compares the voltage Vin with the voltage Vref. After Step S311, the processing proceeds to Step S312.

In Step S312, the voltage Vbp (the voltage Vin obtained and held by the S/H 162 in Step S311) becomes higher than the voltage Vref, so that the output of the comparator 171 changes (e.g., from the H level to the L level). Thus, the voltage measuring circuit 151A wakes up from the sleep mode. At this time, the signal WKUP is output. After the wake-up from the sleep mode, the voltage data of the register 173c and the time data of the timing circuit 173b are output. After Step S312, the processing proceeds to Step S313.

In Step S312, a difference between the count value of the counter at the time of the previous output and the count value of the counter at the time of the present output may be calculated to output the data of the difference time as the time data. That is, the data of the difference time is data of the time required for the input voltage to change by a predetermined voltage value.

In Step S313, whether the conditions of stopping the charge are satisfied is determined. As the conditions of stopping the charge, for example, the conditions described above in Example 1 of charge method to Example 3 of charge method can be used as appropriate. In the case where the conditions of stopping the charge are satisfied, the processing ends in Step S399. Alternatively, in the case where the conditions of stopping the charge are not satisfied, the processing proceeds to Step S314.

In Step S399, a signal for indicating the fact that the conditions of stopping the charge are satisfied is preferably transmitted to the control circuit 153 so that the constant current charge of the secondary battery 121 by the charging unit 201 is stopped in the power storage system 200.

In Step S314, the data of the register 173c is updated to data that is higher by a predetermined data value. Accordingly, the voltage output from the DAC 172 is increased by a predetermined voltage value, and the voltage is held in the S/H 174. That is, the voltage Vref held in the S/H 174 is increased by a predetermined voltage value. After that, the signal SLEP is output and the voltage measuring circuit 151A is transferred to the sleep mode again. After Step S314, the processing returns to Step S311.

As described above, the voltage measuring circuit 151A can calculate the time required for the voltage Vbp of the secondary battery 121 to change by a predetermined voltage value (e.g., 1 mV) and output the time. The voltage measuring circuit 151A can be in the sleep mode until the voltage Vbp changes by a predetermined voltage value, i.e., while a change in the voltage Vbp is smaller than the predetermined voltage value. When the voltage measuring circuit 151A is in the sleep mode, power supply to the DAC 172 and the register 173c can be stopped and part of the operation of the signal processing circuit 173a can be stopped, for example. Thus, the power consumption of the voltage measuring circuit 151A can be reduced.

In the above description, for example, the time required for the voltage Vbp to increase by a predetermined voltage value at the time of the charge of the secondary battery 121 can be calculated. Meanwhile, for example, the time required for the voltage Vbp to decrease by a predetermined voltage value at the time of the discharge of the secondary battery 121 may be calculated. In that case, for example, in Step S304 and Step S314, the data of the register 173c is updated to data that is lower by a predetermined data value. That is, the voltage Vref held in the S/H 174 is decreased by a predetermined voltage value.

The charging unit that can be used for the power storage system of one embodiment of the present invention includes the voltage measuring circuit 151A, so that the power consumption can be reduced.

### Example 2 of Voltage Measuring Circuit

A voltage measuring circuit 151B is described as another structure example of the voltage measuring circuit 151 included in the charging unit 201. The voltage measuring circuit 151B is a modification example of the above-described voltage measuring circuit 151A. Therefore, differences of the voltage measuring circuit 151B from the voltage measuring circuit 151A are mainly described to reduce repeated description. Note that the above description of the voltage measuring circuit 151A can be referred to as appropriate.

### Structure Example

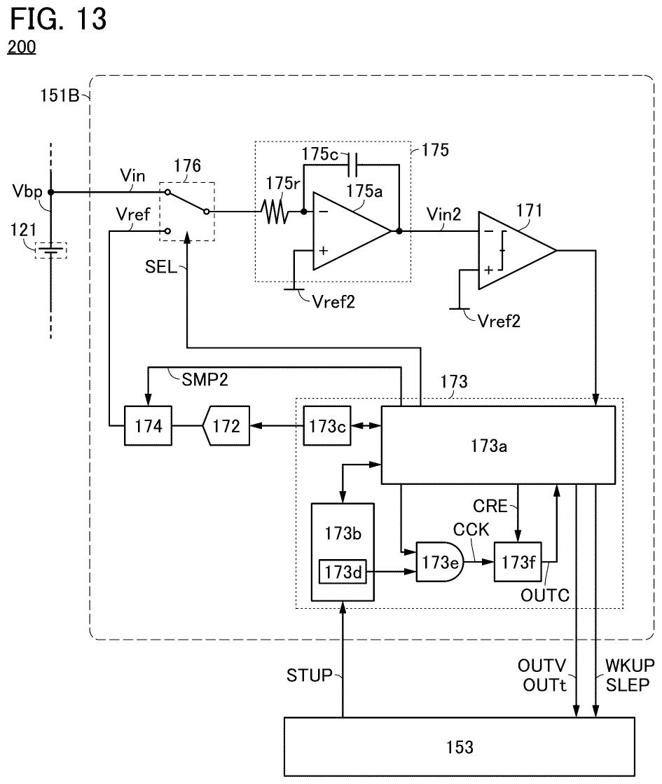

FIG. 13 is a block diagram illustrating a structure example of the voltage measuring circuit 151B.

As illustrated in FIG. 13, the voltage measuring circuit 151B includes an integrator circuit 175 and a selection circuit 176 in addition to the above-described components of the voltage measuring circuit 151A. The voltage measuring circuit 151B is different from the voltage measuring circuit 151A in that the S/H 162 is not necessarily included. The voltage measuring circuit 151B includes, in the control portion 173, an oscillator 173d in the timing circuit 173b, an AND circuit 173e, and a counter 173f in addition to the above-described components of the voltage measuring circuit 151A.

The voltage measuring circuit 151B has a function of a double integrating type analog-digital converter circuit (ADC). The voltage measuring circuit 151B has a function of calculating the time required for the input voltage to change by a predetermined voltage value (e.g., 1 mV) (also referred to as a difference time or a time difference) and outputting the time. Thus, the voltage measuring circuit 151B may be referred to as a subtractor, a time measuring circuit, or the like, for example.

The selection circuit 176 has a function of supplying one of the voltage Vin (the voltage Vbp) and the voltage Vref to an input terminal of the integrator circuit 175 in accordance with a signal SEL.

The integrator circuit 175 has a function of integrating voltage supplied to the input terminal (one of the voltage Vin and the voltage Vref) and supplying an integrated voltage Vin2 to an output terminal.

The integrator circuit 175 includes an operational amplifier 175a, a resistor 175r, and a capacitor 175c. In the integrator circuit 175, an inverting input terminal of the operational amplifier 175a is electrically connected to one terminal of the resistor 175r and one terminal of the capacitor 175c. A non-inverting input terminal of the operational amplifier 175a is electrically connected to a wiring to which voltage Vref2 is supplied. An output terminal of the operational amplifier 175a is electrically connected to the other terminal of the capacitor 175c and the output terminal of the integrator circuit 175. The other terminal of the resistor 175r is electrically connected to the input terminal of the integrator circuit 175. Note that in the integrator circuit 175, a switch (not illustrated) having a function of establishing or breaking electrical continuity between one terminal and the other terminal of the capacitor 175c is preferably provided.

The output terminal of the integrator circuit 175 is electrically connected to the inverting input terminal of the comparator 171. That is, the voltage Vin2 supplied to the output terminal of the integrator circuit 175 is supplied to the inverting input terminal of the comparator.

The comparator 171 has a function of comparing the levels of the voltage Vin2 supplied to the inverting input terminal and the voltage Vref2 supplied to the non-inverting input terminal and outputting the H level or the L level in accordance with the comparison result.

The oscillator 173d has a function of outputting a clock pulse.

The AND circuit 173e has a function of calculating a logical product of a clock pulse supplied from the oscillator 173d and a signal supplied from the signal processing circuit 173a and outputting a signal CCK.

The counter 173f has a function of counting the number of clock pulses supplied as the signal CCK. The counter 173f has a function of resetting the count value in accordance with a signal CRE. The counter 173f has a function of outputting a count value (data OUTC).

The signal processing circuit 173a has a function of outputting the signal SEL for controlling the operation of the selection circuit 176, for example. The signal processing circuit 173a has a function of controlling, with the use of the AND circuit 173e, whether a clock pulse output from the oscillator 173d is supplied to the counter 173f or not, for example. The signal processing circuit 173a has a function of outputting the signal CRE for controlling the operation of the counter 173f, for example. The signal processing circuit 173a has a function of outputting, to the control circuit 153, voltage data (data OUTV) based on the data OUTC output from the counter 173f, for example.

The register 173c may have a function of storing the data OUTC output from the counter 173f. In the register 173c, a memory circuit (not illustrated) may be provided to store the data OUTC, for example.

In some or all of the circuits included in the voltage measuring circuit 151B, an OS transistor or a memory circuit using an OS transistor can be provided, as in the above-described voltage measuring circuit 151A.

Like the above-described voltage measuring circuit 151A, the voltage measuring circuit 151B can be in a sleep mode until the input voltage changes by a predetermined voltage value, i.e., while a change in the input voltage is smaller than the predetermined voltage value.

The voltage measuring circuit 151B can perform analog-digital conversion (A/D conversion), which will be described later, also in the sleep mode.

### Operation Example

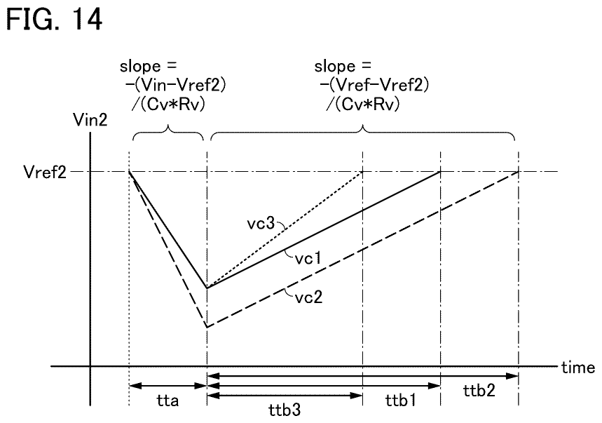

FIG. 14 is a schematic view showing analog-digital conversion (A/D conversion) in the voltage measuring circuit 151B.

FIG. 14 shows a time-dependent change in the voltage Vin2 output from the integrator circuit 175 at the time of the A/D conversion. In FIG. 14, the change indicated by a dashed line (vc2) is observed in the case where the voltage Vin is increased from that at which the change indicated by a solid line (vc1) is observed. In addition, the change indicated by a dotted line (vc3) is observed in the case where the voltage Vref is increased from that at which the change indicated by the solid line (vc1) is observed.

In order to perform the A/D conversion, the voltage Vref and the voltage Vref2 are set to satisfy the voltage Vin>the voltage Vref2>the voltage Vref in the voltage measuring circuit 151B. In the initial state, the voltage Vin2=the voltage Vref2 is satisfied. In addition, the count value of the counter 173f is reset to 0. The electric resistance value of the resistor 175r is Rv and the electrostatic capacitance value of the capacitor 175c is Cv.

Note that in the description of this operation example, changing the voltage Vin such that the potential difference between the voltage Vin and the voltage Vref2 is large (or small) is referred to as increasing (or decreasing) the voltage Vin in some cases. Changing the voltage Vref such that the potential difference between the voltage Vref and the voltage Vref2 is large (or small) is referred to as increasing (or decreasing) the voltage Vref in some cases.

First, the selection circuit 176 is controlled to input the voltage Vin to the integrator circuit 175. Thus, the voltage Vin2 decreases at a slope of “−(the voltage Vin−the voltage Vref2)/(Cv×Rv)”.

Next, after a certain period (a period tta) has elapsed, the selection circuit 176 is controlled to input the voltage Vref to the integrator circuit 175. Thus, the voltage Vin2 increases at a slope of “−(the voltage Vref−the voltage Vref2)/(Cv×Rv)”. At this time, control is performed such that the clock pulse output from the oscillator 173d is supplied to the counter 173f. Then, the count of the counter 173f starts.

Next, the voltage Vin2 increases until it reaches the voltage Vref2, so that the output of the comparator 171 changes (e.g., from the H level to the L level). At this time, the count value of the counter 173f is output.

The count value output from the counter 173f is a value counted during a period ttb (a period ttb1, a period ttb2, or a period ttb3) from when the voltage Vref is input to the integrator circuit 175 until the voltage Vin2 reaches the voltage Vref2, and has a positive correlation with the voltage Vin input to the integrator circuit 175.

For example, when the voltage Vin is higher than that in the case of the solid line (vc1), the slope of the decrease in the voltage Vin2 during the period tta becomes steeper as shown by the dashed line (vc2). As a result, the period ttb2>the period ttb1 is satisfied, and the count value of the counter 173f increases. In this manner, the count value of the counter 173f is a value based on the voltage Vin.

Here, for example, when the voltage Vref is higher than that in the case of the solid line (vc1), the slope of the increase in the voltage Vin2 during the period ttb becomes steeper as shown by the dotted line (vc3). As a result, the period ttb3<the period ttb1 is satisfied, and the count value of the counter 173f decreases. By utilizing this, the time required for the input voltage Vin to change by a predetermined voltage value can be calculated as described later.

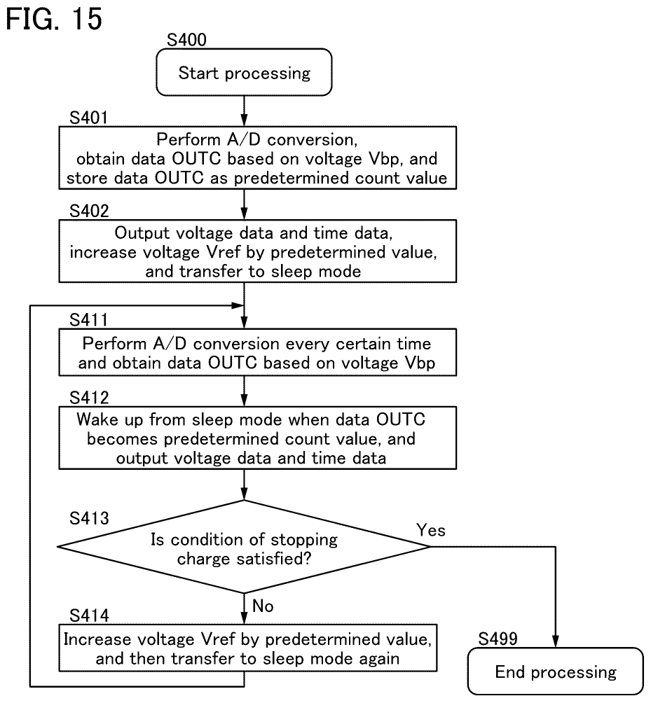

FIG. 15 is a flowchart showing an operation example of the voltage measuring circuit 151B.

First, in Step S400, the signal STUP is supplied from the control circuit 153, whereby processing is started. Note that the secondary battery 121 is assumed to be charged with a constant current.

In the initial state, the voltage Vin2=the voltage Vref2 is satisfied. For example, a switch provided between one terminal and the other terminal of the capacitor 175c is controlled to be in a conduction state.

Next, in Step S401, an analog input voltage is converted into digital voltage data. In Step S401, the above-described A/D conversion is performed to obtain the data OUTC based on the voltage Vbp (voltage Vin). At this time, for example, the switch provided between one terminal and the other terminal of the capacitor 175c is controlled to be in a non-conduction state. The obtained data OUTC is retained as a predetermined count value. For example, the predetermined count value may be retained in a memory circuit for storing the data OUTC that is provided in the register 173c. After Step S401, the processing proceeds to Step S402.

Next, in Step S402, the voltage data based on the data OUTC and the time data of the timing circuit 173b are output and the voltage measuring circuit 151B is transferred to the sleep mode. At this time, the signal SLEP is output. Here, before the voltage measuring circuit 151B is transferred to the sleep mode, the data of the register 173c is updated to data that is higher by a predetermined data value (e.g., a data value corresponding to 1 mV). Accordingly, the voltage output from the DAC 172 is increased by a predetermined voltage value (e.g., 1 mV), and the voltage is held in the S/H 174. That is, the voltage Vref held in the S/H 174 is increased by a predetermined voltage value, and then the voltage measuring circuit 151B is transferred to the sleep mode. After Step S402, the processing proceeds to Step S411.

Next, in Step S411 to Step S414, the time required for the input voltage to change by a predetermined voltage value is calculated and the time is output.

In Step S411, the above-described A/D conversion is performed every certain time (e.g., 100 ms), whereby the data OUTC based on the voltage Vbp is obtained. At this time, since the voltage Vref is increased by a predetermined voltage value in the previous step, the data OUTC becomes a value lower than the predetermined count value even when the voltage Vbp does not change. After Step S411, the processing proceeds to Step S412.

In Step S412, the voltage Vbp increases by a predetermined voltage value, so that the data OUTC becomes a predetermined count value. Thus, the voltage measuring circuit 151B wakes up from the sleep mode. At this time, the signal WKUP is output. After the wake-up from the sleep mode, the voltage data based on the data OUTC and the time data of the timing circuit 173b are output. After Step S412, the processing proceeds to Step S413.

In Step S412, as in the above-described voltage measuring circuit 151A, data on the difference time between the previous output and the present output may be output as the time data. That is, the data of the difference time is data of the time required for the input voltage to change by a predetermined voltage value.

In Step S413, whether the conditions of stopping the charge are satisfied is determined. As the conditions of stopping the charge, for example, the conditions described above in Example 1 of charge method to Example 3 of charge method can be used as appropriate. In the case where the conditions of stopping the charge are satisfied, the processing ends in Step S499. Alternatively, in the case where the conditions of stopping the charge are not satisfied, the processing proceeds to Step S414.

In Step S414, the data of the register 173c is updated to data that is higher by a predetermined data value. Accordingly, the voltage output from the DAC 172 is increased by a predetermined voltage value, and the voltage is held in the S/H 174. That is, the voltage Vref held in the S/H 174 is increased by a predetermined voltage value. After that, the signal SLEP is output and the voltage measuring circuit 151B is transferred to the sleep mode again. After Step S414, the processing returns to Step S411.

As described above, the voltage measuring circuit 151B can calculate the time required for the voltage Vbp of the secondary battery 121 to change by a predetermined voltage value (e.g., 1 mV) and output the time. The voltage measuring circuit 151B can be in the sleep mode until the voltage Vbp changes by a predetermined voltage value, i.e., while a change in the voltage Vbp is smaller than the predetermined voltage value. When the voltage measuring circuit 151B is in the sleep mode, power supply to the DAC 172 and the register 173c can be stopped and part of the operation of the signal processing circuit 173a can be stopped, for example. Thus, the power consumption of the voltage measuring circuit 151B can be reduced.

In the above description, for example, the time required for the voltage Vbp to increase by a predetermined voltage value at the time of the charge of the secondary battery 121 can be calculated. Meanwhile, for example, the time required for the voltage Vbp to decrease by a predetermined voltage value at the time of the discharge of the secondary battery 121 may be calculated. In that case, for example, in Step S402 and Step S414, the data of the register 173c is updated to data that is lower by a predetermined data value. That is, the voltage Vref held in the S/H 174 is decreased by a predetermined voltage value.

The charging unit that can be used for the power storage system of one embodiment of the present invention includes the voltage measuring circuit 151B, so that the power consumption can be reduced.

### <Estimation of SOH>

The charging unit of one embodiment of the present invention preferably has a function of estimating SOH (State Of Health) of a secondary battery. SOH is an index representing a full rechargeable capacity at a certain point in time with reference to a full rechargeable capacity of a new product. SOH is a numerical value that becomes less than 100 as a secondary battery deteriorates, with the full rechargeable capacity of a new secondary battery regarded as 100, and the unit is “%”.

As for the extremum in the dQ/dV-V curve analyzed in the above example, the intensity (e.g., the height of an upward convex peak) of the extremum may decrease. The intensity may decrease because a phase change corresponding to the extremum is unlikely to occur in the positive electrode active material, and the intensity decrease may have a correlation with SOH, for example.

The charging unit of one embodiment of the present invention preferably has a function of estimating SOH by observing the intensity of the extremum in the dQ/dV-V curve.

As for the extremum in the dQ/dV-V curve analyzed in the above example, the voltage serving as the extremum may have a correlation with a full discharge capacity (a dischargeable capacity of a secondary battery) after the charge is performed. The charging unit of one embodiment of the present invention preferably has a function of estimating the dischargeable capacity of the secondary battery by observing the intensity of the extremum in the dQ/dV-V curve.

<Charge Control with Temperature>

The charging unit 201 preferably performs charge control with temperature.

The control circuit 153 preferably changes the charge conditions in accordance with the ambient temperature of the secondary battery measured by the temperature sensor TS.

The memory circuit included in the control circuit 153 preferably has a table in which the ambient temperature and the charge conditions of the secondary battery are linked, for example.

In the memory circuit included in the control circuit 153, the charge characteristics linked to the ambient temperature of the secondary battery are preferably stored. The charge characteristics may be a past measured value of the secondary battery 121, a measured value of another secondary battery with similar characteristics, or a waveform obtained by calculation. In the flowcharts shown in FIG. 8 and FIG. 9, the extremum (peak) may be estimated using such measured values. Machine learning or the like can be used for the estimation, for example.

The control circuit 153 may use the charge characteristics of the secondary battery, which are stored in the memory circuit, for the analysis of the extrema in the differential curves of voltage and the amount of electricity. Here, for example, a capacity-voltage curve, a voltage-dQ/dV curve, a ΔV-t curve, impedance characteristics, or the like can be used as the charge characteristics.

As the temperature sensor TS, a temperature measuring resistor (e.g., platinum, nickel, or copper), a thermistor (a PTC (Positive Temperature Coefficient) thermistor or an NTC (Negative Temperature Coefficient) thermistor), a thermocouple, an IC temperature sensor, or the like can be used, for example. Alternatively, the temperature sensor TS may have a structure using a semiconductor temperature sensor (e.g., a silicon diode temperature sensor) or a structure using a bandgap circuit, for example.

An NTC thermistor (an NTC element) has a property in which its resistance value decreases gradually with respect to a temperature increase. Thus, the NTC thermistor can be used for minute temperature detection, simple inrush current suppression, or the like, for example. A PTC thermistor (a PTC element) has a property in which its resistance value increases rapidly when the temperature exceeds a certain temperature. Thus, the PTC thermistor can be used for overheat detection, overcurrent protection, inrush current suppression, or the like, for example.

### Example 2 of Power Storage System

FIG. 1B illustrates an example in which the charging unit 201 includes the detection circuit 185 having a function of detecting overcharge and overdischarge, the detection circuit 186 having a function of detecting charge overcurrent and discharge overcurrent, the short-circuit detection circuit SD, the micro short-circuit detection circuit MSD, the transistor 140, and the transistor 150 in addition to the components illustrated in FIG. 1A.

The charging unit 201 illustrated in FIG. 1B has a function of inhibiting overcharge, overdischarge, charge overcurrent, discharge overcurrent, a short circuit, a micro-short circuit, and the like and can function as a protection circuit of the secondary battery. A micro-short circuit here refers to a minute short circuit caused in a secondary battery. A micro-short circuit refers to not a state where a positive electrode and a negative electrode of a secondary battery are short-circuited so that charge is impossible, but a phenomenon in which a slight short-circuit current flows through a minute short-circuit portion. A large voltage change may occur in a relatively short time and a small area in some cases.

Transistors called power MOSFETs can be used as the transistor 140 and the transistor 150, for example.

The control circuit 153 has a function of blocking current flowing to the secondary battery 121 by supplying signals to gates of the transistor 140 and the transistor 150.

The detection circuit 185 monitors the voltage of the secondary battery, and when overcharge or overdischarge is detected, a signal indicating the detection can be supplied to the control circuit 153. The control circuit receives the signal and can supply a signal to at least one of the gate of the transistor 140 and the gate of the transistor 150, so that current flowing to the secondary battery 121 can be blocked.

The detection circuit 186 monitors the current of the secondary battery 121, and when overcurrent is detected in charge or discharge, a signal indicating the detection can be supplied to the control circuit 153. The control circuit receives the signal and can supply a signal to at least one of the gate of the transistor 140 and the gate of the transistor 150, so that current flowing to the secondary battery 121 can be blocked.

The overcharge detected by the detection circuit 185 may be detected using the extremum of the curve of the charge voltage change over time (e.g., the ΔV-t curve) or the extremum of the voltage differential curve of the amount of electricity charged (the dQ/dV curve) described above. Alternatively, the overcharge detected by the detection circuit 185 may be detected through comparison with a predetermined voltage value with the use of a comparison circuit. The predetermined voltage value may vary depending on the ambient temperature of the secondary battery. The voltage value depending on the ambient temperature of the secondary battery is stored in the memory circuit included in the control circuit 153, for example.

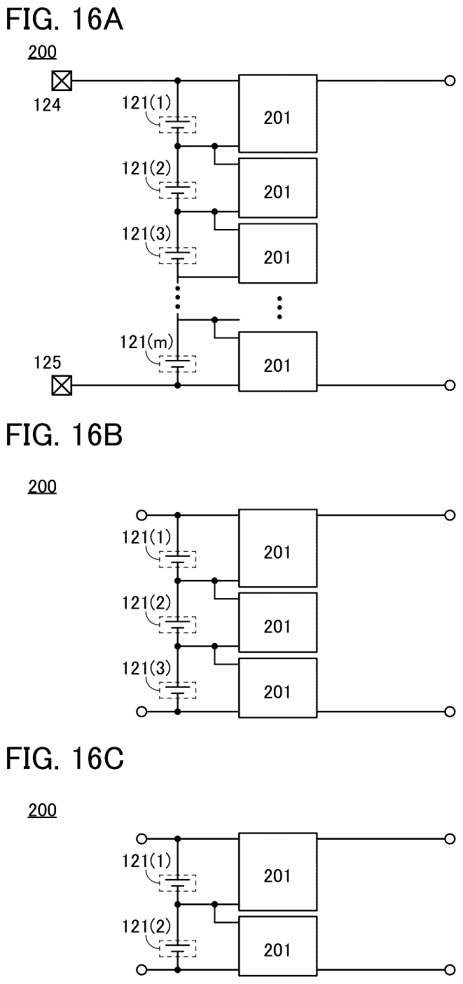

In examples of the power storage system 200 illustrated in FIG. 16A to FIG. 16C, m secondary batteries 121 connected in series are connected to the respective charging units 201. FIG. 16A illustrates the example of the power storage system 200 in which m is an integer greater than or equal to 4, illustrates a secondary battery 121(1), a secondary battery 121(2), a secondary battery 121(3), and a secondary battery 121(m) as the first, the second, the third, and the m-th secondary batteries 121, respectively, of the m secondary batteries 121, and does not illustrate the other secondary batteries. FIG. 16B illustrates the example of the power storage system 200 in which m is 3, and FIG. 16C illustrates the example of the power storage system 200 in which m is 2.

The m charging units 201 may share a function. For example, overcharge at voltage between a terminal 124 electrically connected to a positive electrode of the secondary battery 121(1) and a terminal 125 electrically connected to a negative electrode of the secondary battery 121(m) may be detected with the detection circuits 185 included in the charging units 201. Moreover, for example, the detection circuits 186 and the short-circuit detection circuits SD included in the charging units 201 may detect overcharge or a short circuit on the basis of current between the terminal 124 and the terminal 125.

In the power storage system 200, the m secondary batteries 121 can be independently controlled using the charging units 201 connected to the respective secondary batteries. In that case, in the secondary battery 121 where charge is completed earlier, current is made to flow through a path that is connected in parallel to the secondary battery 121, e.g., a transistor, a resistor, a diode, or the like connected in parallel to the secondary battery 121, after the charge is completed. Thus, the charging unit 201 preferably includes a switch for switching a current path between the secondary battery 121 and the path.

In the power storage system 200, charge may be controlled using the total voltage of the m secondary batteries 121 connected in series (e.g., the voltage between the positive electrode of the secondary battery 121(1) and the negative electrode of the secondary battery 121(m) in FIG. 16A). In such a case, it is possible to use an m-fold voltage value as the voltage used for the charge control.

This embodiment can be combined with the description of any of the other embodiments as appropriate.

### Embodiment 2

This embodiment will describe components included in a lithium-ion battery as an example of a battery included in the secondary battery 121.

The lithium-ion battery includes a negative electrode, a positive electrode, an electrolyte, a separator, and an exterior body.

### [Negative Electrode]

The negative electrode includes a negative electrode active material layer and a negative electrode current collector. The negative electrode active material layer includes a negative electrode active material and may further include a conductive material and a binder.

Metal foil can be used as the current collector, for example. The negative electrode can be formed by applying slurry onto the metal foil and drying the slurry. Note that pressing may be performed after drying. The negative electrode is a component obtained by forming an active material layer over the current collector.

Slurry refers to a material solution that is used to form the active material layer over the current collector and includes an active material, a binder, and a solvent, preferably also a conductive material mixed therewith. Slurry may also be referred to as slurry for an electrode or active material slurry; in some cases, slurry for forming a negative electrode active material layer is referred to as slurry for a negative electrode.

### <Negative Electrode Active Material>

The negative electrode of one embodiment of the present invention preferably contains a first active material and a second active material.

An example of the negative electrode active material will be described below.

The negative electrode preferably contains graphite as the first active material.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

The first active material is preferably a material with a small volume change in charge and discharge.

As for the volume change of the first active material in charge or discharge, in the case where the minimum volume in charge or discharge is regarded as 1, the maximum volume in charge or discharge is preferably less than or equal to 2, further preferably less than or equal to 1.5, still further preferably less than or equal to 1.1.

The particle diameter of the first active material is desirably larger than the particle diameter of the second active material. As the particle diameter of the first active material, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

For example, in laser diffraction particle size distribution measurement, the D50 of the first active material is preferably more than or equal to 1.5 times and less than 1000 times, further preferably more than or equal to 2 times and less than or equal to 500 times, still further preferably more than or equal to 10 times and less than or equal to 100 times the D50 of the second active material. Here, D50 is a particle diameter when the cumulative amount is 50% in a cumulative curve obtained as a result of the particle size distribution measurement, i.e., a median.

Note that the particle size is not necessarily measured by laser diffraction particle size distribution measurement, and the diameter of the cross section of the particle or the average value of the major diameter and the minor diameter of the cross section of the particle may be measured by analysis with a SEM, a TEM, or the like to calculate the median diameter. In the case where the particle size is measured with a SEM, a TEM, or the like, the number of measured particles is preferably at least 10 or more, further preferably 20 or more, still further preferably 50 or more.

In the negative electrode, a particle containing silicon is preferably used as the second active material.

A material whose resistance is lowered by addition of an impurity element such as phosphorus, arsenic, boron, aluminum, or gallium to silicon may be used. A silicon material pre-doped with lithium may also be used. Examples of a pre-doping method include annealing of a mixture of silicon with lithium fluoride, lithium carbonate, or the like and mechanical alloying of a lithium metal and silicon. A secondary battery may be fabricated in the following manner: an electrode is formed; lithium doping is performed through charge and discharge reaction with a combination of the formed electrode and an electrode of a lithium metal or the like; and then the electrode subjected to doping is combined with a counter electrode (e.g., a positive electrode for a negative electrode subjected to pre-doping).

A nanosilicon particle can be used as silicon, for example. The median diameter (D50) of a nanosilicon particle is, for example, preferably greater than or equal to 5 nm and less than 1 μm, further preferably greater than or equal to 10 nm and less than or equal to 300 nm, still further preferably greater than or equal to 10 nm and less than or equal to 100 nm.

A nanosilicon particle may have a spherical shape, a flattened spherical shape, or a rectangular solid shape with rounded corners. The size of a nanosilicon particle, which is measured as D50 by laser diffraction particle size distribution measurement, is preferably greater than or equal to 5 nm and less than 1 m, further preferably greater than or equal to 10 nm and less than or equal to 300 nm, still further preferably greater than or equal to 10 nm and less than or equal to 100 nm, for example. Here, D50 is a particle diameter when the cumulative amount is 50% in a cumulative curve obtained as a result of the particle size distribution measurement, i.e., a median. The particle size distribution measurement is not limited to laser diffraction particle size distribution measurement; in the case where the particle size is less than or equal to the lower measurement limit of the laser diffraction particle size distribution measurement, the major diameter of the cross section of the particle may be measured by analysis with a SEM, a TEM, or the like.

A nanosilicon particle may have crystallinity. A nanosilicon particle may include a region with crystallinity and an amorphous region.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous. A particle in which a graphene compound clings to a secondary particle of silicon may be used.

As a compound containing silicon, Li₂SiO₃ and Li₄SiO₄ can be included, for example. Each of Li₂SiO₃ and Li₄SiO₄ may have crystallinity or may be amorphous.

The analysis of the compound containing silicon can be performed by NMR, XRD, Raman spectroscopy, a SEM, a TEM, EDX, or the like.

The ratio W1/W2 between the weight W1 of the first active material and the weight W2 of the second active material is preferably greater than or equal to 1 and less than or equal to 20, further preferably greater than or equal to 2 and less than or equal to 10, still further preferably greater than or equal to 4 and less than or equal to 10. For example, the ratio Wg/Ws between the weight Wg of graphite and the weight Ws of silicon can be 9. Note that the ratio between the weight W1 of the first active material and the weight W2 of the second active material is not limited to the above ratio and may be another ratio.

### <Binder>

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, sodium polyglutamate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, the “passivation film” refers to a film without electrical conductivity or a film with extremely low electrical conductivity, and can inhibit the decomposition of the electrolyte solution at a potential at which a battery reaction occurs when the passivation film is formed on the active material surface, for example. It is further desirable that the passivation film can conduct lithium ions while inhibiting electrical conduction.

### <Conductive Material>

The conductive material is also referred to as a conductivity-imparting agent or a conductive additive, and a carbon material is used as the conductive material. The conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Active material layers such as the positive electrode active material layer and the negative electrode active material layer preferably contain a conductive material.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. The graphene compound may include a functional group. The graphene compound is preferably bent. The graphene compound may be rounded like carbon nanofiber.

The active material layer may contain, as a conductive material, metal powder or metal fiber of copper, nickel, aluminum, silver, gold, or the like, a conductive ceramic material, or the like.

The content of the conductive material to the total volume of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of the battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The battery obtained by the fabrication method of one embodiment of the present invention can have high capacity density per volume and stability, and is effective as an in-vehicle battery.

### <Current Collector>

As the current collector, a highly conductive material that does not alloy with a carrier ion of lithium or the like, for example, a metal such as stainless steel, gold, platinum, zinc, iron, copper, aluminum, or titanium, or an alloy thereof can be used. The current collector can have a sheet-like shape, a net-like shape, a punching-metal shape, an expanded-metal shape, or the like as appropriate.

A resin current collector can be used as the current collector. As the resin current collector, for example, a resin current collector including a resin such as polyolefin (e.g., polypropylene or polyethylene), nylon (polyamide), polyimide, vinylon, polyester, acrylic, or polyurethane, and a particulate or fibrous conductive material (also referred to as a conductive filler) can be used.

As the conductive material contained in the resin current collector, a conductive carbon material and one or more of metal materials such as aluminum, titanium, stainless steel, gold, platinum, zinc, iron, and copper can be used. For example, one kind or two or more kinds of carbon black such as acetylene black and furnace black, graphite such as artificial graphite and natural graphite, carbon fiber such as carbon nanofiber and carbon nanotube, graphene, and a graphene compound can be used as the conductive carbon material. In the case where the resin current collector is used as a positive electrode current collector, an antioxidant such as a hindered phenol-based material is further preferably used.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

Note that the average particle diameter of the conductive material contained in the resin current collector can be greater than or equal to 10 nm and less than or equal to 10 μm, and is preferably greater than or equal to 30 nm and less than or equal to 5 μm.

The current collector preferably has a thickness greater than or equal to 5 μm and less than or equal to 30 μm.

Note that a material that does not alloy with a carrier ion of lithium or the like is preferably used for the negative electrode current collector.

### [Positive Electrode]

The positive electrode includes a positive electrode active material layer and a positive electrode current collector. The positive electrode active material layer includes a positive electrode active material and may further include at least one of a conductive material and a binder. Note that the positive electrode current collector, the conductive material, and the binder described in [Negative electrode] can be used.

Metal foil can be used as the current collector, for example. The positive electrode can be formed by applying slurry onto the metal foil and drying the slurry. Note that pressing may be performed after drying. The positive electrode is a component obtained by forming an active material layer over the current collector.

Slurry refers to a material solution that is used to form the active material layer over the current collector and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode.

### <Positive Electrode Active Material>

As the positive electrode active material, one or more of a composite oxide having a layered rock-salt structure, a composite oxide having an olivine structure, and a composite oxide having a spinel structure can be used.

As the composite oxide having a layered rock-salt structure, one or more of lithium cobalt oxide, lithium nickel-cobalt-manganese oxide, lithium nickel-cobalt-aluminum oxide, and lithium nickel-manganese-aluminum oxide can be used. Note that the composition formula can be represented by LiM1O₂ (M1 is one or more selected from nickel, cobalt, manganese, and aluminum), and a coefficient of the composition formula is not limited to an integer.

As the lithium cobalt oxide, for example, lithium cobalt oxide to which nickel and magnesium are added can be used. In elementary analysis on the lithium cobalt oxide (by STEM-EDX, for example), the detected amount of nickel is different between the inner portion and the surface portion of the lithium cobalt oxide; the detected amount of nickel is larger in the surface portion. The detected amount of magnesium is also different between the inner portion and the surface portion of the lithium cobalt oxide; the detected amount of magnesium is larger in the surface portion. Note that the surface portion refers to a region ranging from the surface of the lithium cobalt oxide to a depth of approximately 50 nm toward the inner portion. The surface portion includes a region where the distribution of nickel and the distribution of magnesium overlap with each other. Nickel is preferably detected on a plane other than the (001) plane of the lithium cobalt oxide in the surface portion of the lithium cobalt oxide.

The lithium cobalt oxide may further contain aluminum. In elementary analysis on the lithium cobalt oxide (by EDX, for example), the detected amount of aluminum is different between the inner portion and the surface portion of the lithium cobalt oxide; the detected amount of aluminum is larger in the surface portion. In the surface portion, the distribution of aluminum preferably has a concentration peak closer to the inner portion of the lithium cobalt oxide than a concentration peak of the distribution of magnesium is. It is preferable that the distribution of aluminum and the distribution of magnesium partly overlap with each other. The lithium cobalt oxide having such features will be described in detail in Embodiment 3.

As the lithium nickel-cobalt-manganese oxide, for example, lithium nickel-cobalt-manganese oxide with an atomic ratio such as nickel:cobalt:manganese=1:1:1, 6:2:2, 7:1.5:1.5, 8:1:1, or 9:0.5:0.5 can be used. As the above-described lithium nickel-cobalt-manganese oxide, for example, lithium nickel-cobalt-manganese oxide to which one or more of aluminum, calcium, barium, strontium, and gallium are added is preferably used.

As the composite oxide having an olivine structure, one or more of lithium iron phosphate, lithium manganese phosphate, lithium cobalt phosphate, and lithium iron manganese phosphate can be used. Note that the composition formula can be represented by LiM2PO₄ (M2 is one or more selected from iron, manganese, and cobalt), and a coefficient of the composition formula is not limited to an integer.

Furthermore, a composite oxide having a spinel structure, such as LiMn₂O₄, can be used.

### [Electrolyte]

Examples of the electrolyte are described below. As one mode of the electrolyte, a liquid electrolyte (also referred to as an electrolyte solution) containing a solvent and an electrolyte dissolved in the solvent can be used. The electrolyte is not limited to a liquid electrolyte (electrolyte solution) that is liquid at normal temperature, and a solid electrolyte can be used as well. Alternatively, an electrolyte including both a liquid electrolyte that is liquid at normal temperature and a solid electrolyte that is a solid at normal temperature (such an electrolyte is referred to as a semi-solid electrolyte) can also be used. Note that when the solid electrolyte or the semi-solid electrolyte is used for a bendable battery, employing a structure in which part of a stack in the battery includes the electrolyte can maintain the flexibility of the battery.

In the case where a liquid electrolyte is used for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds thereof can be used in an appropriate combination at an appropriate ratio, for example.

Alternatively, the use of one or more of ionic liquids (normal temperature molten salts) which have features of non-flammability and non-volatility as a solvent of an electrolyte can prevent a secondary battery from exploding or catching fire even when an internal region of a secondary battery shorts out or the temperature in the internal region increases owing to overcharge or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion, for example.

In the case where a lithium ion is used as a carrier ion, the electrolyte contains a lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, or the like can be used, for example.

For example, an organic solvent described in this embodiment contains ethylene carbonate (EC), ethyl methyl carbonate (EMC), and dimethyl carbonate (DMC). When the total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y:100−x−y (where 5≤x≤35 and 0<y<65) can be used. More specifically, an organic solvent containing EC, EMC, and DMC at EC:EMC:DMC=30:35:35 (volume ratio) can be used.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the additive agent in the solvent is, for example, higher than or equal to 0.1 wt % and lower than or equal to 5 wt %.

When a high-molecular material that can gel is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVDF; polyacrylonitrile; a copolymer containing any of them; or the like can be used. For example, PVDF-HFP, which is a copolymer of PVDF and hexafluoropropylene (HFP), can be used. The formed polymer may be porous.

### [Separator]

When the electrolyte includes an electrolyte solution, a separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a bag-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, degradation of the separator during high-voltage charge can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, heat resistance can be improved to improve the safety of the secondary battery.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The structure, method, and the like described in this embodiment can be used in an appropriate combination with structures, methods, and the like described in the other embodiments.

This embodiment can be combined with the description of any of the other embodiments as appropriate.

### Embodiment 3

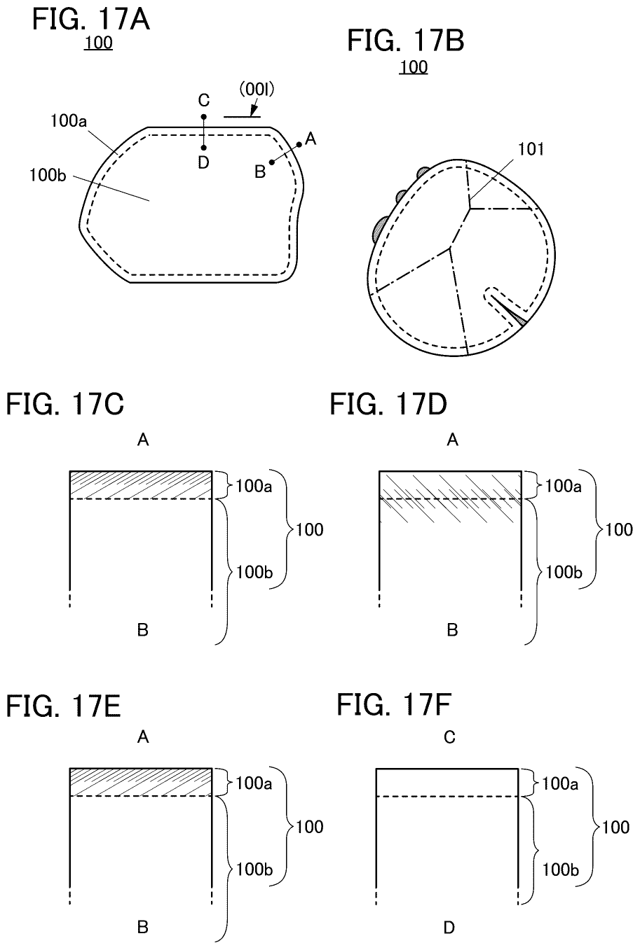

In this embodiment, lithium cobalt oxide that is a positive electrode active material of one embodiment of the present invention will be described with reference to FIG. 17 to FIG. 22.

FIG. 17A and FIG. 17B are each a cross-sectional view of a positive electrode active material 100 of one embodiment of the present invention. FIG. 17C to FIG. 17E illustrate enlarged views of the vicinity of A-B in FIG. 17A. FIG. 17F illustrates an enlarged view of the vicinity of C-D in FIG. 17A.

As illustrated in FIG. 17A to FIG. 17F, the positive electrode active material 100 includes a surface portion 100a and an inner portion 100b. In each drawing, the dashed line denotes a boundary between the surface portion 100a and the inner portion 100b. In FIG. 17B, the dashed-dotted line denotes part of a crystal grain boundary 101.

In this specification and the like, the surface portion 100a of the positive electrode active material 100 refers to a region ranging from the surface to a depth of 50 nm or less, preferably 35 nm or less, further preferably 20 nm or less toward the inner portion, and most preferably a region ranging from the surface to a depth of 10 nm or less in a perpendicular or substantially perpendicular direction. Note that “substantially perpendicular” refers to a state where an angle is greater than or equal to 80° and less than or equal to 100°. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

The surface of the positive electrode active material 100 refers to a surface of a composite oxide including the surface portion 100a and the inner portion 100b. Thus, the positive electrode active material 100 does not contain a material to which a metal oxide that does not contain a lithium site contributing to charge and discharge, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from that of the inner portion 100b.

Furthermore, the surface of the positive electrode active material 100 does not contain an electrolyte, an organic solvent, a binder, a conductive material, and a compound originating from any of these that are attached to the positive electrode active material 100.

Since the positive electrode active material 100 is a compound which contains a transition metal and oxygen and into and from which lithium can be inserted and extracted, an interface between a region where oxygen and a transition metal M (Co, Ni, Mn, Fe, or the like) that is oxidized or reduced by insertion and extraction of lithium are present and a region where oxygen and the transition metal M are absent is considered as the surface of the positive electrode active material. A plane generated by slipping, a split, and/or a crack also can be considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

### <Contained Element>

The positive electrode active material 100 contains lithium, a transition metal, oxygen, and an additive element. Alternatively, the positive electrode active material 100 can contain lithium cobalt oxide (LiCoO₂) to which an additive element is added. Note that the positive electrode active material 100 of one embodiment of the present invention has a crystal structure described later. Thus, the composition of the lithium cobalt oxide is not strictly limited to Li:Co:O=1:1:2.

A positive electrode active material of a lithium-ion secondary battery needs to contain a transition metal which can be oxidized or reduced in order to maintain a neutrally charged state even when lithium ions are inserted and extracted. It is preferable that the positive electrode active material 100 of one embodiment of the present invention mainly contain cobalt as the transition metal taking part in an oxidation-reduction reaction. In addition to cobalt, one or both of nickel and manganese may be used. Cobalt is preferably used at higher than or equal to 75 atomic %, preferably higher than or equal to 90 atomic %, further preferably higher than or equal to 95 atomic % as the transition metal contained in the positive electrode active material 100, in which case many advantages such as relatively easy synthesis, easy handling in the manufacturing process of the battery, and excellent cycle performance are offered.

When cobalt is used as the transition metal contained in the positive electrode active material 100 at higher than or equal to 75 atomic %, preferably higher than or equal to 90 atomic %, further preferably higher than or equal to 95 atomic %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium is preferably used. The total percentage of the transition metal among the additive elements is preferably less than 25 atomic %, further preferably less than 10 atomic %, still further preferably less than 5 atomic %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element preferably forms a solid solution with the positive electrode active material 100. Thus, in STEM-EDX line analysis, for example, a depth at which the amount of the detected additive element increases is preferably at a deeper position than a depth at which the amount of the detected transition metal M increases, i.e., on the inner portion side of the positive electrode active material 100.

In this specification and the like, a depth at which the amount of a detected element increases in STEM-EDX line analysis refers to a depth at which a measured value, which can be determined not to be a noise in terms of intensity, spatial resolution, and the like, is successively obtained.

These additive elements further stabilize the crystal structure of the positive electrode active material 100 as described later. In this specification and the like, the additive element can be rephrased as part of a raw material or a mixture.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

For example, when the positive electrode active material 100 is substantially free from manganese, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

### <Crystal Structure>

<<x in LiₓCoO₂ Being 1>>

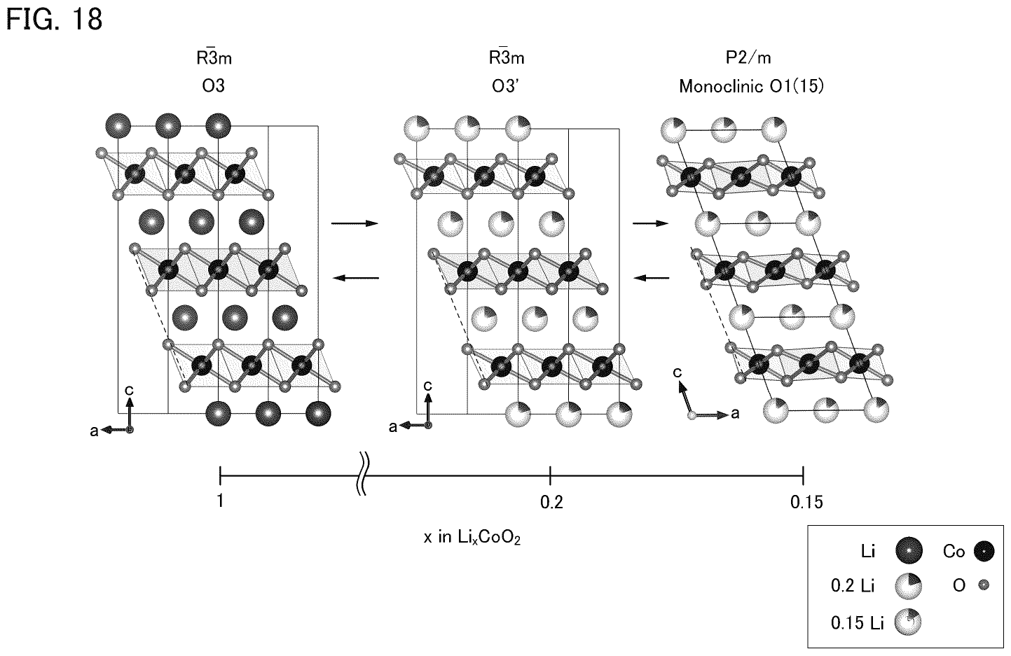

The positive electrode active material 100 of one embodiment of the present invention preferably has a layered rock-salt crystal structure belonging to the space group R-3m in a discharged state, i.e., in the case where x in LiₓCoO₂ is 1. A composite oxide having a layered rock-salt crystal structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 18, the layered rock-salt crystal structure is denoted by R-3m O3.

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charge. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100, such as extraction of oxygen, and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charge, and is a region that tends to have a lower concentration of lithium than the inner portion 100b. It can be said that bonds between atoms are partly cut on the surface of the particle of the positive electrode active material 100 included in the surface portion 100a. Thus, the surface portion 100a is regarded as a region that tends to be unstable and tends to start deterioration of the crystal structure. Meanwhile, when the surface portion 100a can be made sufficiently stable, the layered structure, which is formed of octahedrons of cobalt and oxygen, of the inner portion 100b is unlikely to break even with small x in LiₓCoO₂, e.g., with x of 0.24 or less. Furthermore, a shift in layers, which are formed of octahedrons of cobalt and oxygen, of the inner portion 100b can be inhibited.

In order that the surface portion 100a can have a stable composition and a stable crystal structure, the surface portion 100a preferably contains an additive element, further preferably contains a plurality of additive elements. The surface portion 100a preferably has a higher concentration of one or two or more selected from the additive elements than the inner portion 100b. The one or two or more selected from the additive elements contained in the positive electrode active material 100 preferably have a concentration gradient. In addition, it is further preferable that the additive elements contained in the positive electrode active material 100 be differently distributed. For example, it is further preferable that the additive elements exhibit concentration peaks at different depths from the surface. The concentration peak here refers to the local maximum value of the concentration in the surface portion 100a or a region ranging from the surface to a depth of 50 nm or less.

Distribution of the additive elements is described. FIG. 17C to FIG. 17E are enlarged views of the vicinity of A-B in FIG. 17A. FIG. 17F is an enlarged view of the vicinity of C-D in FIG. 17A.

For example, as illustrated in FIG. 17C by gradation, some of the additive elements such as magnesium, fluorine, nickel, titanium, silicon, phosphorus, boron, calcium, and barium preferably have a concentration gradient in which the concentration increases from the inner portion 100b toward the surface. An additive element having such a concentration gradient is referred to as an additive element X.

Another additive element such as aluminum or manganese preferably has a concentration gradient as illustrated in FIG. 17D by hatching density and exhibits a concentration peak in a deeper region than the additive element X. The concentration peak may be located in the surface portion 100a or located deeper than the surface portion 100a. For example, the peak is preferably located in a region ranging from a depth of 5 nm to a depth of 30 nm inclusive from the surface toward the inner portion. An additive element having such a concentration gradient is referred to as an additive element Y.

Note that some of the additive elements X, such as nickel and barium, clearly exist in the vicinity of A-B in FIG. 17A as indicated by hatching in FIG. 17E. On the other hand, as the absence of hatching in FIG. 17F indicates, those additive elements X are substantially absent from the vicinity of C-D in FIG. 17A in some cases, which is different from the other additive elements X. Note that here, “clearly exist” means a case where the energy spectrum of characteristic X-rays of the element is detected in cross-sectional STEM-EDX analysis of the positive electrode active material 100.

In addition, “substantially absent” means a case where the energy spectrum of characteristic X-rays of the element is not detected in cross-sectional STEM-EDX analysis of the positive electrode active material 100. It can also be said that the element is less than or equal to the lower detection limit in STEM-EDX analysis. In that case, it can also be said that the element is less than or equal to the lower detection limit in analysis by STEM-EDX.

Note that the vicinity of A-B in FIG. 17A can be referred to as an edge region. The vicinity of C-D in FIG. 17A can be referred to as a basal region. Note that in FIG. 17A, the straight line denoted by (00l) represents a (00l) plane. Here, the edge region has a surface exposed in a direction intersecting the (00l) plane, and the edge region refers to a region ranging from the surface to a depth of 50 nm or less, preferably 35 nm or less, further preferably 20 nm or less, and most preferably 10 nm or less toward the inner portion in a direction perpendicular or substantially perpendicular to the surface. Here, “intersect” means that an angle between a line perpendicular to a first plane (the (00l) plane) and a line normal to a second plane (the surface of the positive electrode active material 100) is greater than or equal to 100 and less than or equal to 90°, preferably greater than or equal to 300 and less than or equal to 90°.

Moreover, the basal region has a surface parallel to the (00l) plane, and the basal region refers to a region ranging from the surface to a depth of 50 nm or less, preferably 35 nm or less, further preferably 20 nm or less, and most preferably 10 nm or less toward the inner portion in a direction perpendicular or substantially perpendicular to the surface. Here, “parallel” means that an angle between the line perpendicular to the first plane (the (00l) plane) and the line normal to the second plane (the surface of the positive electrode active material 100) is greater than or equal to 0° and less than 10°, preferably greater than or equal to 0° and less than or equal to 5°.

The concentration of the additive element X and the concentration of the additive element Y may differ between the basal region and the edge region. For example, the concentration of the additive element X in the edge region is preferably higher than the concentration of the additive element X in the basal region. The concentration of the additive element Y in the edge region is preferably higher than the concentration of the additive element Y in the basal region. The edge region is a region where many end portions of Li layers are exposed in the layered rock-salt crystal structure of lithium cobalt oxide; thus, it is preferable that a large amount of the additive element X exist in the edge region and a large amount of the additive element Y exist in the edge region, in which case the positive electrode active material 100 is reinforced.

### [Magnesium]

Magnesium, which is an example of the additive element X, is divalent, and a magnesium ion is more stable in lithium sites than in cobalt sites in the layered rock-salt crystal structure and thus is likely to enter the lithium sites. An appropriate concentration of magnesium in the lithium sites of the surface portion 100a can facilitate the maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium can also be expected to increase the density of the positive electrode active material 100. In addition, a high concentration of magnesium in the surface portion 100a can be expected to increase the corrosion resistance to hydrofluoric acid generated by the decomposition of an electrolyte solution.

An appropriate concentration of magnesium does not have an adverse effect on insertion and extraction of lithium in charge and discharge, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms. Here, the amount of magnesium contained in the entire positive electrode active material 100 may be a value obtained by element analysis on the entire positive electrode active material 100 by GD-MS, ICP-MS, or the like, or may be a value based on the ratio of the raw materials compounded in the process of forming the positive electrode active material 100, for example.

### [Nickel]

Nickel, which is an example of the additive element X, can exist in both the cobalt site and the lithium site.

When nickel exists in lithium sites, a shift in the layered structure formed of octahedrons of cobalt and oxygen can be inhibited. Moreover, a change in volume in charge and discharge is inhibited. Furthermore, an elastic modulus becomes large, i.e., hardness increases. This is probably because nickel in the lithium sites serves as a column supporting the CoO₂ layers. Thus, in particular, the crystal structure can be expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO and CoO, and the orientations of NiO and LiCoO₂ are likely to be aligned with each other.

Ionization tendency is the lowest in nickel, followed in order by cobalt, aluminum, and magnesium (Mg>Al>Co>Ni). Therefore, it can be considered that in charge, nickel is less likely to be dissolved into an electrolyte solution than the other elements described above. Accordingly, nickel can be considered to have a high effect of stabilizing the crystal structure of the surface portion in a charged state.

Furthermore, in nickel, Ni²⁺ is the most stable among Ni²⁺, Ni³⁺, and Ni⁴⁺, and nickel has higher trivalent ionization energy than cobalt. Thus, it is known that a spinel crystal structure does not appear only with nickel and oxygen. Therefore, nickel can be considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials compounded in the process of forming the positive electrode active material, for example.

Note that nickel selectively exists in the edge region of the surface portion 100a in some cases.

### [Aluminum]

Aluminum, which is an example of the additive element Y, can exist in the cobalt site in a layered rock-salt crystal structure. Since aluminum is a trivalent representative element and its valence does not change, lithium around aluminum is unlikely to move even in charge and discharge. Thus, aluminum and lithium therearound serve as columns to inhibit a change in the crystal structure. Furthermore, aluminum has effects of inhibiting dissolution of cobalt around aluminum and improving continuous charge tolerance. Moreover, an Al—O bond is stronger than a Co—O bond and thus extraction of oxygen around aluminum can be inhibited. These effects improve thermal stability. Hence, a secondary battery including the positive electrode active material 100 containing aluminum as the additive element can have improved safety. Furthermore, the positive electrode active material 100 can have a crystal structure that is unlikely to be broken even with repeated charge and discharge.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 by GD-MS, ICP-MS, or the like, or may be a value based on the ratio of the raw materials compounded in the process of forming the positive electrode active material 100, for example.

### [Fluorine]

Fluorine, which is an example of the additive element X, is a monovalent anion; when fluorine is substituted for part of oxygen in the surface portion 100a, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine is present in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux agent) for lowering the melting point of the other additive element source.

An oxide of titanium, which is an example of the additive element X, is known to have superhydrophilicity. Accordingly, the positive electrode active material 100 that contains titanium oxide in the surface portion 100a presumably has good wettability with respect to a high-polarity solvent. In a secondary battery including the positive electrode active material 100, the positive electrode active material 100 and a high-polarity electrolyte solution can have favorable contact at the interface therebetween, which may inhibit an internal resistance increase.

In the positive electrode active material 100, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentration of magnesium described here may be a value obtained by element analysis on the entire positive electrode active material 100 by GC-MS, ICP-MS, or the like, or may be a value based on the ratio of the raw materials compounded in the process of forming the positive electrode active material 100, for example.

### [Synergistic Effect of a Plurality of Elements]

When the surface portion 100a contains both magnesium and nickel, divalent nickel can exist more stably in the vicinity of divalent magnesium. Thus, dissolution of magnesium might be inhibited even when x in LiₓCoO₂ is small. This can contribute to stabilization of the surface portion 100a.

For a similar reason, when the additive element is added to lithium cobalt oxide in the formation process, magnesium is preferably added in a step before addition of nickel. Alternatively, magnesium and nickel are preferably added in the same step. Magnesium has a large ion radius and thus is likely to remain in the surface portion of lithium cobalt oxide regardless of in which step magnesium is added, but nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

Additive elements that are differently distributed, such as the additive element X and the additive element Y, are preferably contained at a time, in which case the crystal structure of a wider region can be stabilized. For example, in the case where the positive electrode active material 100 contains magnesium and nickel, which are examples of the additive elements X, and contains aluminum, which is one of the additive elements Y, the crystal structure of a wider region can be stabilized as compared with the case where only the additive element X or the additive element Y is contained. In the case where the positive electrode active material 100 contains both the additive element X and the additive element Y as described above, the surface can be sufficiently stabilized by the additive element X such as magnesium or nickel; thus, the additive element Y such as aluminum is not necessary for the surface. It is preferable that aluminum be widely distributed in a deeper region. For example, it is preferable that aluminum be continuously detected in a region ranging from a depth from the surface of 1 nm or more to a depth from the surface of 25 nm or less. Aluminum is preferably widely distributed in a region ranging from a depth from the surface of 0 nm or more to a depth from the surface of 100 nm or less, further preferably a region ranging from a depth from the surface of 0.5 nm or more to a depth from the surface of 50 nm or less, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained because a high effect of stabilizing the composition and the crystal structure can be obtained.

Note that the surface portion 100a occupied by only a compound of an additive element and oxygen is not preferable because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, it is necessary that the surface portion 100a contain at least cobalt, also contain lithium in a discharged state, and have a path through which lithium is inserted and extracted.

To secure the sufficient path through which lithium is inserted and extracted, the concentration of cobalt is preferably higher than that of magnesium in the surface portion 100a. For example, the ratio of the number of magnesium atoms Mg to the number of cobalt atoms Co (Mg/Co) is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is preferably higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably less than or equal to one-sixth the number of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of suppressing dissolution of magnesium can be expected in a manner similar to the above.

It is preferable that the crystal structure continuously change from the inner portion 100b toward the surface owing to the above-described concentration gradient of the additive element. Alternatively, the crystal orientations of the surface portion 100a and the inner portion 100b are preferably substantially aligned with each other.

For example, the crystal structure preferably changes continuously from the inner portion 100b that has a layered rock-salt crystal structure toward the surface and the surface portion 100a that have a rock-salt crystal structure or have features of both a rock-salt crystal structure and a layered rock-salt crystal structure. Alternatively, the crystal orientation of the surface portion 100a that has a rock-salt crystal structure or has features of both a rock-salt crystal structure and a layered rock-salt crystal structure is preferably substantially aligned with that of the inner portion 100b that has a layered rock-salt crystal structure.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure such as a crystal structure belonging to the space group Fm-3m is included and cations and anions are alternately arranged. Note that a cation or anion vacancy may exist.

Having features of both a layered rock-salt crystal structure and a rock-salt crystal structure can be determined from electron diffraction, a TEM image, a cross-sectional STEM image, or the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure in which two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. When electron diffraction patterns of rock-salt MgO and layered rock-salt LiCoO₂ are compared to each other, for example, the distance between the bright spots on the (003) plane of LiCoO₂ is observed at a distance approximately half the distance between the bright spots on the (111) plane of MgO. Thus, for instance, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt crystal structure and the layered rock-salt crystal structure has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal described later are presumed to form a cubic close-packed structure. Thus, when a layered rock-salt crystal and a rock-salt crystal are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases. Topotaxy refers to having similarity in a three-dimensional structure such that crystal orientations are substantially aligned with each other, or to having the same orientations crystallographically.

The orientations of crystals in two regions being substantially aligned with each other can be determined from a TEM image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an electron diffraction pattern, or the like. It can be determined also from an FFT pattern of a TEM image or an FFT pattern of a STEM image or the like. Furthermore, XRD, neutron diffraction, and the like can be used for determination.

<<State where x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

A conventional positive electrode active material and the positive electrode active material 100 of one embodiment of the present invention are compared and changes in crystal structures owing to a change in x in LiₓCoO₂ will be described with reference to FIG. 18 to FIG. 20.

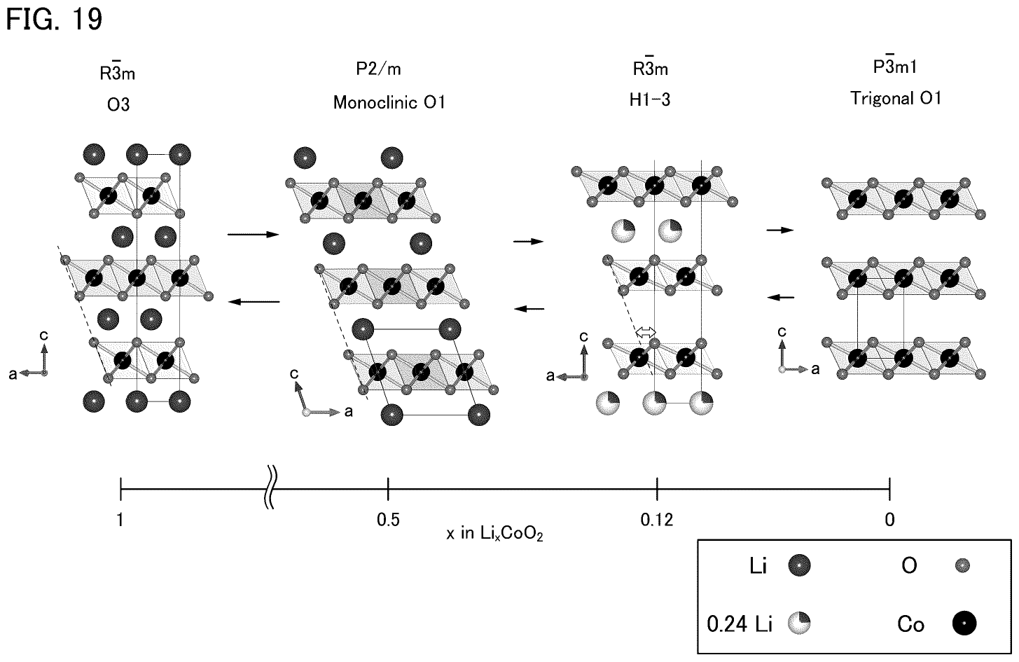

A change in the crystal structure of the conventional positive electrode active material is illustrated in FIG. 19. The conventional positive electrode active material illustrated in FIG. 19 is lithium cobalt oxide (LiCoO₂) without an additive element in particular. A change in the crystal structure of lithium cobalt oxide containing no additive element is described in Non-Patent Document 1 to Non-Patent Document 3 and the like.

FIG. 19 illustrates the crystal structure of lithium cobalt oxide with x=1 in LiₓCoO₂, which is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x=0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 experimentally. The number of cobalt atoms per unit cell in the actual H1-3 type crystal structure is twice that in other structures (e.g., R-3m O3). However, in this specification including FIG. 19, the c-axis of the H1-3 type crystal structure is half that of the unit cell for easy comparison with the other crystal structures.

When charge that makes x in LiₓCoO₂ be 0.24 or less and discharge are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrows in FIG. 19, the CoO₂ layer in the H1-3 type crystal structure largely shifts from that in R-3m O3 in a discharged state. Such a dynamic structural change can adversely affect the stability of the crystal structure.

On the other hand, in the positive electrode active material 100 of one embodiment of the present invention illustrated in FIG. 18, a change in the crystal structure between a discharged state with x in LiₓCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is unlikely to break even when charge that makes x be 0.24 or less and discharge are repeated, and enables excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 18 illustrates crystal structures of the inner portion 100b of the positive electrode active material 100 in a state where x in LiₓCoO₂ is 1, in a state where x in LiₓCoO₂ is approximately 0.2, and in a state where x in LiₓCoO₂ is approximately 0.15. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x=1 has the R-3m O3 type crystal structure, which is the same as that of conventional lithium cobalt oxide.

However, the positive electrode active material 100 has a crystal structure different from the H1-3 type crystal structure when x is 0.24 or less, e.g., approximately 0.2 or approximately 0.15, with which conventional lithium cobalt oxide has the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is referred to as an O3′ type crystal structure. In FIG. 18, this crystal structure is denoted by R-3m O3′.

In the unit cell of the O3′ type crystal structure, the coordinates of cobalt and oxygen can be represented as follows: Co (0, 0, 0.5) and O (0, 0, z) within the range of 0.20≤z≤0.25. In the unit cell, the lattice constant of the a-axis is preferably 2.797≤a≤2.837 (×10⁻¹⁰ m), further preferably 2.807≤a≤2.827 (×10⁻¹⁰ m), typically a=2.817 (×10⁻¹⁰ m). The lattice constant of the c-axis is preferably 13.681≤c≤13.881 (×10⁻¹⁰ m), further preferably 13.751≤c≤13.811 (×10⁻¹⁰ m), typically c=13.781 (×10⁻¹⁰ m).

When x is approximately 0.15, the positive electrode active material 100 of one embodiment of the present invention has a monoclinic crystal structure belonging to the space group P2/m. This structure includes one CoO₂ layer in a unit cell. Here, lithium in the positive electrode active material 100 is approximately 15 atomic % of that in a discharged state. Thus, this crystal structure is referred to as a monoclinic O1(15) type crystal structure. In FIG. 18, this crystal structure is denoted by P2/m monoclinic O1(15).

In the unit cell of the monoclinic O1(15) type crystal structure, the coordinates of cobalt and oxygen can be represented by Co1 (0.5, 0, 0.5), Co2 (0, 0.5, 0.5), O1 (X_{O1}, 0, Z_{O1}) within the ranges of 0.23≤X_{O1}≤0.24 and 0.61≤Z_{O1}≤0.65, and O2 (X_{O2}, 0.5, Z_{O2}) within the ranges of 0.75≤X_{O2}≤0.78 and 0.68≤Z_{O2}≤0.71. The unit cell has lattice constants of a=4.880±0.05 (×10⁻¹⁰ m), b=2.817±0.05 (×10⁻¹⁰ m), c=4.839±0.05 (×10⁻¹⁰ m), α=90°, β=109.6±0.1°, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants of a=2.817±0.02 (×10⁻¹⁰ m) and c=13.68±0.1 (×10⁻¹⁰ m).

In both of the O3′ type crystal structure and the monoclinic O1(15) type crystal structure, an ion of cobalt, nickel, magnesium, or the like occupies a site coordinated to six oxygen atoms. Note that light elements such as lithium and magnesium sometimes occupy a site coordinated to four oxygen atoms.

As denoted by the dotted lines in FIG. 18, the CoO₂ layers hardly shift between the R-3m O3 type crystal structure in a discharged state, the O3′ type crystal structure, and the monoclinic O1(15) type crystal structure.

The R-3m O3 type crystal structure in a discharged state and the O3′ type crystal structure which contain the same number of cobalt atoms have a difference in volume of 2.5% or less, specifically 2.2% or less, typically 1.8%.

The R-3m O3 type crystal structure in a discharged state and the monoclinic O1(15) type crystal structure which contain the same number of cobalt atoms have a difference in volume of 3.3% or less, specifically 3.0% or less, typically 2.5%.

Table 2 shows a difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m 03 type structure in a discharged state and the trigonal O1 type structure in Table 2, which are used for the calculation, the literature values can be referred to (ICSD coll. code. 172909 and 88721). For the lattice constants of the H1-3 type structure, Non-Patent Document 3 can be referred to. In the case of the O3′ type structure and the monoclinic O1(15) type structure, the lattice constants thereof can be calculated from the experimental values of XRD. Note that 1 Å is 1×10⁻¹⁰ m.

TABLE 2

| Crystal | Lattice constant | | | | Volume of | Volume per | Volume change |
|---|---|---|---|---|---|---|---|
| structure | a (Å) | b (Å) | c (Å) | β (°) | unit cell (Å³) | Co atom (Å³) | percentage (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic | 4.881 | 2.817 | 4.839 | 109.6 | 62.69 | 31.35 | 2.5 |
| O1(15) | | | | | | | |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume between the compared structures having the same number of cobalt atoms is inhibited. Thus, the crystal structure of the positive electrode active material 100 is unlikely to break even when charge that makes x be 0.24 or less and discharge are repeated. Therefore, the positive electrode active material 100 inhibits a decrease in charge and discharge capacity in charge and discharge cycles. Furthermore, the positive electrode active material 100 can stably use a larger amount of lithium than a conventional positive electrode active material and thus enables high discharge capacity per weight and per volume. Thus, with the use of the positive electrode active material 100, a secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type crystal structure in some cases when x in LiₓCoO₂ is greater than 0.1 and less than or equal to 0.2, typically greater than or equal to 0.17 and less than or equal to 0.15. However, the crystal structure is influenced not only by x in LiₓCoO₂ but also by the number of charge and discharge cycles, charge current and discharge current, temperature, an electrolyte, and the like, so that the range of x is not limited to the above.

Thus, when x in LiₓCoO₂ is greater than 0.1 and less than or equal to 0.24, the positive electrode active material 100 may have only the O3′ type crystal structure, only the monoclinic O1(15) type crystal structure, or both of them. Not all particles of the inner portion 100b of the positive electrode active material 100 necessarily have the O3′ type crystal structure and/or the monoclinic O1(15) type crystal structure. The positive electrode active material may have another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CC/CV charge is performed at 25° C. and a voltage of 4.6 V or higher with reference to the potential of a lithium metal, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, in other words, the positive electrode active material 100 of one embodiment of the present invention is preferable because the crystal structure with the symmetry of R-3m O3 can be maintained even when charge at a high charge voltage of 4.6 V or higher is performed at 25° C., for example. In other words, the positive electrode active material 100 of one embodiment of the present invention is preferable because the O3′ type crystal structure can be obtained when charge at a higher charge voltage, e.g., a voltage higher than or equal to 4.65 V and lower than or equal to 4.7 V is performed at 25° C. In other words, the positive electrode active material 100 of one embodiment of the present invention is preferable because the monoclinic O1(15) type crystal structure can be obtained when charge at an even higher charge voltage, e.g., a voltage higher than 4.7 V and lower than or equal to 4.8 V is performed at 25° C.

In the positive electrode active material 100, when the charge voltage is increased, the H1-3 type crystal structure is eventually observed in some cases. As described above, the crystal structure is influenced by the number of charge and discharge cycles, charge current and discharge current, temperature, an electrolyte, and the like, so that the positive electrode active material 100 of one embodiment of the present invention sometimes has the O3′ type crystal structure even at a lower charge voltage, e.g., a charge voltage higher than or equal to 4.5 V and lower than 4.6 V at 25° C. Similarly, the positive electrode active material 100 sometimes has the monoclinic O1(15) type crystal structure at a charge voltage higher than or equal to 4.65 V and lower than or equal to 4.7 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of graphite.

Although a chance of the existence of lithium is the same in all lithium sites in O3′ and monoclinic O1(15) in FIG. 18, one embodiment of the present invention is not limited thereto. Lithium may exist unevenly in only some of the lithium sites; for example, lithium may symmetrically exist as in the monoclinic O1 (Li_{0.5}CoO₂) illustrated in FIG. 19. Distribution of lithium can be analyzed by neutron diffraction, for example.

The O3′ type crystal structure and the monoclinic O1(15) type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide when charged to be Li_{0.06}NiO₂; however, pure lithium cobalt oxide or a layered rock-salt positive electrode active material containing a large amount of cobalt is known not to have the CdCl₂ type crystal structure in general.

### <<Crystal Grain Boundary>>

It is further preferable that the additive element contained in the positive electrode active material 100 of one embodiment of the present invention have the above-described distribution and be at least partly unevenly distributed at the crystal grain boundary 101 and the vicinity thereof.

In this specification and the like, uneven distribution means that the concentration of an element in a certain region differs from that in another region. This may be rephrased as segregation, precipitation, unevenness, deviation, or a mixture of a high-concentration portion and a low-concentration portion.

For example, the concentration of magnesium at the crystal grain boundary 101 and the vicinity thereof in the positive electrode active material 100 is preferably higher than that in the other regions in the inner portion 100b. In addition, the concentration of fluorine at the crystal grain boundary 101 and the vicinity thereof is preferably higher than that in the other regions in the inner portion 100b. In addition, the concentration of nickel at the crystal grain boundary 101 and the vicinity thereof is preferably higher than that in the other regions in the inner portion 100b. In addition, the concentration of aluminum at the crystal grain boundary 101 and the vicinity thereof is preferably higher than that in the other regions in the inner portion 100b.

The crystal grain boundary 101 is a type of plane defect. Thus, the crystal grain boundary 101 tends to be unstable and the crystal structure easily starts to change like the surface of the particle. Hence, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with the electrolyte solution. Thus, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

### <Analysis Method>

Whether or not a given positive electrode active material is the positive electrode active material 100 of one embodiment of the present invention, which has the O3′ type crystal structure and/or monoclinic O1(15) type crystal structure when x in LiₓCoO₂ is small, can be determined by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is measured by powder XRD, the measurement is preferably performed while the influence of orientation of positive electrode active material particles due to pressure application or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 of one embodiment of the present invention has a feature of a small change in the crystal structure between when x in LiₓCoO₂ is 1 and when x is less than or equal to 0.24. A material 50% or more of which has the crystal structure to be largely changed by high-voltage charge is not preferable because the material cannot withstand repetition of high-voltage charge and discharge.

It should be noted that the O3′ type crystal structure or the monoclinic O1(15) type crystal structure is not obtained in some cases only by addition of the additive element. For example, when x in LiₓCoO₂ is less than or equal to 0.24, lithium cobalt oxide containing magnesium and fluorine or lithium cobalt oxide containing magnesium and aluminum has the O3′ type crystal structure and/or the monoclinic O1(15) type crystal structure at 60% or more in some cases, and has the H1-3 type crystal structure at 50% or more in other cases, depending on the concentration and distribution of the additive element.

In the case where x is too small, e.g., 0.1 or less, or under the condition where charge voltage is higher than 4.9 V, even the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be determined by, for example, analysis using XPS, energy dispersive X-ray spectroscopy (EDX), EPMA (electron probe microanalysis), or the like.

The crystal structure of the surface portion 100a, the crystal grain boundary 101, or the like can be analyzed by electron diffraction of a cross section of the positive electrode active material 100, for example.

### <<Charge Method>>

Charge for determining whether or not a composite oxide is the positive electrode active material 100 of one embodiment of the present invention can be performed on a coin cell (CR2032 type with a diameter of 20 mm and a height of 3.2 mm) with the composite oxide used for a positive electrode and a lithium metal used for a counter electrode, for example. The coin cell includes an electrolyte solution, a separator, a positive electrode can, and a negative electrode can.

More specifically, a positive electrode can be formed by application of slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated under the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. In the case of CCCV charge, for example, CC charge can be performed with a current higher than or equal to 20 mA/g and lower than or equal to 100 mA/g. CV charge can be ended with a current higher than or equal to 2 mA/g and lower than or equal to 10 mA/g. To observe a phase change of the positive electrode active material, charge with such a small current value is desirably performed. The temperature is set to 25° C. or 45° C. After charge is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charge is completed, the positive electrode is preferably taken out and subjected to the analysis immediately. Specifically, the positive electrode is preferably subjected to analysis within an hour, further preferably within 30 minutes after the completion of charge.

In the case where the crystal structure in a charged state after charge and discharge are performed multiple times is analyzed, the conditions of the charge and discharge performed multiple times may be different from the above-described charge conditions. For example, the charge can be performed by constant current charge with a current value greater than or equal to 20 mA/g and less than or equal to 100 mA/g to a given voltage (e.g., 4.6 V, 4.65 V, 4.7 V, 4.75 V, or 4.8 V) and then constant voltage charge until the current value becomes greater than or equal to 2 mA/g and less than or equal to 10 mA/g. The discharge can be performed by constant current discharge with greater than or equal to 20 mA/g and less than or equal to 100 mA/g to 2.5 V.

Also in the case where the crystal structure in a discharged state after the charge and discharge are performed multiple times is analyzed, constant current discharge can be performed with a current value greater than or equal to 20 mA/g and less than or equal to 100 mA/g to 2.5 V, for example.

### <<XRD>>

The apparatus and conditions for the XRD measurement are not particularly limited. For example, the measurement can be performed using the following apparatus and conditions.
XRD apparatus: D8 ADVANCE produced by Bruker AXS
X-ray: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in the following manner: the positive electrode is attached to a substrate with a double-sided adhesive tape so that the position of the positive electrode active material layer can be adjusted to the measurement plane required by the apparatus.

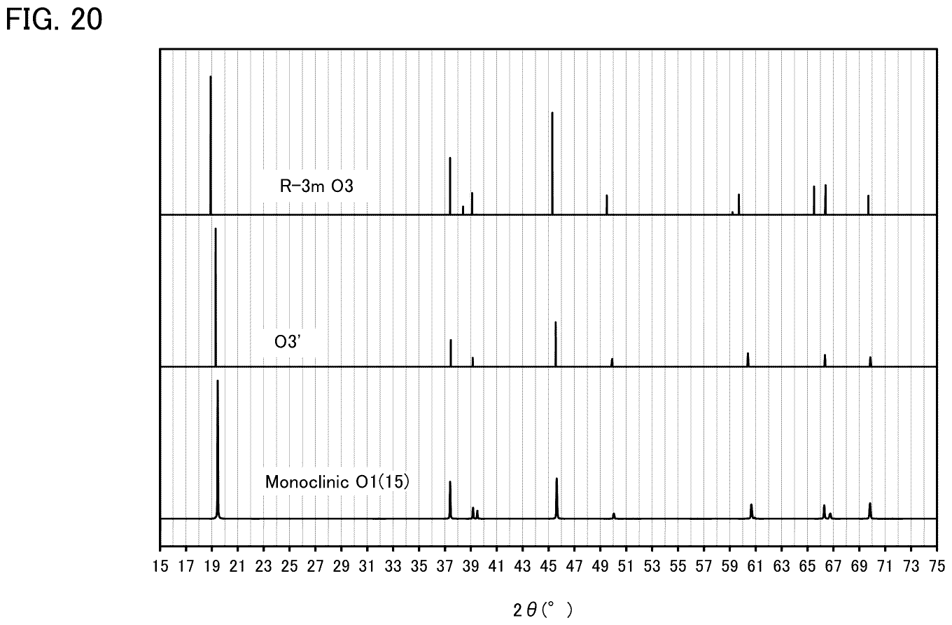

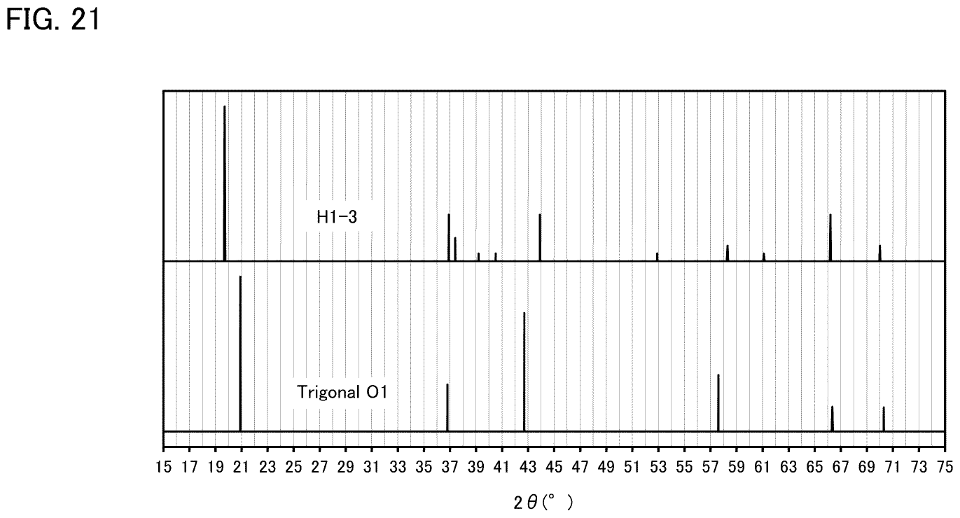

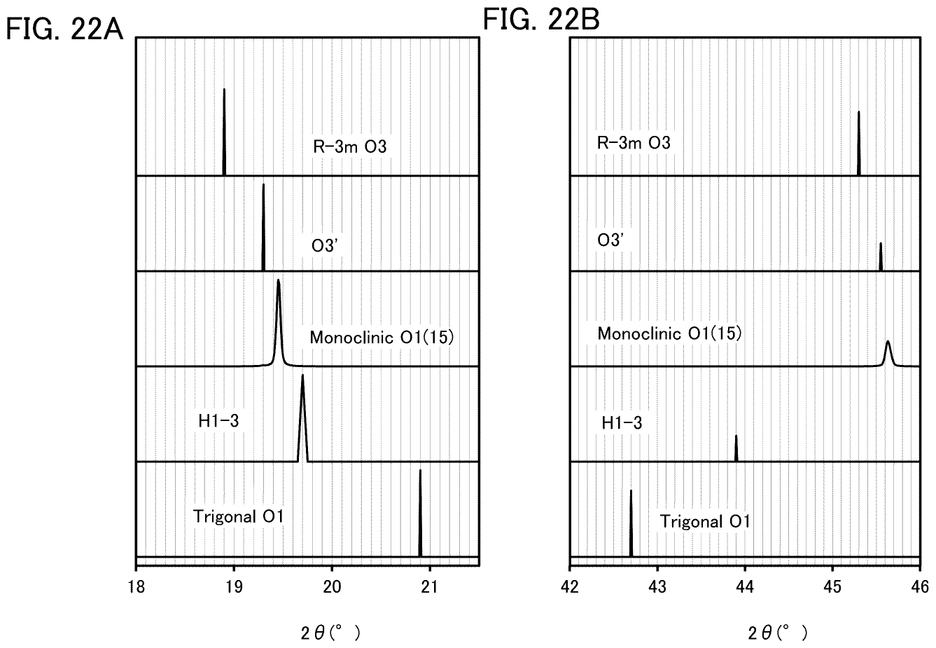

FIG. 20, FIG. 21, FIG. 22A, and FIG. 22B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the crystal structure of LiCoO₂ O3 with x=1 in LiₓCoO₂ and the crystal structure of the trigonal O1 with x=0 are also shown. FIG. 22A and FIG. 22B each show the XRD patterns of the O3′ type crystal structure, the monoclinic O1(15) type crystal structure, and the H1-3 type crystal structure, and FIG. 22A and FIG. 22B are enlarged diagrams showing, respectively, a range of 2θ greater than or equal to 180 and less than or equal to 21° and a range of 2θ greater than or equal to 42° and less than or equal to 46°. Note that the patterns of LiCoO₂ (O3) and CoO₂ (O1) are made from crystal structure data obtained from the ICSD (Inorganic Crystal Structure Database) (see Non-Patent Document 4) with Reflex Powder Diffraction, which is a module of Materials Studio (BIOVIA). The 2θ range is from 15° to 75°, the step size is 0.01, the wavelength λ1 is 1.540562×10⁻¹⁰ m, λ2 is not set, and a single monochromator is used. The pattern of the H1-3 type crystal structure is similarly made from the crystal structure data disclosed in Non-Patent Document 3. The O3′ type crystal structure and the monoclinic O1(15) type crystal structure are estimated from the XRD pattern of the positive electrode active material of one embodiment of the present invention, the crystal structure is fitted with TOPAS ver. 3 (crystal structure analysis software produced by Bruker Corporation), and the XRD patterns of the O3′ type crystal structure and the monoclinic O1(15) type crystal structure are made in a manner similar to that for other structures.

As shown in FIG. 20, FIG. 22A, and FIG. 22B, the O3′ type crystal structure exhibits diffraction peaks at 2θ=19.25±0.12° (greater than or equal to 19.130 and less than 19.37°) and 2θ=45.47±0.10° (greater than or equal to 45.37° and less than 45.57°).

Furthermore, the monoclinic O1(15) type crystal structure exhibits diffraction peaks at 2θ=19.47±0.10° (greater than or equal to 19.370 and less than or equal to 19.57°) and 2θ=45.62±0.05° (greater than or equal to 45.57° and less than or equal to 45.67°).

However, as shown in FIG. 21, FIG. 22A, and FIG. 22B, the H1-3 type crystal structure and the trigonal O1 do not exhibit peaks at these positions. Thus, it can be said that exhibiting peaks at greater than or equal to 19.13° and less than 19.37° and/or greater than or equal to 19.37° and less than or equal to 19.57° and at greater than or equal to 45.37° and less than 45.57° and/or greater than or equal to 45.57° and less than or equal to 45.67° in a state with small x in LiₓCoO₂ is the feature of the positive electrode active material 100 of one embodiment of the present invention.

It can also be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure and/or the monoclinic O1(15) type crystal structure when x in LiₓCoO₂ is small, not all particles necessarily have the O3′ type crystal structure and/or the monoclinic O1(15) type crystal structure. The particles may include another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% enables sufficiently good cycle performance.

Furthermore, even after 100 or more cycles of charge and discharge after the measurement starts, the O3′ type crystal structure and/or the monoclinic O1(15) type crystal structure preferably account(s) for greater than or equal to 35%, further preferably greater than or equal to 40%, still further preferably greater than or equal to 43% when the Rietveld analysis is performed.

In addition, the H1-3 type crystal structure and the O1 type crystal structure preferably account for less than or equal to 50% in the Rietveld analysis performed in a similar manner.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity sufficiently contributes to stability of the crystal structure after charge.

The crystallite sizes of the O3′ type crystal structure and the monoclinic O1(15) type crystal structure included in the positive electrode active material 100 are only decreased to approximately one-twentieth that of LiCoO₂ (O3) in a discharged state. Thus, a clear peak of the O3′ type crystal structure and/or the monoclinic O1(15) type crystal structure can be observed when x in LiₓCoO₂ is small, even under the same XRD measurement conditions as those of a positive electrode before charge and discharge. By contrast, conventional LiCoO₂ has a small crystallite size and a broad and small peak even when it can have a structure part of which is similar to the O3′ type crystal structure and/or the monoclinic O1(15) type crystal structure. The crystallite size can be calculated from the half width of the XRD peak.

Preferable ranges of the lattice constants of the positive electrode active material of one embodiment of the present invention are examined above. In the layered rock-salt crystal structure of the positive electrode active material 100 in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charge and discharge are not performed may be, for example, the state of a powder before the fabrication of a positive electrode of a secondary battery.

Alternatively, in the layered rock-salt crystal structure of the positive electrode active material 100 in the discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charge and discharge are not performed is subjected to XRD analysis, a first peak is observed at 2θ of greater than or equal to 18.50° and less than or equal to 19.30° and a second peak is observed at 2θ of greater than or equal to 38.00° and less than or equal to 38.80°, in some cases.

### <<XPS>>

In an inorganic oxide, a region ranging from a surface to a depth of approximately 2 to 8 nm (normally, less than or equal to 5 nm) can be analyzed by X-ray photoelectron spectroscopy (XPS) using monochromatic aluminum Kα radiation as an X-ray; thus, the concentrations of elements in a region ranging to approximately half the depth of the surface portion 100a can be quantitatively analyzed. The bonding states of the elements can be analyzed by narrow scanning. Note that in many cases, the quantitative accuracy of XPS is approximately ±1 atomic %, and the lower detection limit is approximately 1 atomic % but depends on the element.

In the positive electrode active material 100 of one embodiment of the present invention, the concentration of one or two or more selected from the additive elements is preferably higher in the surface portion 100a than in the inner portion 100b. This means that the concentration of one or two or more selected from the additive elements in the surface portion 100a is preferably higher than the average concentration of the selected element(s) in the entire positive electrode active material 100. For this reason, for example, it can be said that the concentration of one or two or more additive elements selected from the surface portion 100a, which is measured by XPS or the like, is preferably higher than the average concentration of the additive element(s) in the entire positive electrode active material 100, which is measured by ICP-MS (inductively coupled plasma-mass spectrometry), GD-MS (glow discharge mass spectrometry), or the like. For example, the concentration of magnesium in at least part of the surface portion 100a, which is measured by XPS or the like, is preferably higher than the average concentration of magnesium in the entire positive electrode active material 100. The concentration of nickel in at least part of the surface portion 100a is preferably higher than the average concentration of nickel in the entire positive electrode active material 100. The concentration of aluminum in at least part of the surface portion 100a is preferably higher than the average concentration of aluminum in the entire positive electrode active material 100. The concentration of fluorine in at least part of the surface portion 100a is preferably higher than the average concentration of fluorine in the entire positive electrode active material 100.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material, a positive electrode active material layer, or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt is preferable because it enables comparison while reducing the influence of a carbonate or the like which is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, (Mg/Co) is preferably greater than or equal to 0.001 and less than or equal to 0.06.

Similarly, to secure the sufficient path through which lithium is inserted and extracted, the concentrations of lithium and cobalt are preferably higher than those of the additive elements in the surface portion 100a of the positive electrode active material 100. It can be said that the concentrations of lithium and cobalt in the surface portion 100a are preferably higher than that of one or two or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than that of aluminum. Similarly, the concentration of lithium is preferably higher than the concentration of aluminum. The concentration of cobalt is preferably higher than that of fluorine. Similarly, the concentration of lithium is preferably higher than that of fluorine.

It is further preferable that the additive element Y such as aluminum be widely distributed in a deep region, e.g., a region ranging from a depth from the surface of 5 nm or more to a depth from the surface of 50 nm or less. Thus, the additive element Y such as aluminum is detected by analysis on the entire positive electrode active material 100 by ICP-MS, GD-MS, or the like, but the concentration of the additive element Y such as aluminum is preferably lower than or equal to the lower detection limit in XPS or the like.

Furthermore, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the number is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray, for example. An extraction angle is, for example, 45°. For example, the measurement can be performed using the following apparatus and conditions.
Measurement apparatus: Quantera II produced by PHI, Inc.
X-ray: monochromatic Al Kα (1486.6 eV)
Detection area: 100 μmϕ
Detection depth: approximately 4 to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably at approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <<EDX>>

The one or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferable because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of each additive element, in particular, the additive element Xin the surface portion 100a is higher than that in the inner portion 100b.

The surface of the positive electrode active material in, for example, STEM-EDX line analysis refers to a point where the value of characteristic X-rays derived from cobalt is equal to 50% of the sum of the average value M_{AVE} of the amount of detected cobalt in the inner portion and the average value M_{BG} of the amount of background cobalt and a point where the value of characteristic X-rays derived from oxygen is equal to 50% of the sum of the average value O_{AVE} of the amount of detected oxygen in the inner portion and the average value O_{BG} of the amount of background oxygen. Note that in the case where the positions of the points differ between cobalt and oxygen, the difference is probably due to the influence of a carbonate, a metal oxide containing oxygen, or the like, which is attached to the surface. Thus, the point that is equal to 50% of the sum of the average value M_{AVE} of the amount of detected cobalt in the inner portion and the average value M_{BG} of the amount of background cobalt can be used.

The average value M_{BG} of the amount of background cobalt can be calculated by averaging the amounts of detected cobalt in the range greater than or equal to 2 nm, preferably greater than or equal to 3 nm, which is outside a portion of the positive electrode active material in the vicinity of the portion at which the amount of detected cobalt begins to increase, for example. The average value M_{AVE} of the amount of detected cobalt in the inner portion can be calculated by averaging the amounts of detected cobalt in the range greater than or equal to 2 nm, preferably greater than or equal to 3 nm in a region where the count numbers of cobalt and oxygen atoms are saturated and stabilized, e.g., a portion that is greater than or equal to 30 nm, preferably greater than 50 nm in depth from the portion where the amount of detected cobalt begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed.

A peak in STEM-EDX line analysis refers to a local maximum value or the maximum value (also referred to as a peak top) of detection intensity in the intensity distribution of characteristic X-ray corresponding to each element (also referred to as a profile of EDX line analysis). As a noise in STEM-EDX line analysis, a measured value having a half width smaller than or equal to spatial resolution (R), for example, smaller than or equal to R/2 can be given.

For example, EDX area analysis or EDX point analysis of the positive electrode active material 100 containing magnesium as the additive element preferably reveals that the concentration of magnesium in the surface portion 100a is higher than the concentration of magnesium in the inner portion 100b. In the EDX line analysis, a peak of the concentration of magnesium in the surface portion 100a preferably exists in a region from the surface of the positive electrode active material 100 to a depth of 3 nm, further preferably to a depth of 1 nm, still further preferably to a depth of 0.5 nm toward the center. Alternatively, the depth is preferably within +1 nm from the surface. In addition, the magnesium concentration preferably attenuates, at a depth of 1 nm from the peak position, to less than or equal to 60% of the peak concentration. In addition, the magnesium concentration preferably attenuates, at a depth of 2 nm from the peak position, to less than or equal to 30% of the peak concentration. Here, “peak concentration” refers to the local maximum value of the concentration. Note that due to the influence of spatial resolution in the EDX line analysis, the position where the peak of the magnesium concentration exists sometimes has a negative value as a depth from the surface toward the inner portion.

When the positive electrode active material 100 contains magnesium and fluorine as the additive elements, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX line analysis, a peak of the fluorine concentration in the surface portion 100a preferably exists in a region from the surface of the positive electrode active material 100 to a depth of 3 nm, further preferably to a depth of 1 nm, still further preferably to a depth of 0.5 nm toward the center. Alternatively, the depth is preferably within ±1 nm from the surface. It is further preferable that a peak of the fluorine concentration be exhibited slightly closer to the surface than a peak of the magnesium concentration is, which increases resistance to hydrofluoric acid. For example, it is preferable that a peak of the fluorine concentration be exhibited closer to the surface than a peak of the magnesium concentration is by 0.5 nm or more, further preferably 1.5 nm or more.

In the positive electrode active material 100 containing nickel as the additive element, a peak of the nickel concentration in the surface portion 100a preferably exists in a region from the surface of the positive electrode active material 100 to a depth of 3 nm, further preferably to a depth of 1 nm, still further preferably to a depth of 0.5 nm toward the center. Alternatively, the depth is preferably within ±1 nm from the surface. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

In the case where the positive electrode active material 100 contains aluminum as the additive element, a peak of the concentration of magnesium, nickel, or fluorine is preferably closer to the surface than a peak of the aluminum concentration is in the surface portion 100a in the EDX line analysis. For example, a peak of the aluminum concentration preferably exists in a region from the surface of the positive electrode active material 100 to a depth greater than or equal to 0.5 nm and less than or equal to 50 nm, further preferably to a depth greater than or equal to 3 nm and less than or equal to 30 nm toward the center.

When EDX line, area, or point analysis is performed on the positive electrode active material 100, the atomic ratio of magnesium Mg to cobalt Co (Mg/Co) at a peak of the magnesium concentration is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the aluminum concentration is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the nickel concentration is preferably greater than or equal to 0 and less than or equal to 0.2, further preferably greater than or equal to 0.01 and less than or equal to 0.1. The atomic ratio of fluorine F to cobalt Co (F/Co) at a peak of the fluorine concentration is preferably greater than or equal to 0 and less than or equal to 1.6, further preferably greater than or equal to 0.1 and less than or equal to 1.4.

The crystal grain boundary 101 refers to, for example, a portion where particles of the positive electrode active material 100 adhere to each other or a portion where a crystal orientation changes inside the positive electrode active material 100, e.g., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a cavity, or the like. The crystal grain boundary 101 can be regarded as one of plane defects. The vicinity of the crystal grain boundary 101 refers to a region extending less than or equal to 10 nm from the crystal grain boundary 101.

When the line analysis or the area analysis is performed on the positive electrode active material 100, the atomic ratio of an additive element A to cobalt Co (A/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 containing magnesium as the additive element, for example, the atomic ratio of magnesium to cobalt (Mg/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions, of the positive electrode active material 100, it can be said that the additive element is not attached to the surface of the positive electrode active material 100 in a narrow range but widely distributed at a preferable concentration in the surface portion 100a of the positive electrode active material 100.

### <<Powder Resistivity Measurement>>

The positive electrode active material 100 of one embodiment of the present invention has a stable crystal structure even at a high voltage. The stable crystal structure of the positive electrode active material in a charged state can inhibit a charge and discharge capacity decrease due to repeated charge and discharge. In <<XRD>> above, the positive electrode active material 100 having excellent characteristics as described above is described as having a feature of having the O3′ type crystal structure and/or the monoclinic O1(15) type crystal structure when x in LiₓCoO₂ is small. In <<EDX>> above, the preferable distributions of the additive element X and the additive element Y in the STEM-EDX analysis of the positive electrode active material 100 are described. Furthermore, the positive electrode active material 100 of one embodiment of the present invention also has a feature in the volume resistivity of the powder.

As the feature of the positive electrode active material 100 of one embodiment of the present invention, the volume resistivity of the powder of the positive electrode active material 100 is preferably higher than or equal to 1.0×10⁸ Ω·cm and lower than or equal to 1.0×10¹⁰ Ω·cm, further preferably higher than or equal to 5.0×10⁸ Ω·cm and lower than or equal to 1.5×10⁸ Ω·cm under a pressure of 64 MPa. In that case, the total mass of magnesium oxide and tricobalt tetraoxide in the powder of the positive electrode active material 100 is less than or equal to 3% with respect to the mass of lithium cobalt oxide contained in the positive electrode active material 100.

The positive electrode active material 100 with the above volume resistivity has a stable crystal structure even at a high voltage. Thus, the volume resistivity of the powder of the positive electrode active material 100 falling within the above-described range can indicate the favorable formation of the surface portion 100a, which is an important factor for a stable crystal structure of the positive electrode active material in a charged state.

Note that the proportions of magnesium oxide, tricobalt tetraoxide, and lithium cobalt oxide contained in the powder of the positive electrode active material 100 can be estimated by Rietveld analysis of a pattern obtained by powder X-ray diffraction (XRD).

A method for measuring the volume resistivity of the powder of the positive electrode active material 100 of one embodiment of the present invention is described.

For measurement of the volume resistivity of the powder, a device portion including terminals for resistance measurement and a mechanism for applying pressure to the powder serving as a measurement target are preferably provided. The terminals for resistance measurement are preferably four terminals (also referred to as four probes). As such a measurement apparatus that includes the terminals for resistance measurement and the mechanism for applying pressure to the powder as a measurement target (sample), for example, MCP-PD51 produced by Mitsubishi Chemical Analytech Co., Ltd. can be used. As the device portion for a four-probe method, Loresta-GP or Hiresta-GP can be used. The Loresta-GP can be used for measurement of a low-resistance sample, and the Hiresta-GP can be used for measurement of a high-resistance sample. Note that the measurement environment is preferably a stable environment such as a dry room. An example of a preferable environment of the dry room is that the temperature is 25° C. and the dew point is lower than or equal to −40° C.

The measurement of the volume resistivity of the powder using the above-described measurement apparatus is described. First, a powder sample is set in a measurement unit. The measurement unit has a structure in which the powder sample and the terminals for resistance measurement are in contact with each other, and pressure can be applied to the powder sample. A structure for measuring the volume of a powder sample set in the measurement unit is also included. Specifically, the measurement unit includes a cylindrical space, and the powder sample is set in the space. In the structure for measuring the volume of the powder sample, the volume occupied by the powder set in the space can be measured by measuring the height of the powder.

In the measurement of the volume resistivity of the powder, the electrical resistance and volume of the powder under pressure are measured. The pressure applied to the powder can be varied. For example, the electrical resistance and volume of the powder can be measured under pressures of 16 MPa, 25 MPa, 38 MPa, 51 MPa, and 64 MPa. The volume resistivity of the powder can be calculated from the measured electrical resistance and volume of the powder.

In the case where the above-described measurement is performed and the volume resistivity of the powder of the positive electrode active material 100 of one embodiment of the present invention is higher than or equal to 1.0×10⁸ Ω·cm and lower than or equal to 1.0×10¹⁰ Ω·cm under a pressure of 64 MPa, good cycle performance is obtained in a charge and discharge cycle test under the high voltage condition, and better cycle performance is obtained in the charge and discharge cycle test under the high voltage condition in the case where the volume resistivity is higher than or equal to 5.0×10⁸ Ω·cm and lower than or equal to 1.5×10⁹ Ω·cm.

This embodiment can be used in combination with the other embodiments.

### Embodiment 4

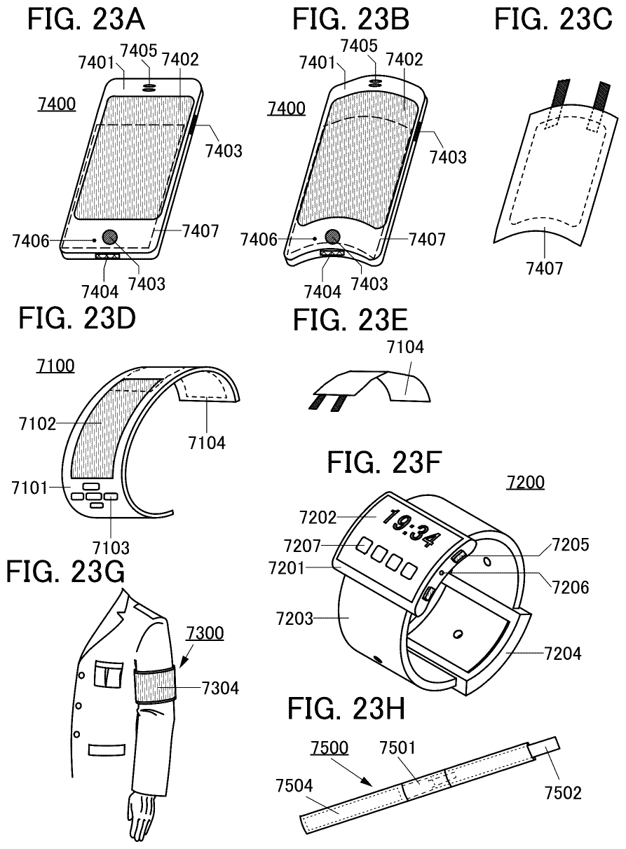

In this embodiment, examples of electronic devices each including the secondary battery of one embodiment of the present invention will be described with reference to FIG. 23A to FIG. 25C.

FIG. 23A to FIG. 23G illustrate examples of electronic devices each including the secondary battery including the power storage system of one embodiment of the present invention. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

A flexible secondary battery can be incorporated along a curved inside or outside wall surface of a house, a building, or the like or a curved interior or exterior surface of an automobile, for example.

FIG. 23A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 23B illustrates the state where the mobile phone 7400 is bent. When the whole mobile phone 7400 is bent by external force, the secondary battery 7407 provided in the mobile phone 7400 is also bent. FIG. 23C illustrates the bent secondary battery 7407. The secondary battery 7407 is a thin storage battery. The secondary battery 7407 is fixed in a state of being bent. Note that the secondary battery 7407 includes a lead electrode electrically connected to a current collector.

FIG. 23D illustrates an example of a bangle display device. A portable display device 7100 includes a housing 7101, a display portion 7102, operation buttons 7103, and a secondary battery 7104. FIG. 23E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 23F illustrates an example of a watch-type portable information terminal. A portable information terminal 7200 includes a housing 7201, a display portion 7202, a band 7203, a buckle 7204, an operation button 7205, an input/output terminal 7206, and the like. The portable information terminal 7200 includes a secondary battery (not illustrated).

The portable information terminal 7200 is capable of executing a variety of applications such as mobile phone calls, e-mailing, viewing and editing texts, music reproduction, Internet communication, and a computer game.

The display surface of the display portion 7202 is curved, and display can be performed on the curved display surface. The display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication conformable to a communication standard. For example, mutual communication with a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

When the secondary battery of one embodiment of the present invention is used as the secondary battery included in the portable information terminal 7200, a lightweight portable information terminal with a long lifetime can be provided. For example, the secondary battery 7104 illustrated in FIG. 23E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 23G illustrates an example of an armband display device. A display device 7300 includes a display portion 7304. The display device 7300 also includes a secondary battery (not illustrated). The display device 7300 can include a touch sensor in the display portion 7304 and can serve as a portable information terminal.

The display surface of the display portion 7304 is curved, and display can be performed on the curved display surface. A display state of the display device 7300 can be changed by, for example, near field communication conformable to a communication standard.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

Examples of electronic devices each including the secondary battery of one embodiment of the present invention with excellent cycle performance are described with reference to FIG. 23H to FIG. 25C.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high discharge capacity are desired in consideration of handling ease for users.

FIG. 23H is a perspective view of a device called a cigarette smoking device (electronic cigarette). In FIG. 23H, an electronic cigarette 7500 includes an atomizer 7501 including a heating element, a secondary battery 7504 that supplies power to the atomizer, and a cartridge 7502 including a liquid supply bottle, a sensor, and the like. The secondary battery of one embodiment of the present invention can be used as the secondary battery 7504. To improve safety, a protection circuit that prevents at least one of overcharge and overdischarge of the secondary battery 7504 may be electrically connected to the secondary battery 7504. The secondary battery 7504 illustrated in FIG. 23H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

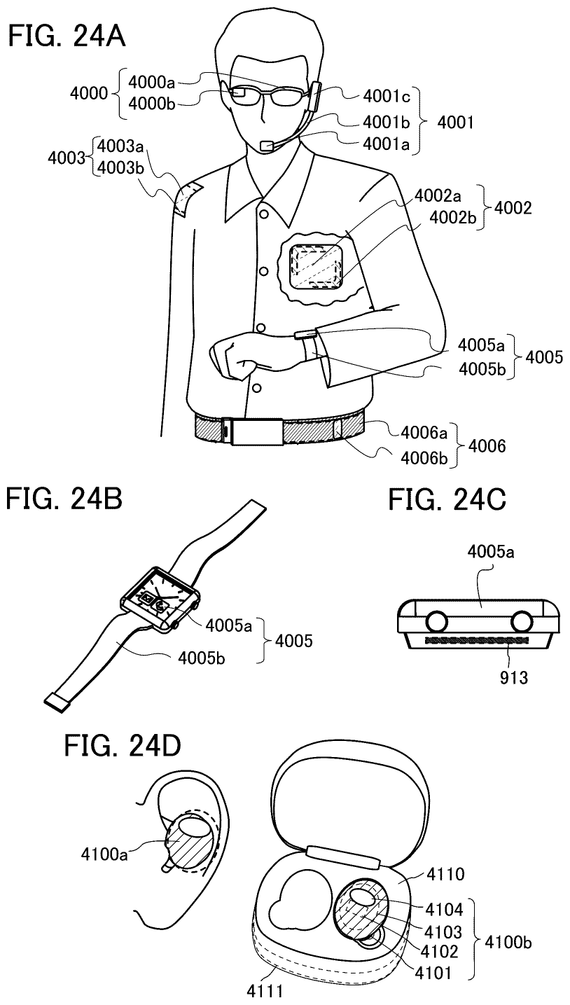

FIG. 24A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 24A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in at least one of the flexible pipe 4001b and the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 24B illustrates a perspective view of the watch-type device 4005 that is detached from an arm.

FIG. 24C illustrates a side view. FIG. 24C illustrates a state where a secondary battery 913 is incorporated in the inner portion. The secondary battery 913 is the secondary battery of one embodiment of the present invention. The secondary battery 913, which is small and lightweight, is provided at a position overlapping with the display portion 4005a.

FIG. 24D illustrates an example of wireless earphones. The wireless earphones illustrated here consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, a coin-type secondary battery, a cylindrical secondary battery, or the like that includes the secondary battery of one embodiment of the present invention can be used. A secondary battery using the negative electrode active material of one embodiment of the present invention has a high energy density; thus, with the use of the secondary battery as the secondary battery 4103 and the secondary battery 4111, space saving required with downsizing of the wireless earphones can be achieved.

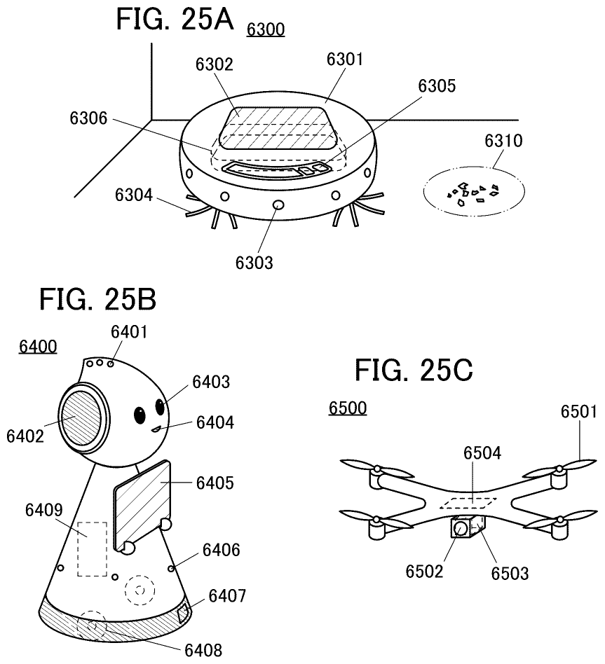

FIG. 25A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes a secondary battery 6306 of one embodiment of the present invention and a semiconductor device or an electronic component. The cleaning robot 6300 including the secondary battery of one embodiment of the present invention can be a highly reliable electronic device that can operate for a long time.

FIG. 25B illustrates an example of a robot. A robot 6400 illustrated in FIG. 25B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of sensing a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 25C illustrates an example of a flying object. A flying object 6500 illustrated in FIG. 25C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 5

In this embodiment, examples of vehicles each including the secondary battery including the power storage system of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

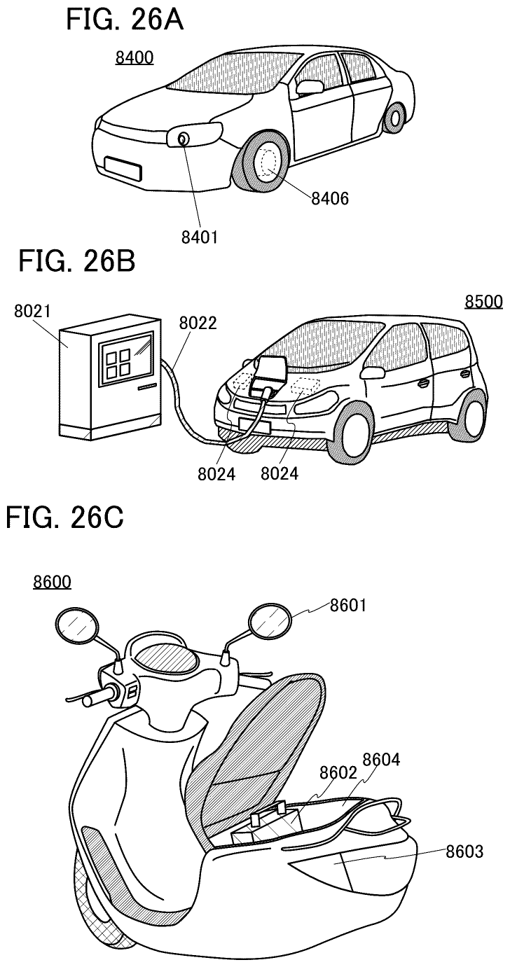

FIG. 26A to FIG. 26C illustrate examples of vehicles each including the secondary battery of one embodiment of the present invention. An automobile 8400 illustrated in FIG. 26A is an electric vehicle that runs on the power of an electric motor. Alternatively, the automobile 8400 is a hybrid electric vehicle capable of driving using either an electric motor or an engine as appropriate. The automobile 8400 includes the secondary battery (not illustrated). For example, the modules of the secondary battery can be arranged in a floor portion in the automobile to be used. The secondary battery can be used not only for driving an electric motor 8406, but also for supplying power to a light-emitting device such as a headlight 8401 and a room light (not illustrated). The use of the secondary battery of one embodiment of the present invention as the secondary battery included in the automobile 8400 can achieve a high-mileage vehicle.

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 26B includes a secondary battery 8024. The secondary battery of one embodiment of the present invention can be used as the secondary battery 8024. Charge can be performed when the secondary battery 8024 included in the automobile 8500 is supplied with power through external charge equipment by a plug-in system, a contactless power feeding system, or the like, for example. FIG. 26B illustrates a state where the secondary battery 8024 included in the automobile 8500 is charged with the use of a ground-based charge apparatus 8021 through a cable 8022. In charge, a given method such as CHAdeMO (registered trademark) or Combined Charging System may be employed as a charge method, the standard of a connector, and the like as appropriate. The charge apparatus 8021 may be a charge station provided in a commerce facility or a power source in a house. For example, with the use of a plug-in technique, the secondary battery 8024 included in the automobile 8500 can be charged by being supplied with power from the outside. Charge can be performed by converting AC power into DC power through a converter such as an ACDC converter.

Although not illustrated, the vehicle may include a power receiving device so that it can be charged by being supplied with power from an above-ground power transmitting device in a contactless manner. In the case of the contactless power feeding system, by fitting a power transmitting device in a road, an exterior wall, or the like, for example, charge can be performed not only when the vehicle is stopped but also when driven. In addition, the contactless power feeding system may be utilized to perform transmission and reception of power between vehicles. Furthermore, a solar cell may be provided in the exterior of the vehicle to charge the secondary battery when the vehicle stops and/or moves, for example. To supply power in such a contactless manner, an electromagnetic induction method, a magnetic resonance method, or the like can be used.

FIG. 26C is an example of a motorcycle using the secondary battery of one embodiment of the present invention. A motor scooter 8600 illustrated in FIG. 26C includes a secondary battery 8602, side mirrors 8601, and direction indicators 8603. The secondary battery 8602 can supply electricity to the direction indicators 8603. The secondary battery of one embodiment of the present invention can be used as the secondary battery 8602.

In the motor scooter 8600 illustrated in FIG. 26C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to the secondary battery of one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle, and thus can increase the mileage. Furthermore, the secondary battery included in the vehicle can be used as a power supply source for products other than the vehicle. In such a case, the use of a commercial power source can be avoided at peak time of power demand, for example. Avoiding the use of a commercial power source at peak time of power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### REFERENCE NUMERALS

200: power storage system
201: charging unit, 121: secondary battery, 151: voltage measuring circuit, 152: current measuring circuit, 153: control circuit, TS: temperature sensor, 185: detection circuit, 186: detection circuit, SD: short-circuit detection circuit, MSD: micro short-circuit detection circuit, 140: transistor, 150: transistor, 152a: resistor, 152b: circuit, 157: DC-DC converter, 158: circuit, 159: diode, Vb1: voltage, Vb2: voltage, Vb3: voltage, 122: resistor, 123: resistor, S100: step, S101: step, S102: step, S103: step, S104: step, S105: step, S106: step, S107: step, S199: step, tp: time, t1: time, t2: time, V2: voltage, S000: step, S001: step, S002: step, S003: step, S004: step, S005: step, S006: step, S007: step, S099: step, tq: time, t3: time, t4: time, V1: voltage, S200: step, S201: step, S202: step, S203: step, S204: step, S205: step, S206: step, S299: step, V3: voltage, 151A: voltage measuring circuit, 162: S/H, 171: comparator, 172: DAC, 173: control portion, 173a: signal processing circuit, 173b: timing circuit, 173c: register, 174: S/H, SMP1: signal, SMP2: signal, STUP: signal, WKUP: signal, SLEP: signal, OUTV: data, OUTt: data, Vbp: voltage, Vin: voltage, Vref voltage, S300: step, S301: step, S302: step, S3021: step, S3022: step, S303: step, S304: step, S311: step, S312: step, S313: step, S314: step, S399: step, 151B: voltage measuring circuit, 175: integrator circuit, 175a: operational amplifier, 175r: resistor, 175c: capacitor, 176: selection circuit, 173d: oscillator, 173e: AND circuit, 173f: counter, SEL: signal, CCK: signal, CRE: signal, OUTC: data, Vin2: voltage, Vref2: voltage, tta: period, ttb: period, ttb1: period, ttb2: period, ttb3: period, S400: step, S401: step, S402: step, S411: step, S412: step, S413: step, S414: step, S499: step, 124: terminal, 125: terminal, 7407: secondary battery, 7104: secondary battery, 7504: secondary battery, 4002b: secondary battery, 4003b: secondary battery, 913: secondary battery, 4103: secondary battery, 4111: secondary battery, 6306: secondary battery, 6409: secondary battery, 6503: secondary battery, 8024: secondary battery, 8602: secondary battery

1. A power storage system comprising:
a secondary battery, a current measuring circuit, a voltage measuring circuit, and a control circuit,
wherein the secondary battery comprises a negative electrode,
wherein the negative electrode comprises graphite and silicon,
wherein the current measuring circuit and the voltage measuring circuit are electrically connected to the control circuit,
wherein the control circuit is configured to start charge of the secondary battery,
wherein the control circuit is configured to perform a first arithmetic operation of calculating a voltage differential value of an amount of electricity of charge current of the secondary battery with use of a current value detected by the current measuring circuit and a voltage value detected by the voltage measuring circuit, and is configured to perform a second arithmetic operation of detecting an extremum of the voltage differential value, and
wherein the control circuit is configured to stop the charge after a predetermined time elapses since the extremum is detected through the second arithmetic operation.

2. A power storage system comprising:
a secondary battery, a current measuring circuit, a voltage measuring circuit, and a control circuit,
wherein the secondary battery comprises a positive electrode and a negative electrode,
wherein the negative electrode comprises graphite and silicon,
wherein the current measuring circuit and the voltage measuring circuit are electrically connected to the control circuit,
wherein the current measuring circuit is configured to measure current flowing through the secondary battery,
wherein the voltage measuring circuit is configured to measure voltage of the secondary battery,
wherein the control circuit is configured to start charge of the secondary battery,
wherein the control circuit is configured to calculate an amount of electricity Q(t) using current I(t) at a time t,
wherein the control circuit is configured to detect a time tp at which a first curve has a first local maximum by analyzing the first curve with a horizontal axis representing voltage V(t) and a vertical axis representing a voltage differential of the amount of electricity Q(t) [dQ(t)/dV(t)],
wherein the control circuit is configured to stop the charge at a time t2 at which a predetermined time elapses from the time tp in a case where voltage V(tp) at the time tp is higher than or equal to first voltage, and
wherein the first voltage depends on a kind of a positive electrode active material in the positive electrode.

3. The power storage system according to claim 2,
wherein the positive electrode active material comprises lithium iron phosphate, and
wherein the first voltage is higher than or equal to 3.40 V and lower than or equal to 3.50 V.

4. The power storage system according to claim 2,
wherein the positive electrode active material comprises lithium nickel-cobalt-manganese oxide, and
wherein the first voltage is higher than or equal to 3.90 V and lower than or equal to 4.50 V.

5. The power storage system according to claim 2,
wherein the positive electrode active material comprises lithium cobalt oxide, and
wherein the first voltage is higher than or equal to 4.20 V and lower than or equal to 4.50 V.

6. The power storage system according to claim 1,
wherein a ratio Wg/Ws between a weight Wg of the graphite and a weight Ws of the silicon is greater than or equal to 4 and less than or equal to 10.

7. The power storage system according to claim 6,
wherein a capacity charged in the negative electrode is greater than or equal to 70% and less than 90% of a rechargeable and dischargeable capacity of the negative electrode.

8. The power storage system according to claim 2,
wherein a ratio Wg/Ws between a weight Wg of the graphite and a weight Ws of the silicon is greater than or equal to 4 and less than or equal to 10.

9. The power storage system according to claim 8,
wherein a capacity charged in the negative electrode is greater than or equal to 70% and less than 90% of a rechargeable and dischargeable capacity of the negative electrode.
